(19) United States
(12) Patent Application Publication
(10) Pub. No.: US 2011/0203383 A1
(43) Pub. Date: Aug. 25, 2011

(54) Method to determine percentage of damage to structure from single or multiple forces

(76) Inventor: Matthew B. Phelps, Galveston, TX (US)

(21) Appl. No.: 12/931,771

(22) Filed: Feb. 10, 2011

Related U.S. Application Data
(60) Provisional application No. 61/303,654, filed on Feb. 11, 2010.

(51) Int. Cl. G01M 5/00

(52) U.S. Cl. 73/786

(57) ABSTRACT

The present invention is directed at providing a numerical analysis method to determine the damage sustained on a structure based upon the physical dimensions of a the structure, the structure's design wind speed and the forces applied during an event such as a hurricane or man made event. The method includes the steps of creating a timeline by which event forces can be plotted and compared to an ultimate load of the structure, individual loads placed upon the structure as well as a sum of the individual loads placed upon the structure. By using this method, the user is able to identify the time at which the ultimate load of the structure was exceeded and the maximum individual and total loads occurred. The method further identifies the time when the structural failure likely initiated and the time by which the structural failure was likely complete. The method further provides a determination of the percentage individual load at the time the ultimate load is breeched as well as a time step of forces applied to the structure throughout the course of the event.

### CROSS REFERENCE TO RELATED APPLICATIONS

The Inventor is claiming the benefit of a provisional patent application. Application No. 61/303,654, filed Feb. 11, 2010. This provisional patent is the basis for the filing of this Utility Patent. No previous patents pertaining to this subject.

### STATEMENT REGARDING FEDERALLY SPONSORED RESEARCH OR DEVELOPMENT

This patent has no relationship to any federally sponsored research or development.

### DESCRIPTION OF ATTACHED APPENDIX

Not Applicable

### BACKGROUND OF THE INVENTION

1. Technical Field

This Invention relates generally to the field of forensic engineering investigation, testing and reporting and more specifically to a method to determine the percentage(s) of damage to a structure from a single or multiple forces. More specifically this invention is directed to a process for a physically based mathematically determination of the percentage damage to a structure resulting from single or multiple forces from neutral or man-made events.

The process comes from the American Society of Civil Engineering (ASCE) reference text “Minimum Design Loads for Buildings and Other Structures” ASCE 07-05, Load Resistance Factor Design (LRFD) and event data and the time line for which the event data is relevant to the subject structure. Calculation methods of the formula from the referenced publications and graphical output methods of the calculated values.

2. Description of the Related Art

In developing this method I sought to develop a numerical method that was based upon the subject structures unique geometric dimensions and the relevance damaging event data over the course of the event such that I could assess the point in time the failure would start (be in excess of the ultimate load) and the end of the event and calculate the average of single or multiple source forces over the period of time the ultimate load was exceeded. To our surprise, we actual found our method would do much more.

Since most damaging causing events occurs when no one is present and their is not typically any documented photographs or other eye witness to the damage event most damages estimates have been based upon historical data and measured or estimated damage event data. For example the Saffari-Simpson hurricane scale will rate a storm intensity from 0 to 5 based upon wind speed and water surge height. Historical data will approximate damage from prior storms to the subject storm Saffari-Simpson rating scale.

Other methods simply estimate the required applied force to cause the documented structural failure. The Safferi-Simpson scale does not correlate storm intensity between wind and flood (surge height) and only reports one value with out scoring the separate forces of wind and water (surge). The Safferi-Simpson scale does not calculate the applied load to a specific structure for wind or water. The Safferi-Simpson scale does not address the ultimate load (load or combination of loads, which will imitate a structural failure of a specific building or structure).

Estimates of the amount of applied force required to cause a specific failure do not partition the force or applied load between the sources of the load or forces. Estimates of applied force do not separate the forces between multiple sources of force such as wind and water (flood), or other combinations of natural and/or man made forces or loads.

Both of the above methods require speculation on the part of the engineer and are not based upon the unique geometry of the subject structure or the time line (interval) of the relevant damaging event (data). Most reports only address the peak value of the damaging event and fail to address the build up of the event intensity. Neither of the above methods address measuring the applied load (from all sources) as it occurs of the entire period of the damaging event. Neither of the above methods address the point at which the structural failure is initiated or the time by which it is likely complete. Both of the above methods make the same fundamental flaw that they assume the damage occurred at the events peak intensity.

### BRIEF SUMMARY OF THE INVENTION

The primary object of the invention is to provide a numerical analysis of the damage sustained based upon the physical dimensions of the structure and the structures design wind speed The process also does the following:
calculates the applied loads acting on the subject structure in the correct time sequence of their action.
calculates the total applied load from the sum of individual loads.
graphs the applied loads (and total load) and compares them to the calculated ultimate load.
identifies the time at which the ultimate load of the structure was breeched.
identifies the time the maximum individual and total loads occurred.
identifies the time when the structural failure likely initiated and the time by which the structural failure was likely complete.
calculates the percentage individual loads at the time the ultimate load is breeched.
calculates the percentage of individual loads during each time step throughout the course of the event.
calculates the average percentage individual applied loads and sums individual loads into the total applied load during the time period the structural failure was likely to have occurred.
converts damaging event data (such as seismic, earth pressures, wind, water (flood) and barometric pressure) to (force) loads that are the same units of force and pressure as used to design structures.
uses actual applied loads and structural data to analysis causation of the damage to a structure.
refutes analysis that only reports damaging event data and load analysis that do not compare the event data time line to the ultimate load.
will provide insurance companies and policy owners a common language to determine the damage (loss) amount on a structure.
mathematically precise and when used with verified damaging event data is irrefutable.

Other objects and advantages of the present invention will become apparent from the following descriptions, taken in connection with the accompanying drawings, wherein, by way of illustration and example, an embodiment of the present invention is disclosed.

In accordance with a preferred embodiment of the invention, there is disclosed a process for a physically based mathematically determination of the percentage damage to a structure comprising the steps of: The ultimate load and applied loads are calculated using physical dimensions of the structure, The ultimate load wind speed is calculated from the design wind speed, The applied loads are calculated from actual damaging event data that is relevant to the project site, The ultimate load identifies the point at which some type of structural failure will initiate, The process will determine the precise amount (percentage) of damage (load) from single or multiple applied forces. The process will determine the order in which the loads appeared (multiple sources of forces) and their time of appearance and relevance to each other, The process will explain why the subject structure may be damaged more or less than an adjacent structure, and The process will define the % of damage from each applied load to the structure.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 is a subject structure data form, illustrating an aspect of the method. (2 pages)

FIG. 2 is weather data set illustrating an aspect of the method (13 pages)

FIG. 3 is a graph of the wind speed and storm surge ht. illustrating an aspect of the method. (1 page)

FIG. 4 is a table of the calculated load values and their relationships, illustrating as aspect of the method. (5 pages)

FIG. 5 is a graph of the applied wind and water loads over the course of the storm event and their relevance to the subject structures ultimate load illustrating as aspect of the method. (1 page)

FIG. 6 is a graph of the applied wind and water loads during the time the ultimate load is exceeded illustrating an aspect of the method. (1 page)

FIG. 7 is a graph of the applied wind and water loads during the time the ultimate load is exceeded with the graphical quadrants and discussion of what is occurring in each quadrant, illustrating an aspect of the method. (1 page)

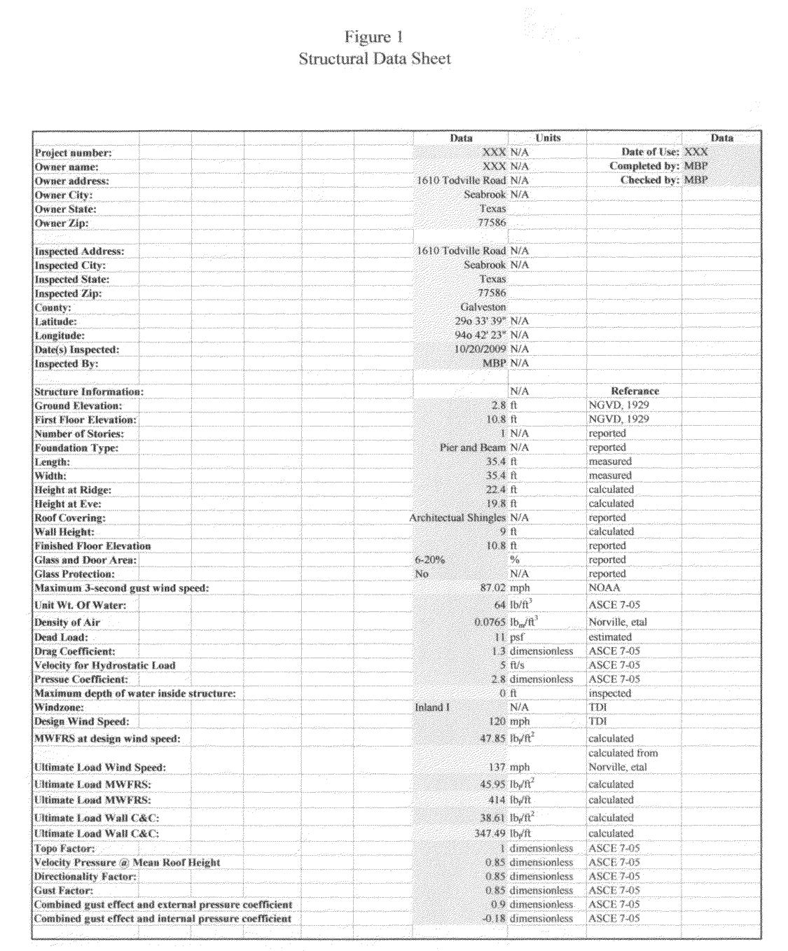

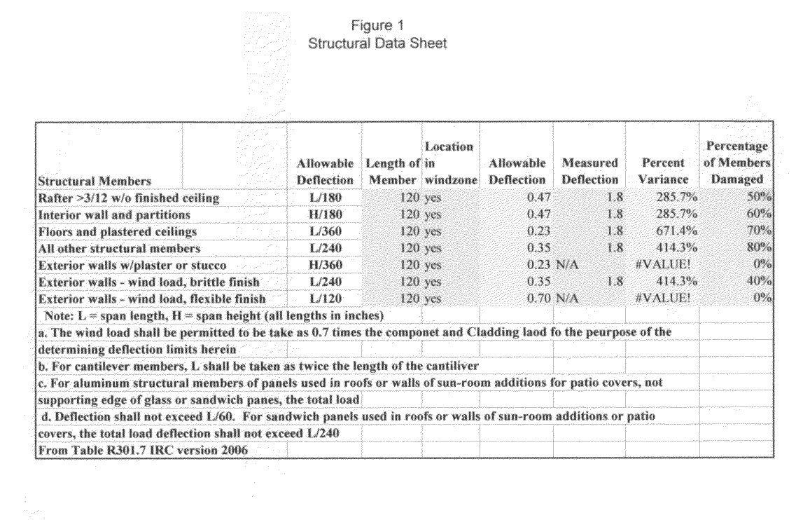

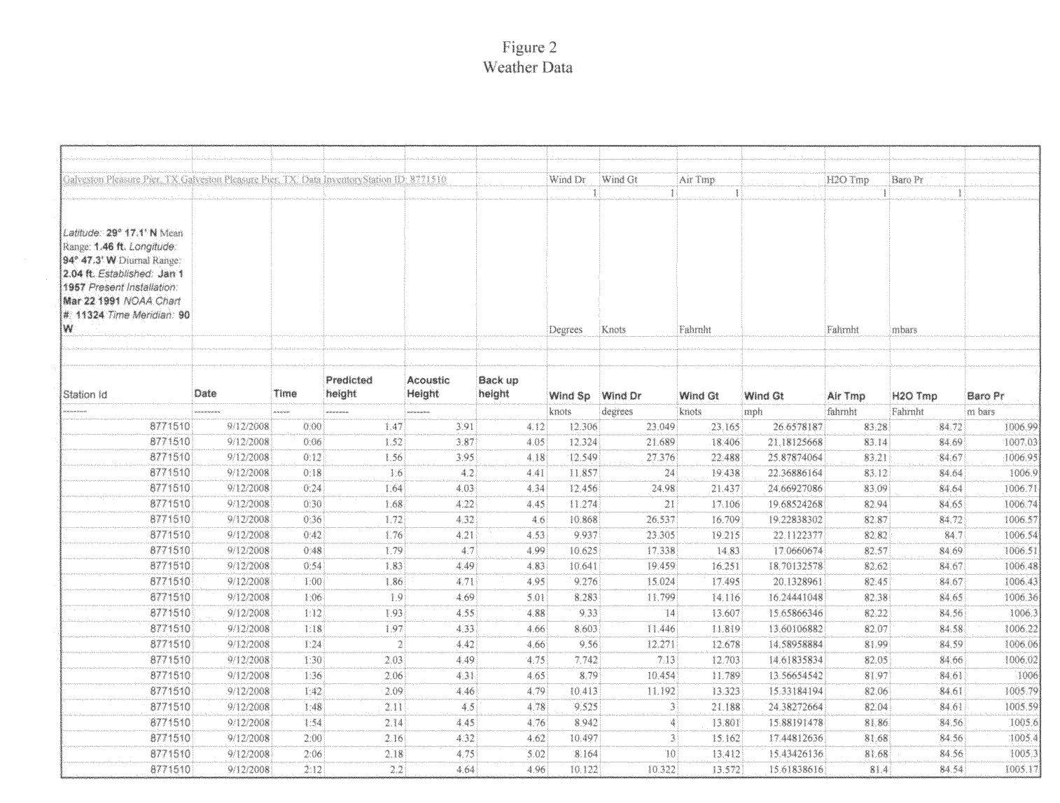

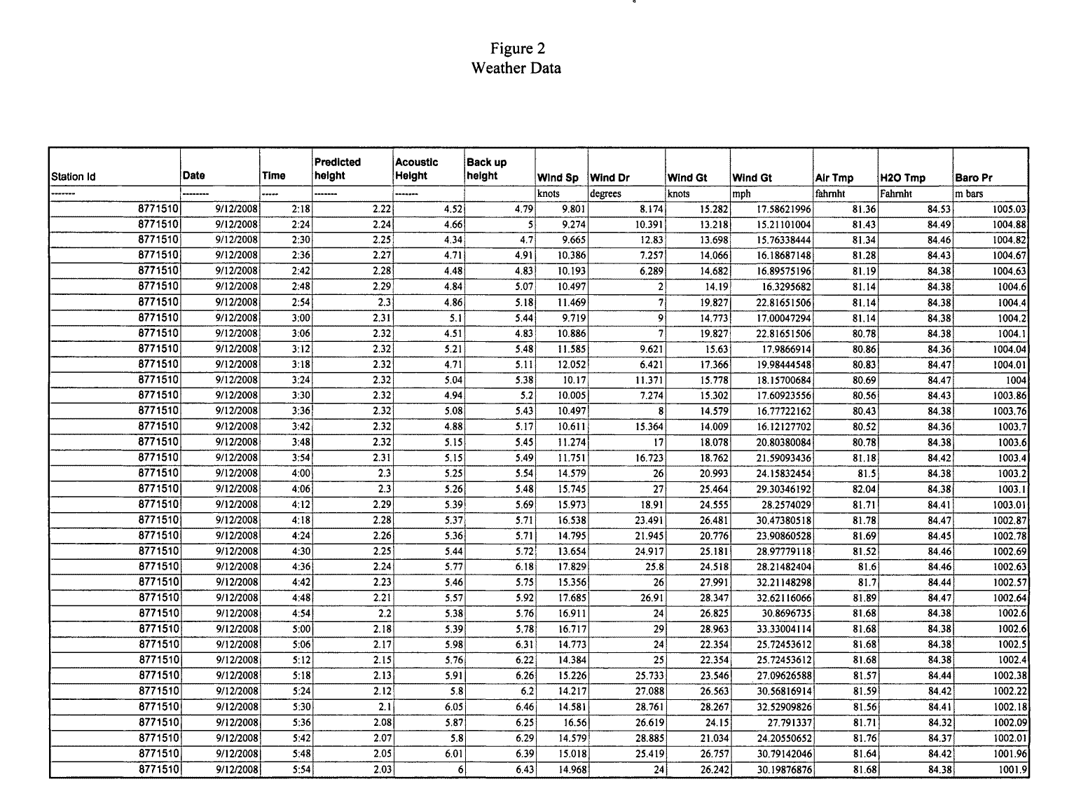

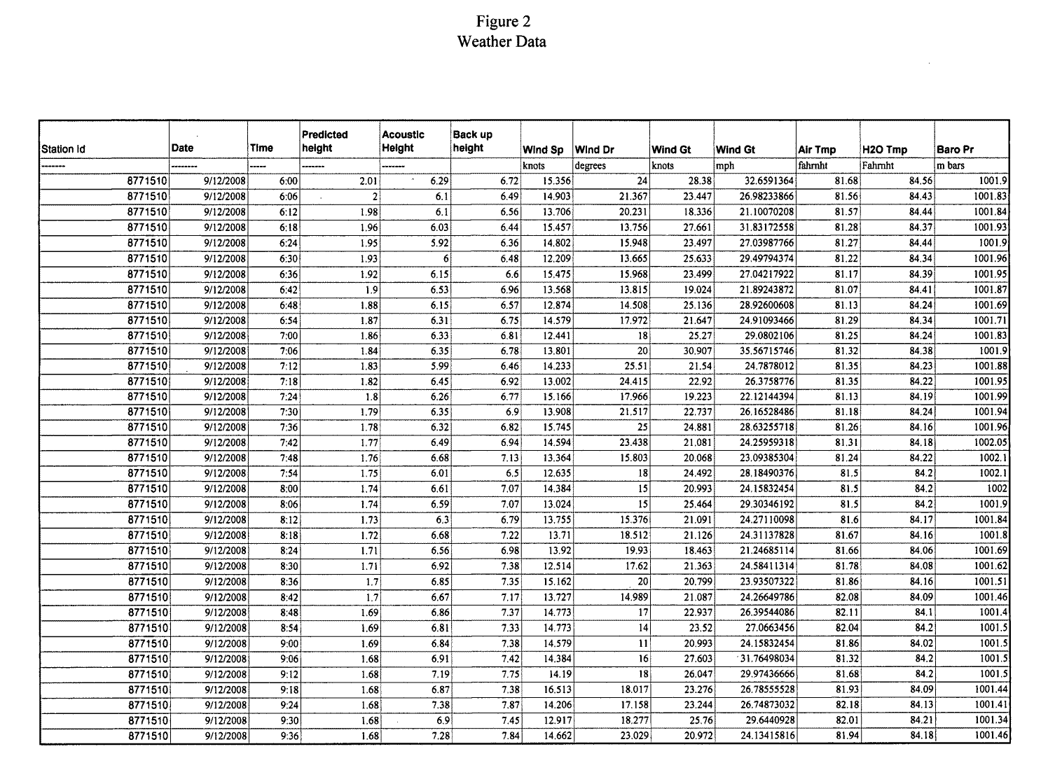

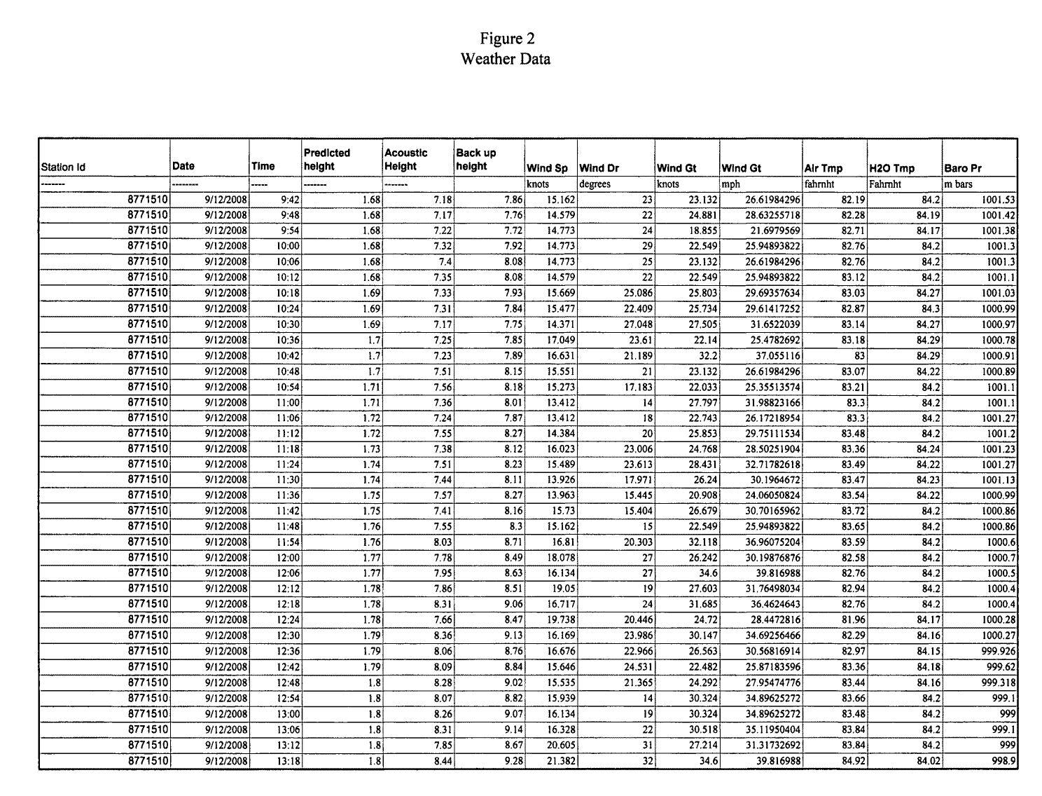

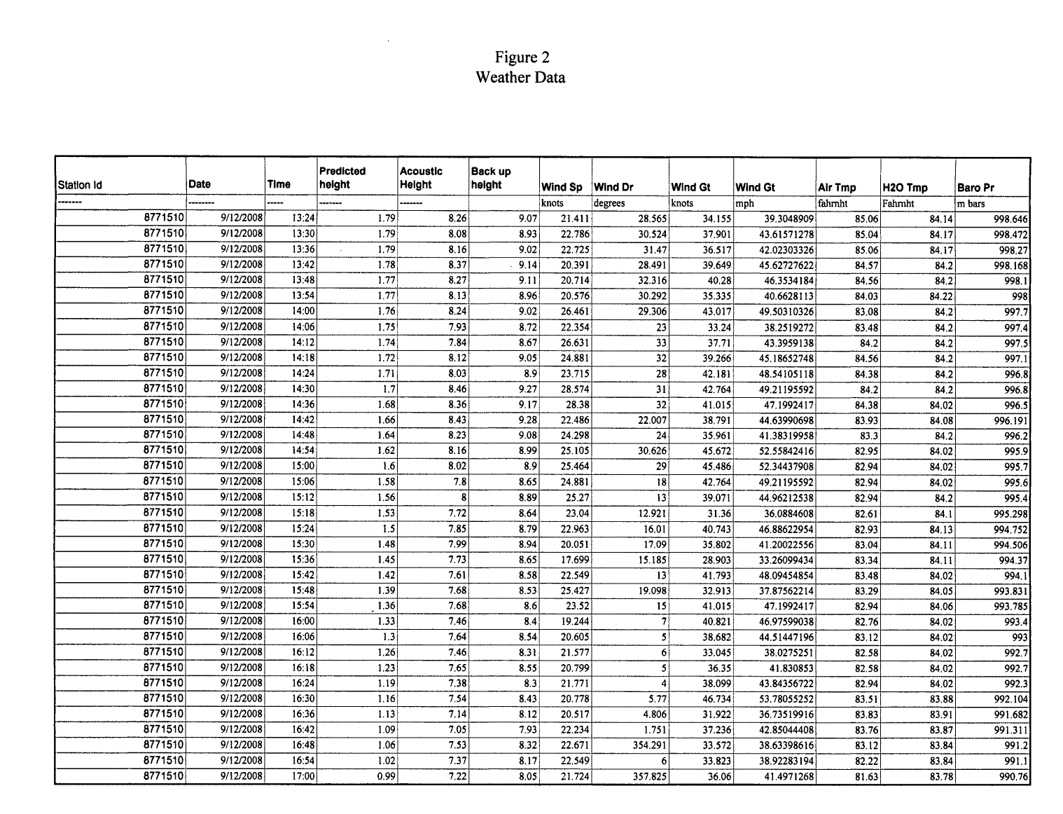

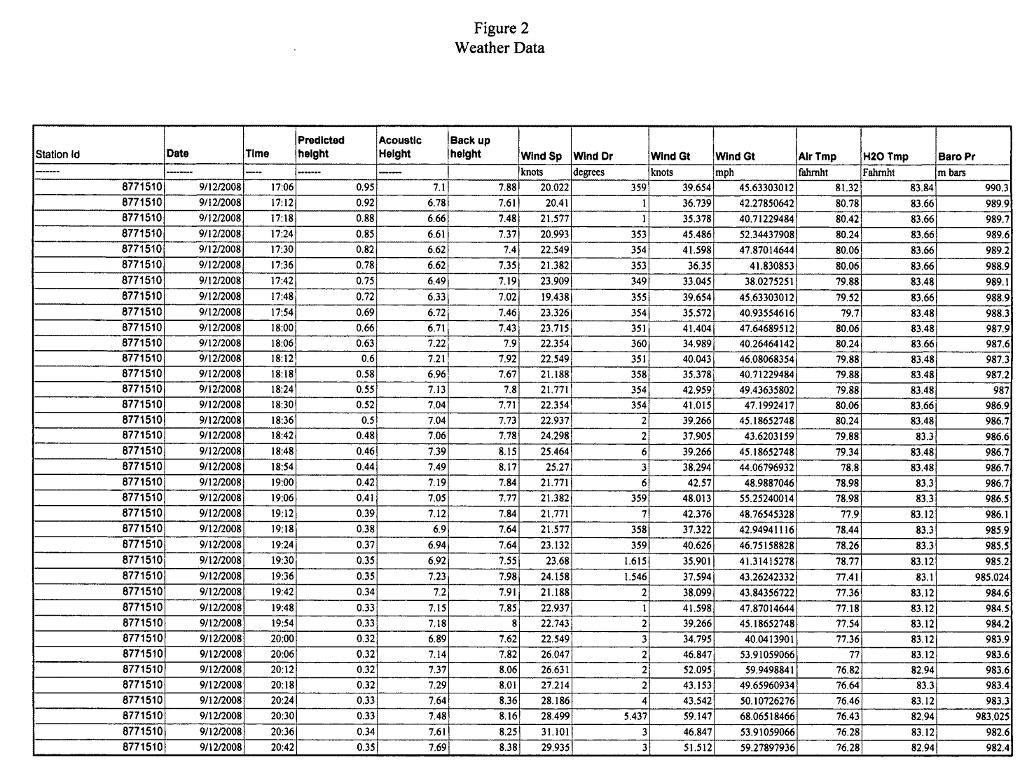

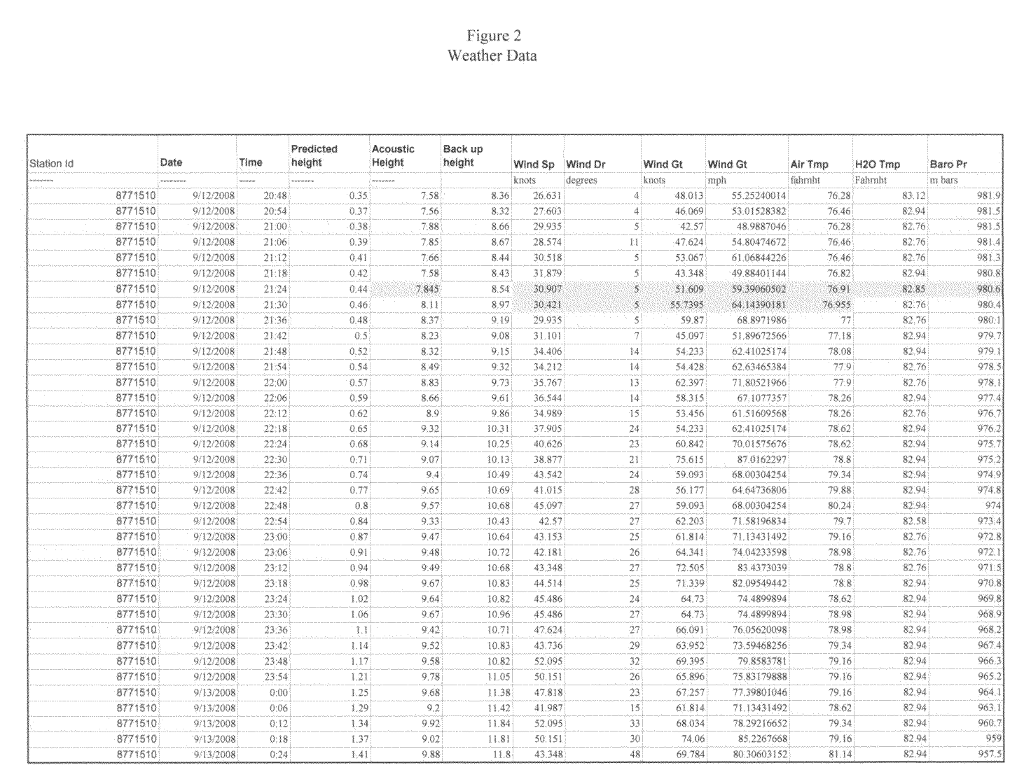

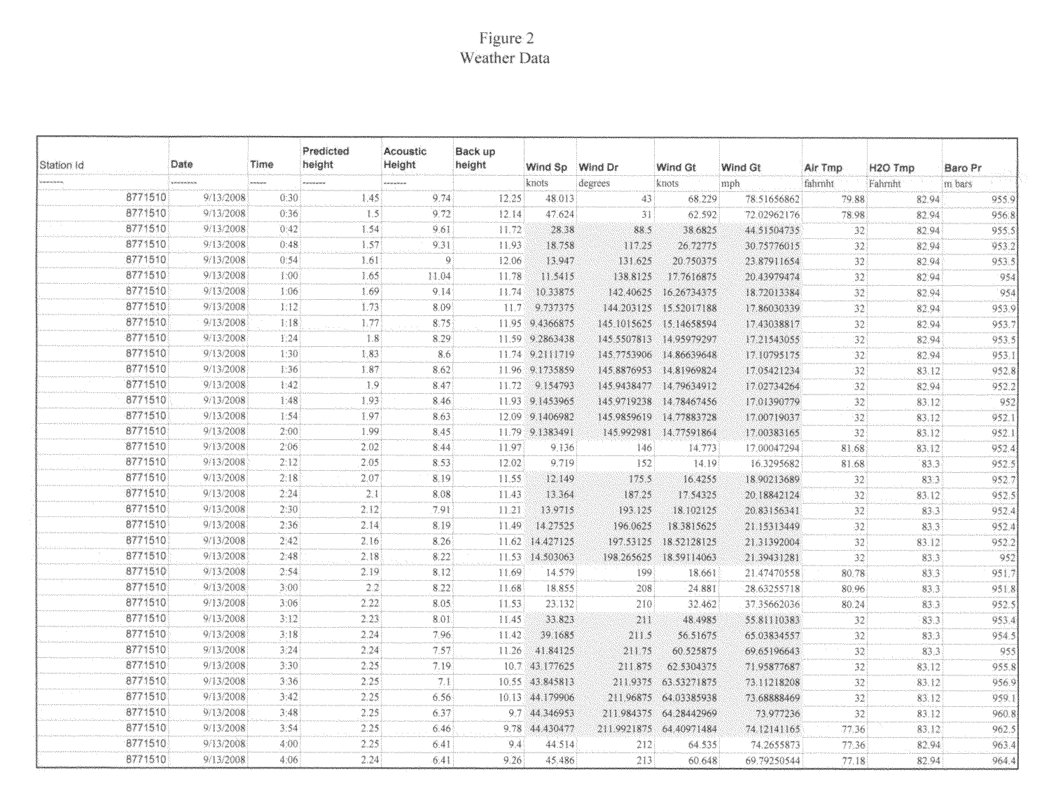

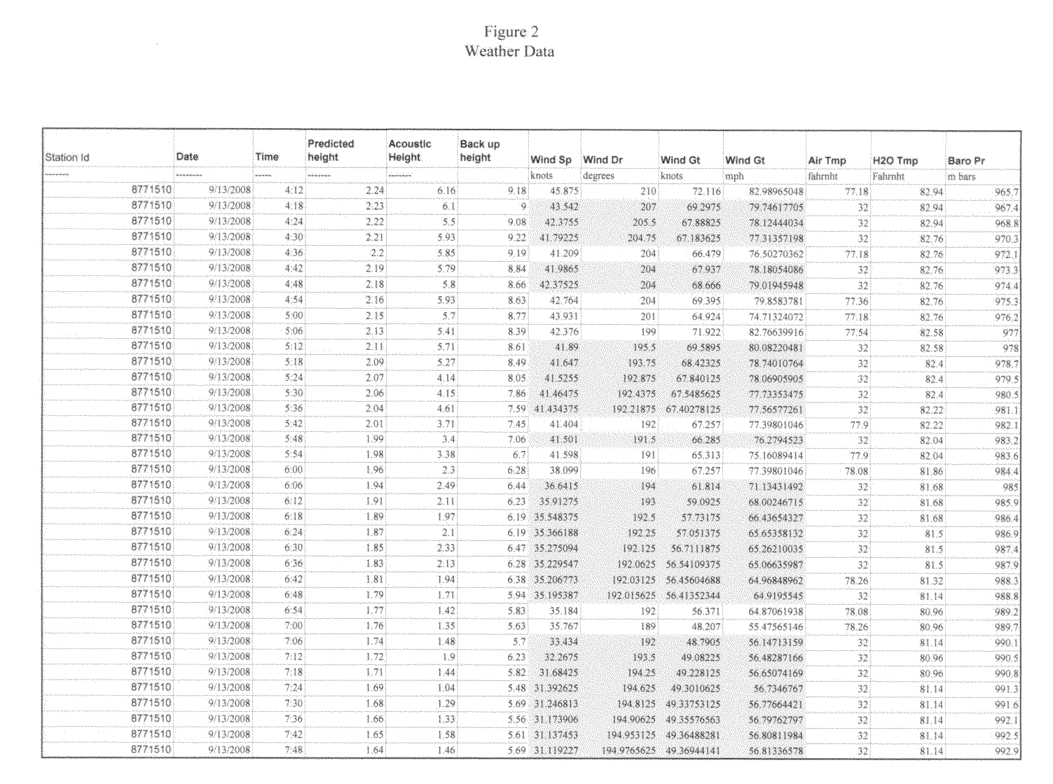

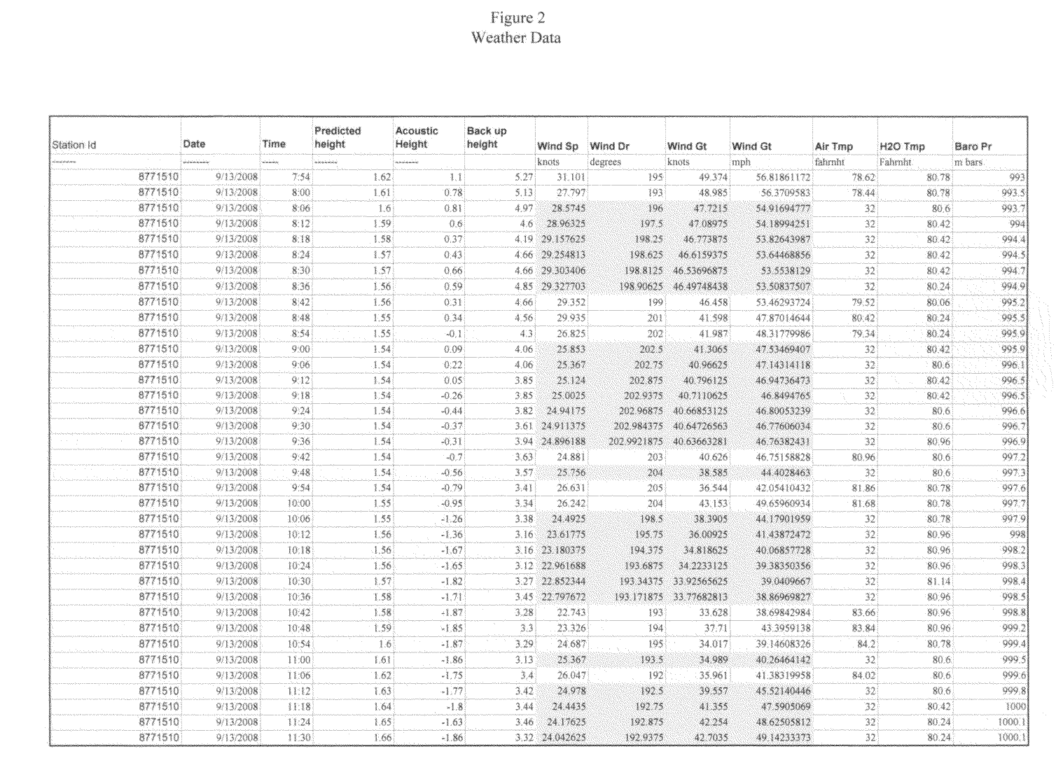

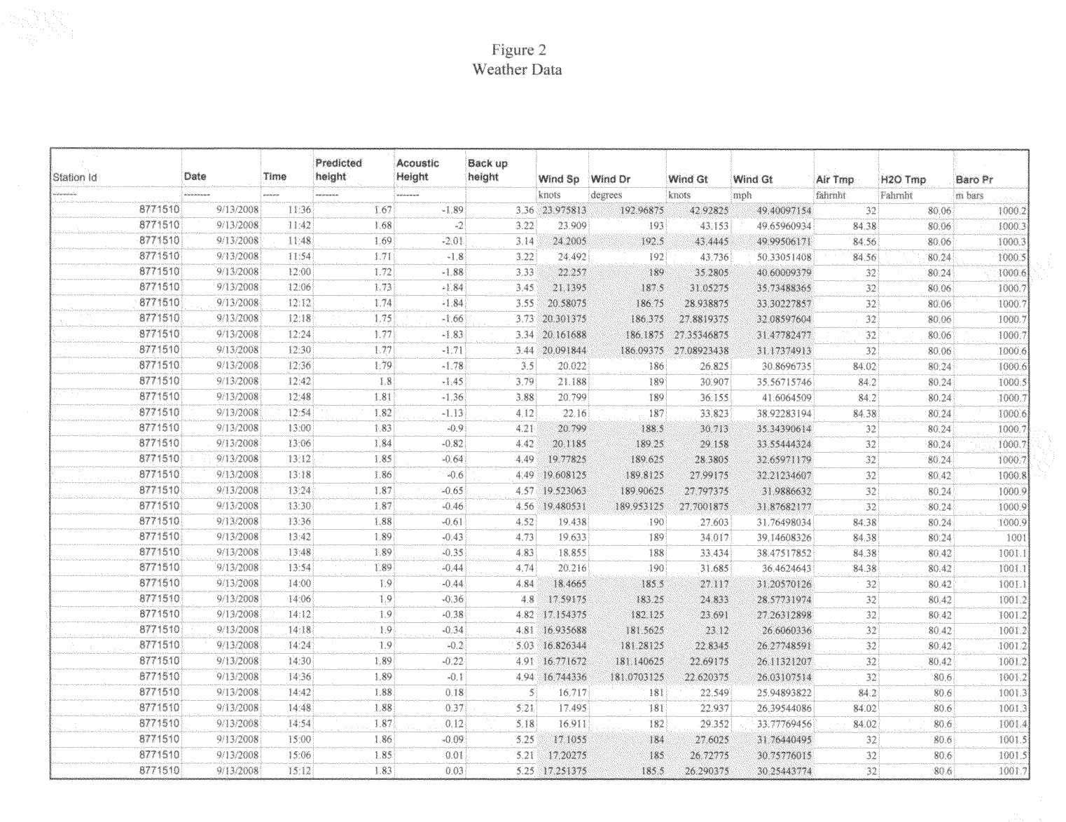

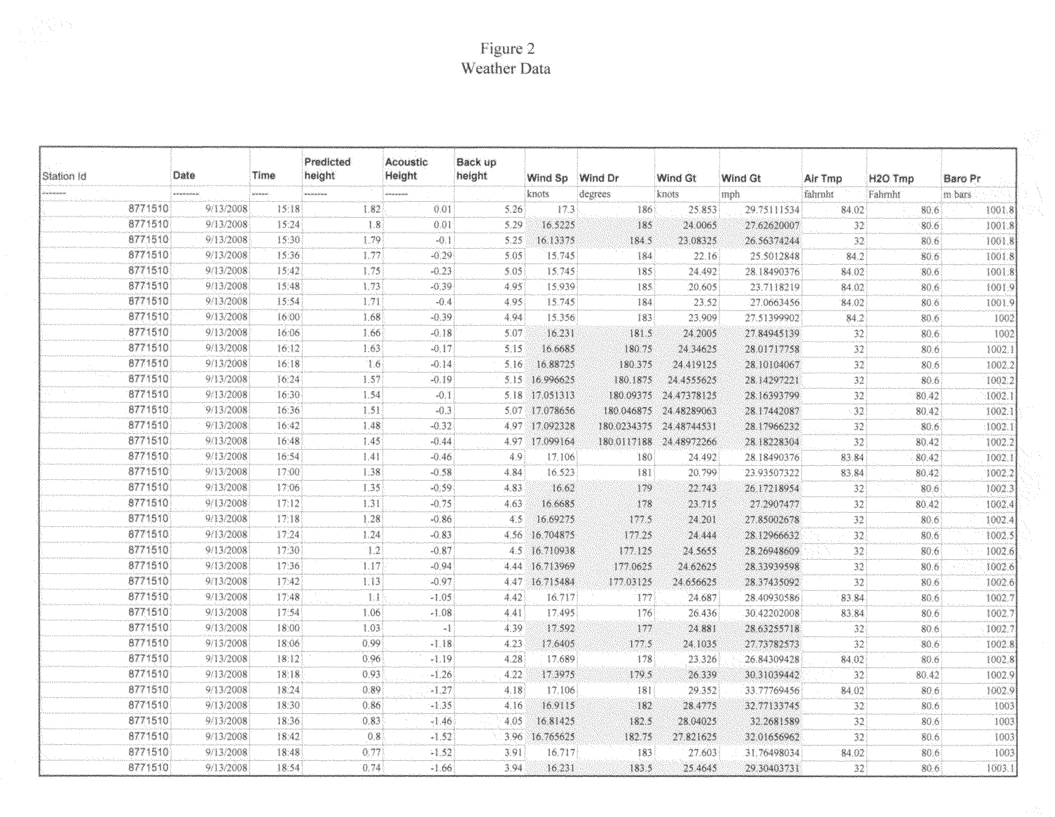

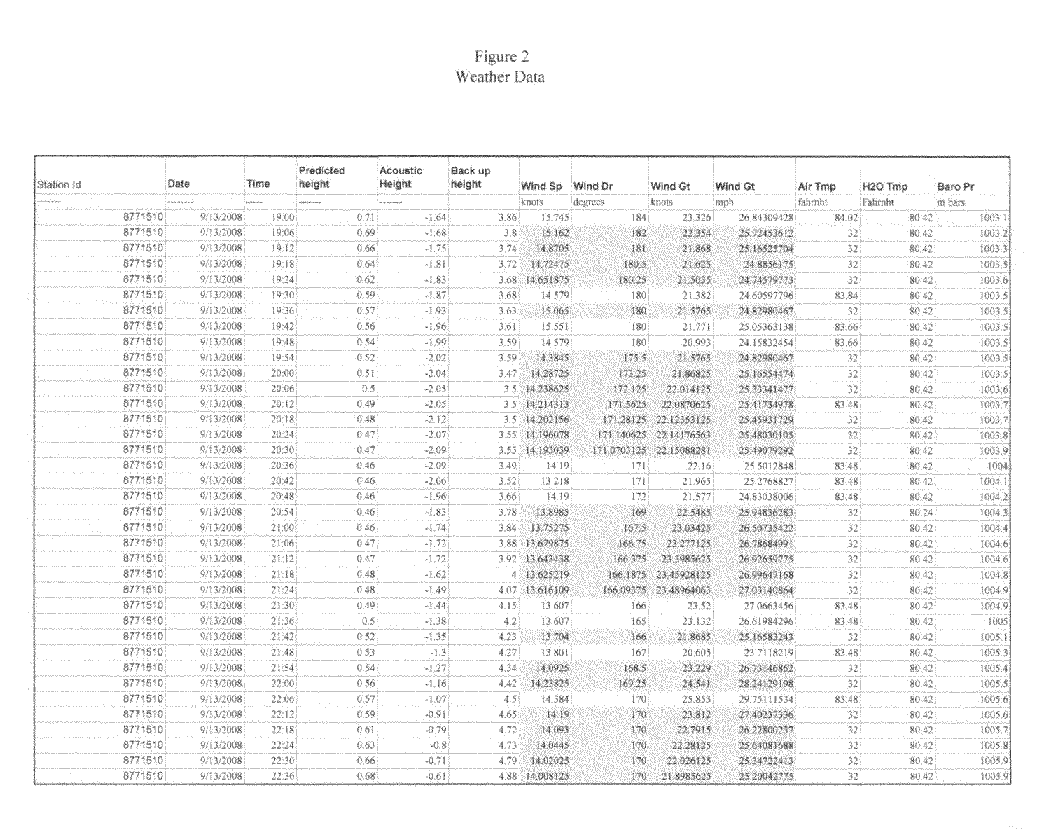

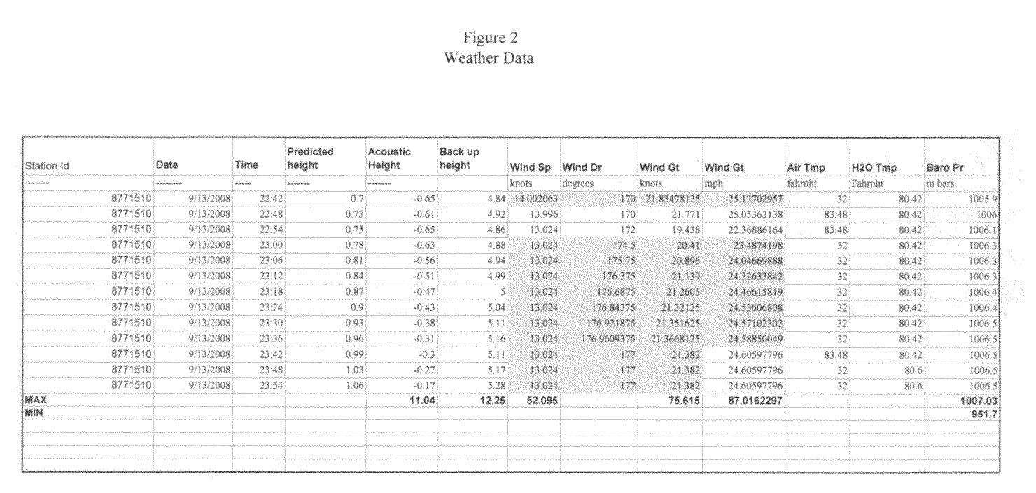

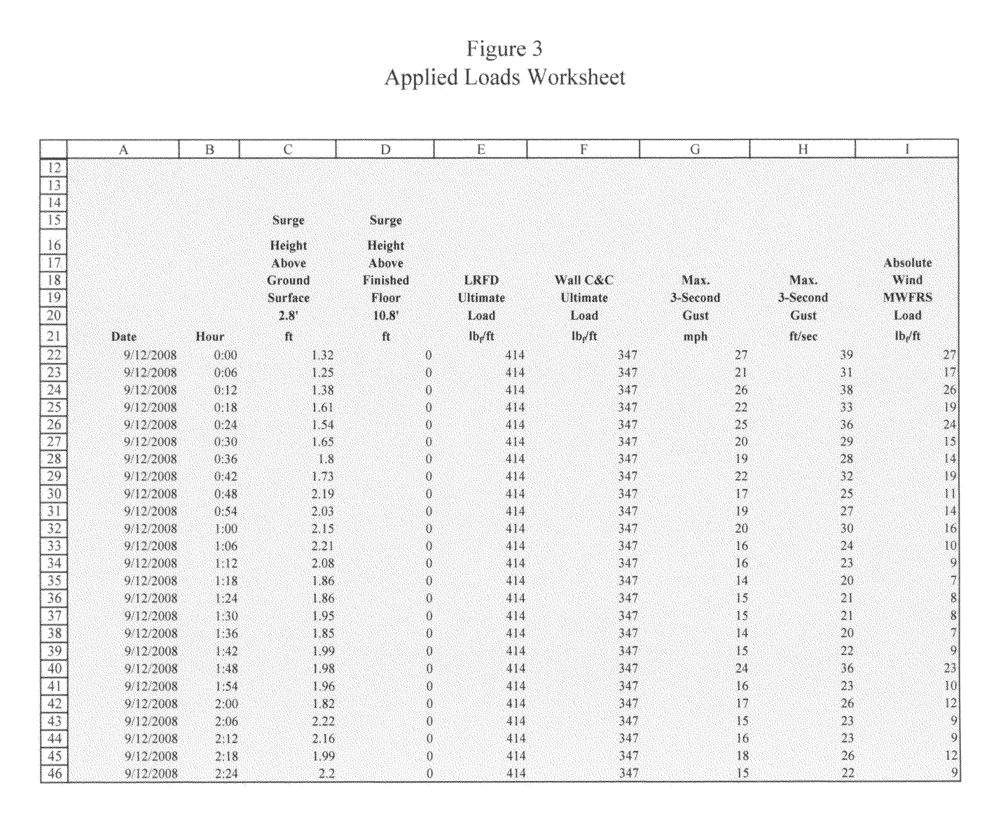

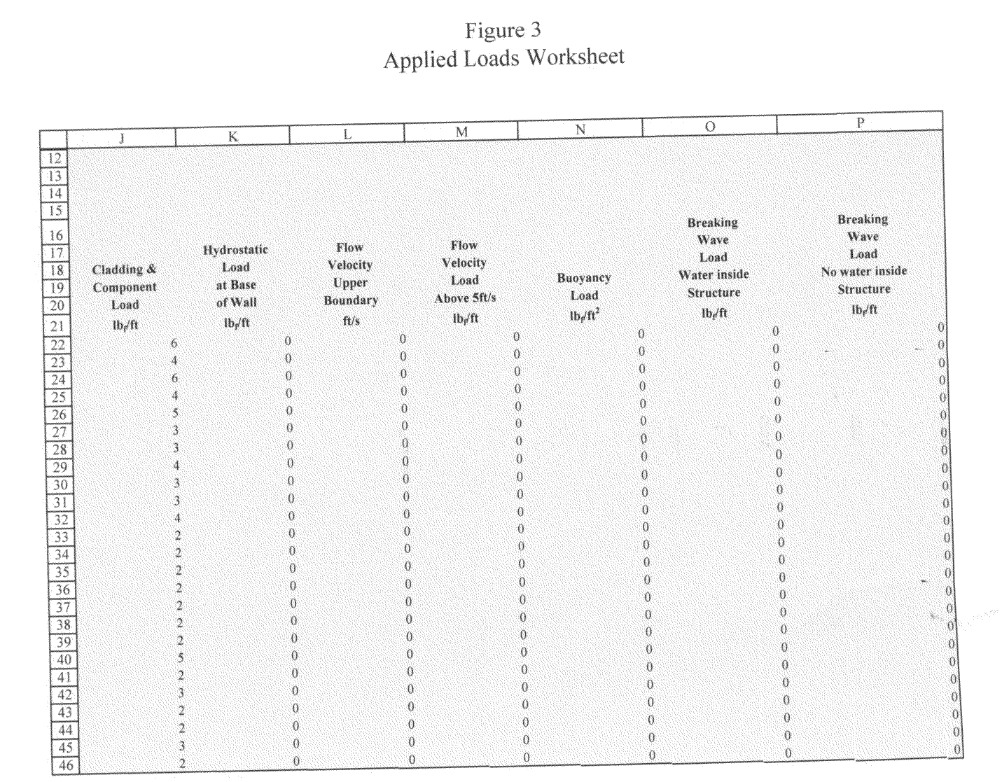

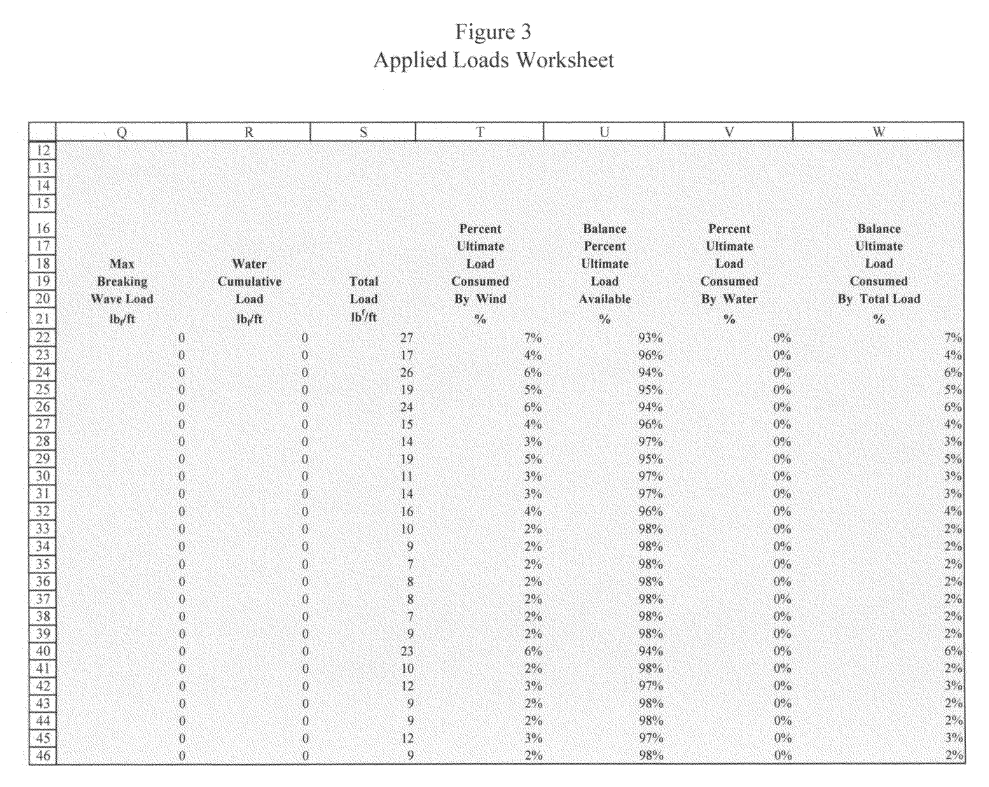

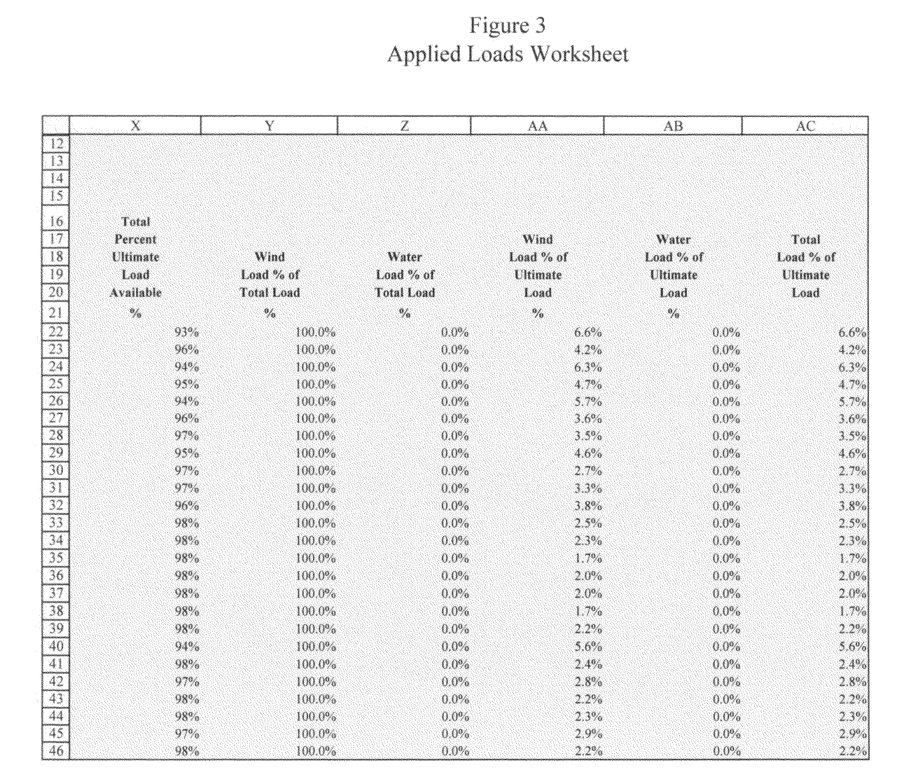

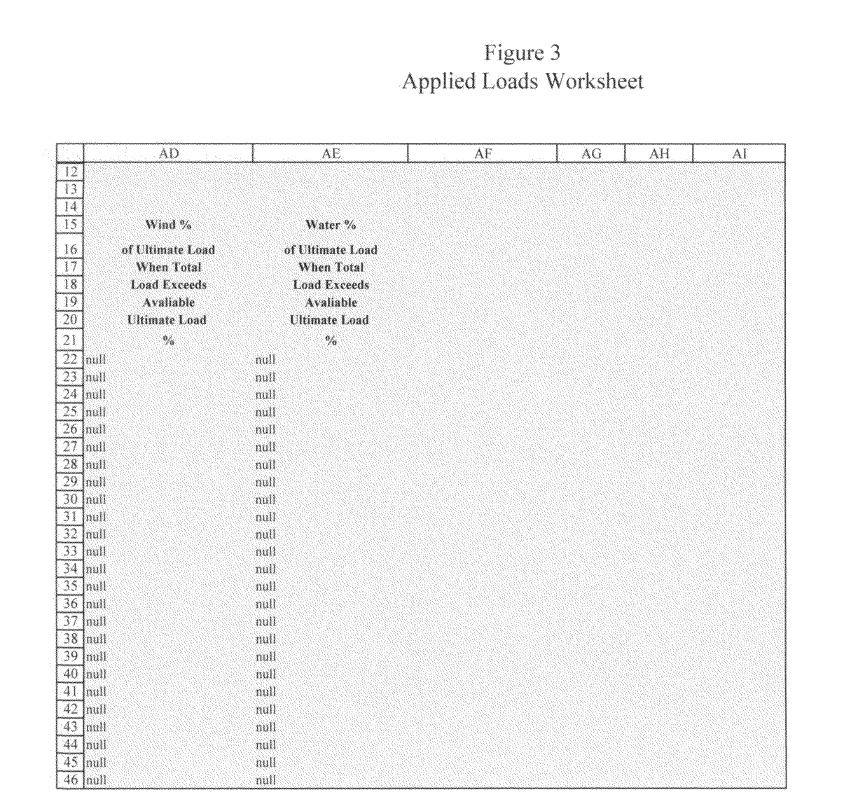

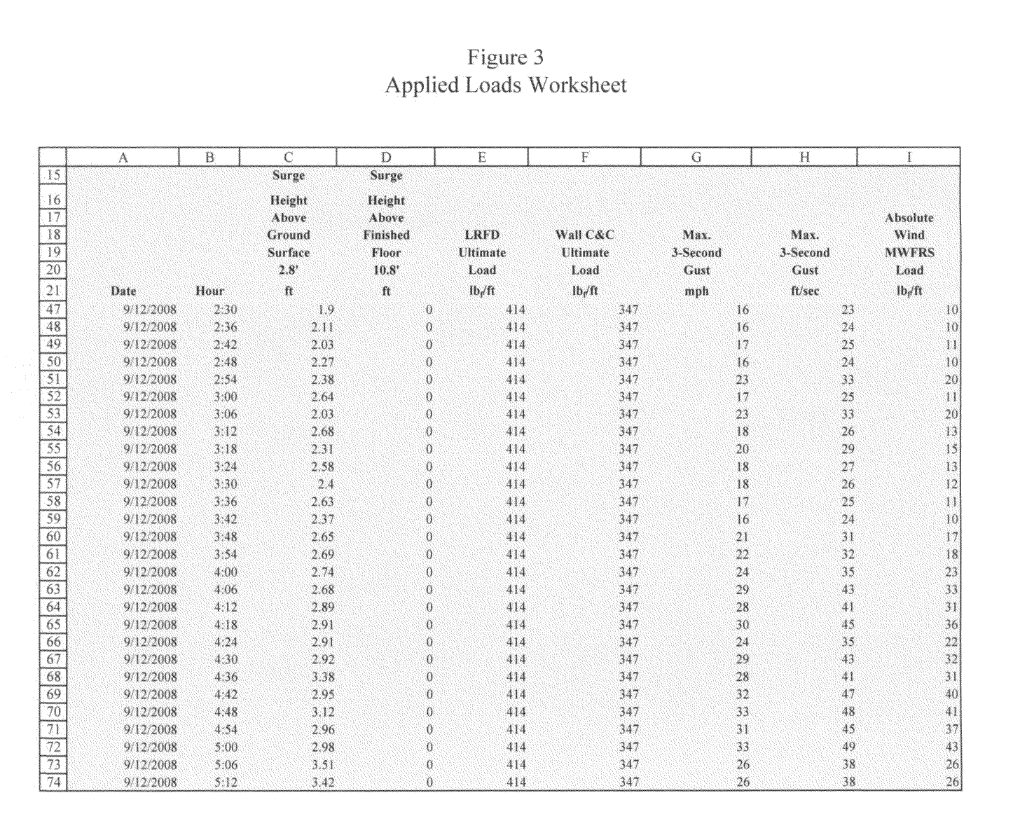

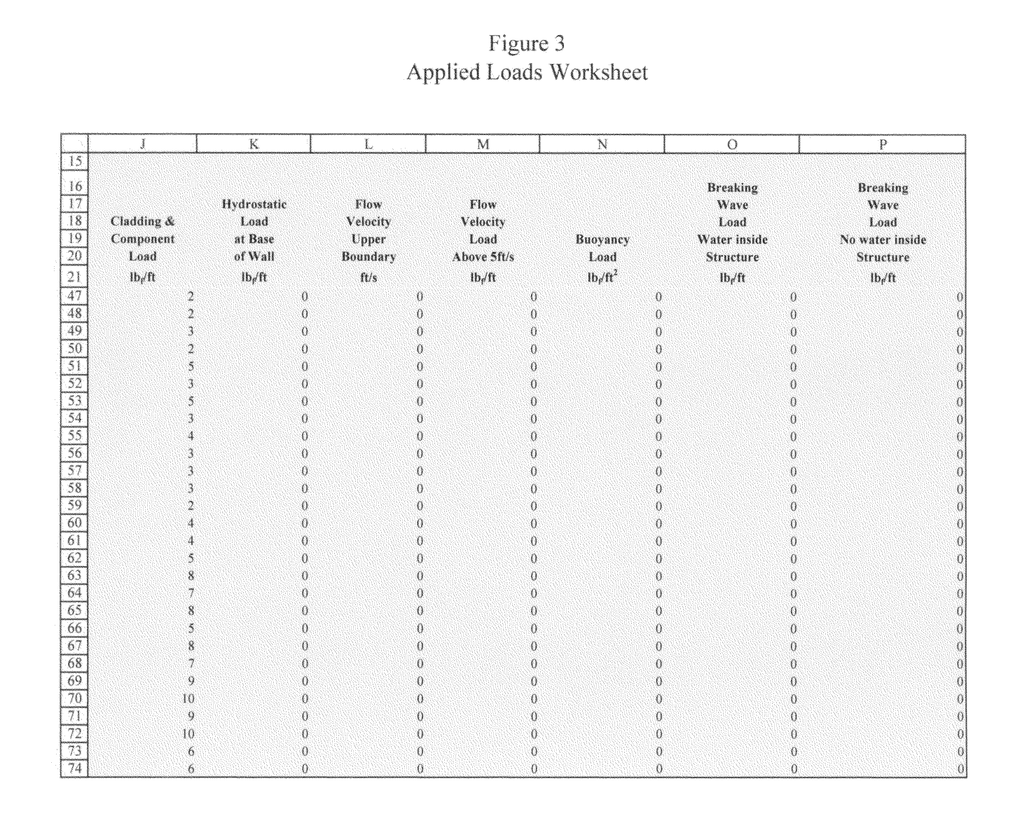

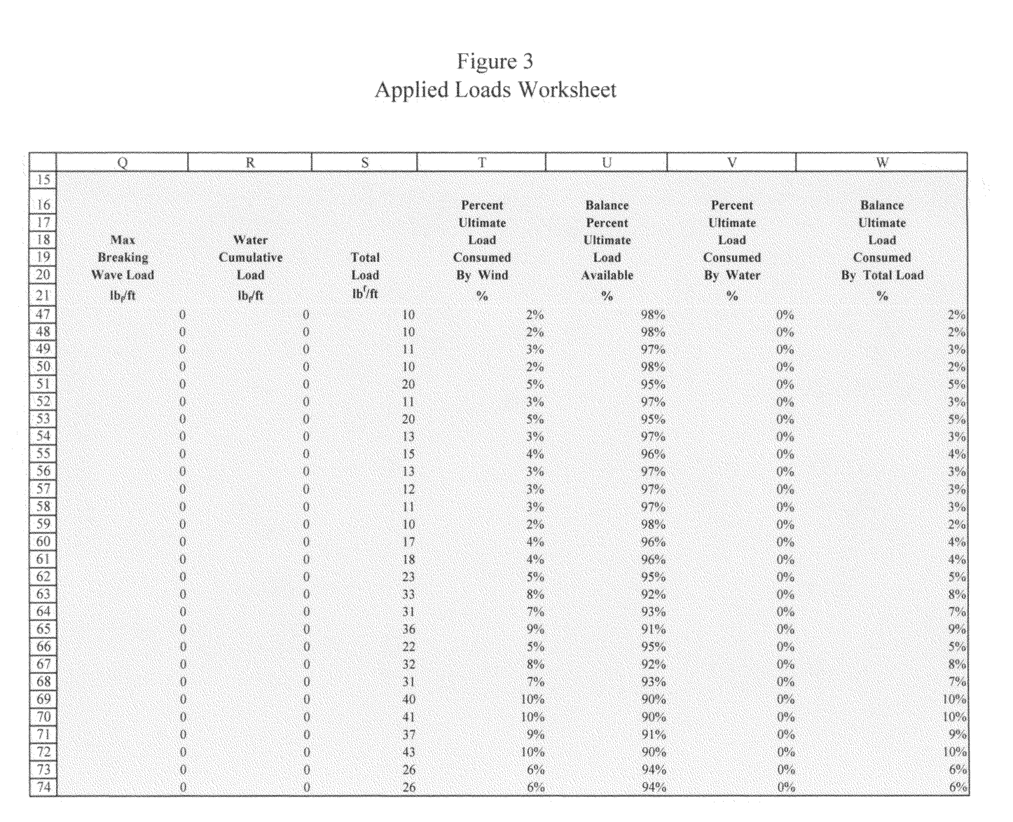

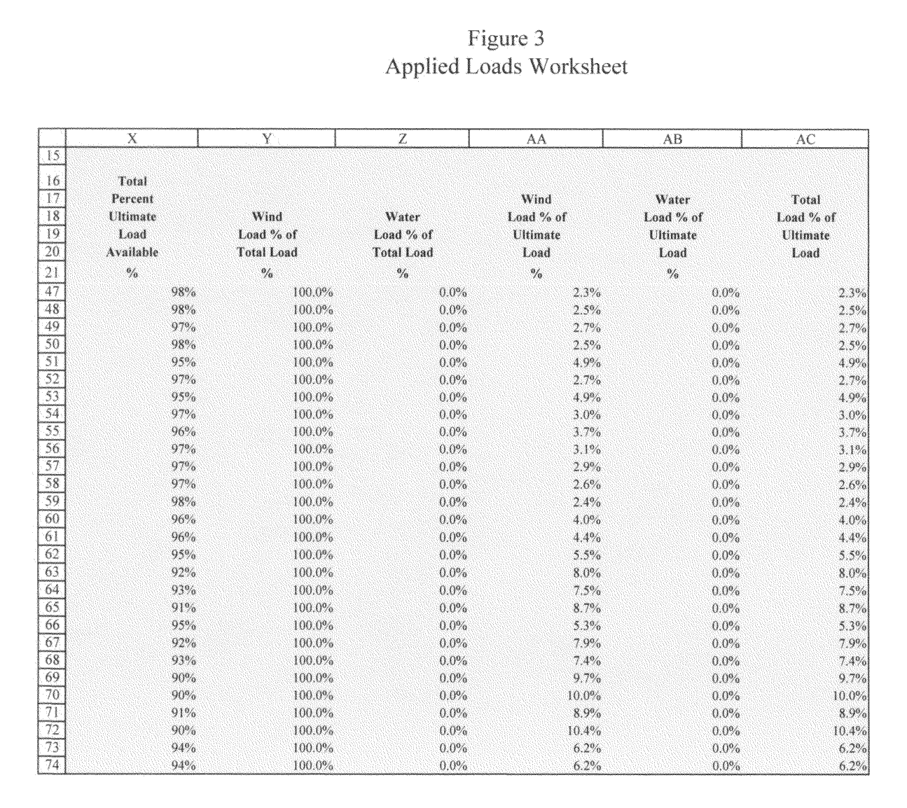

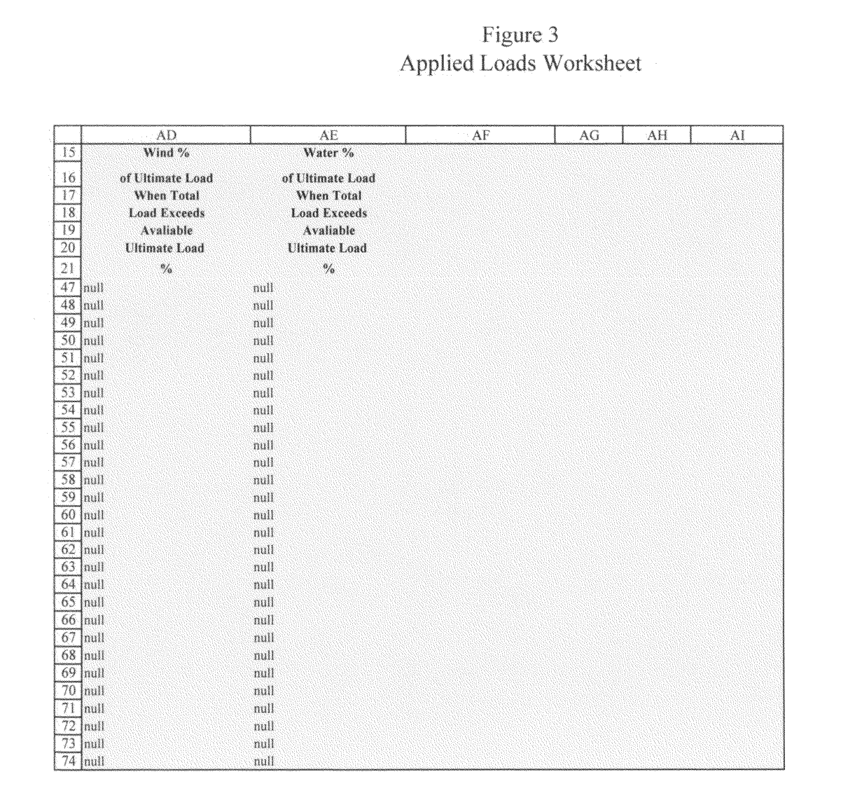

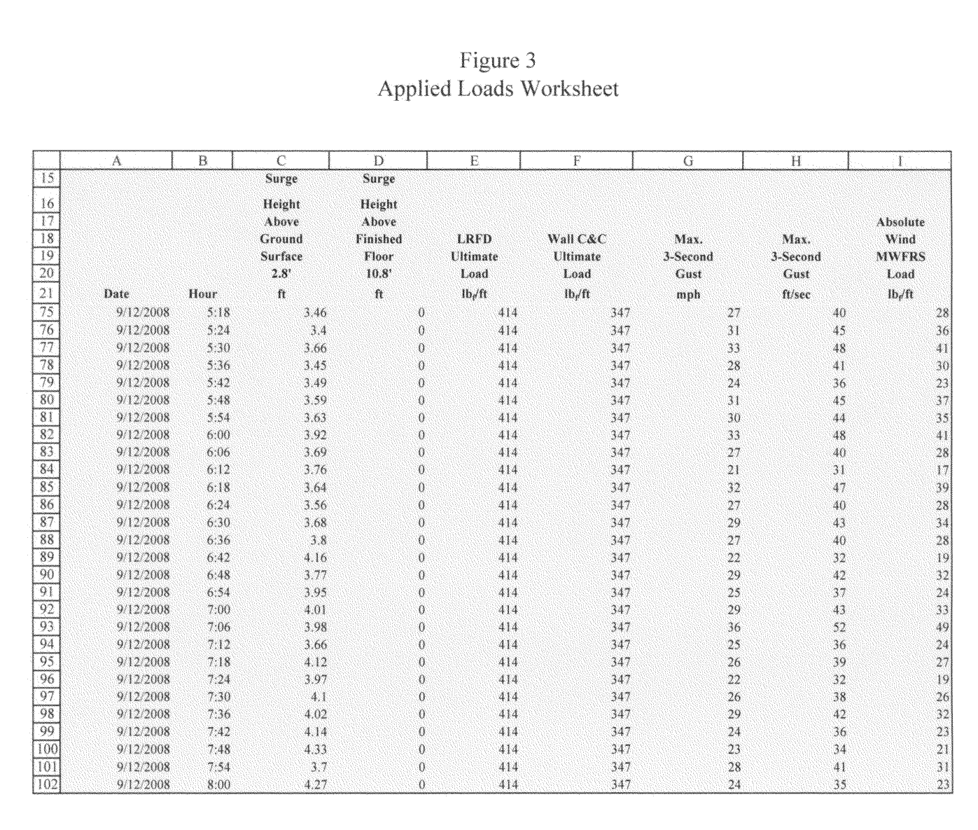

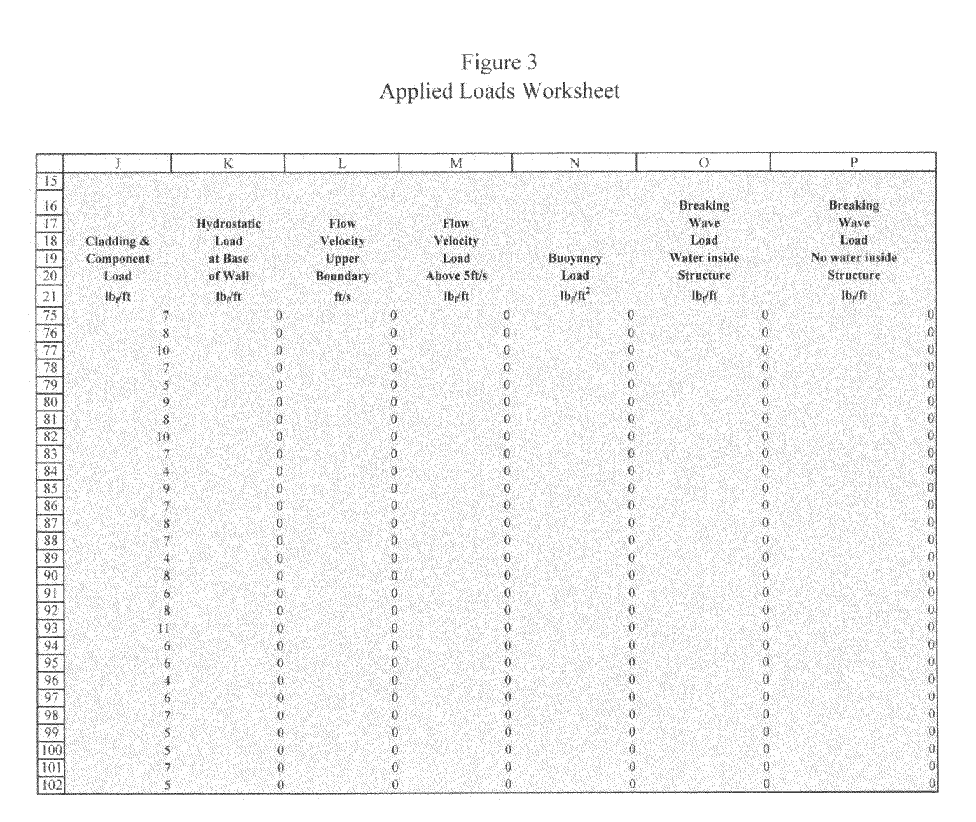

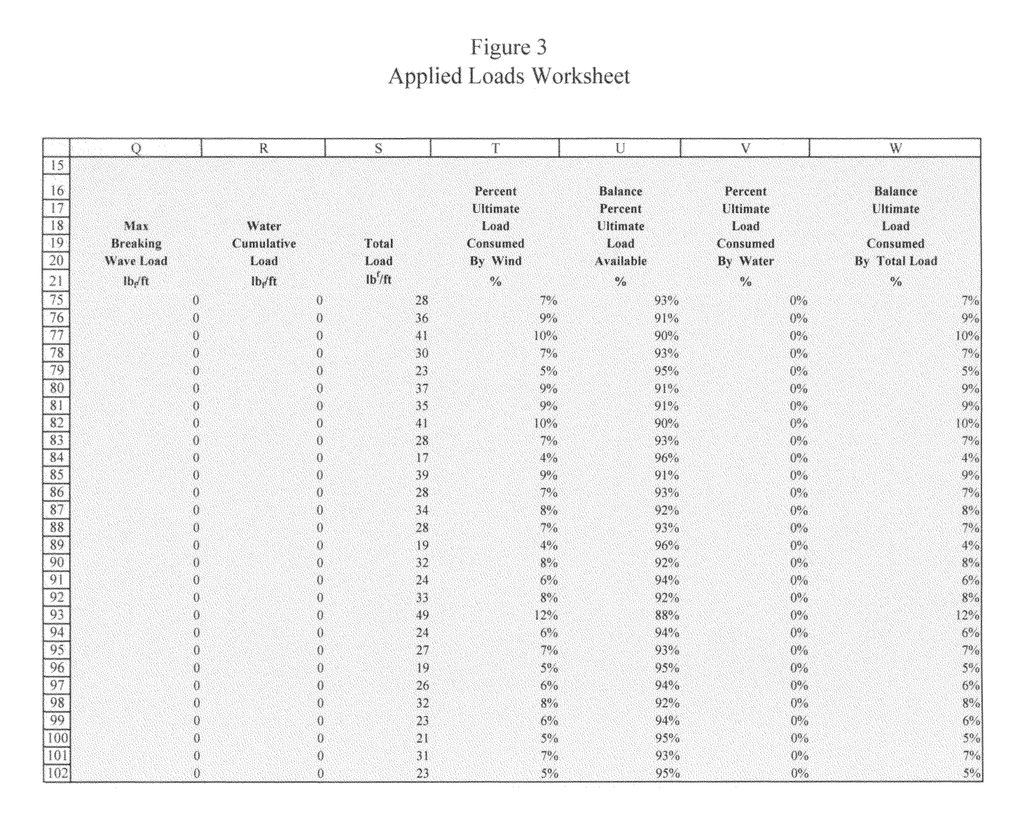

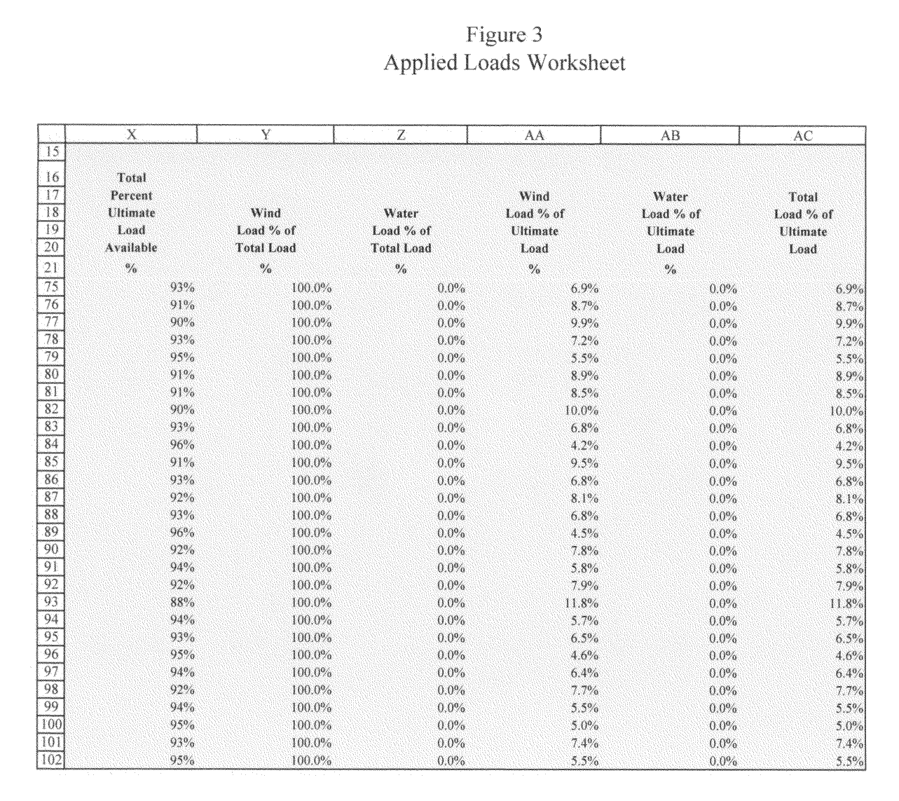

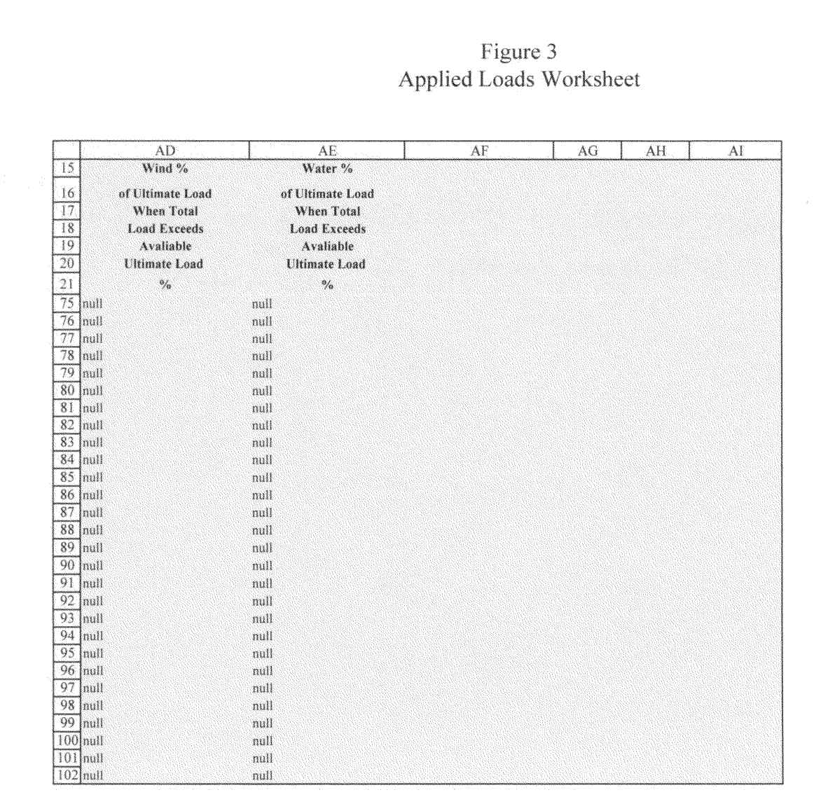

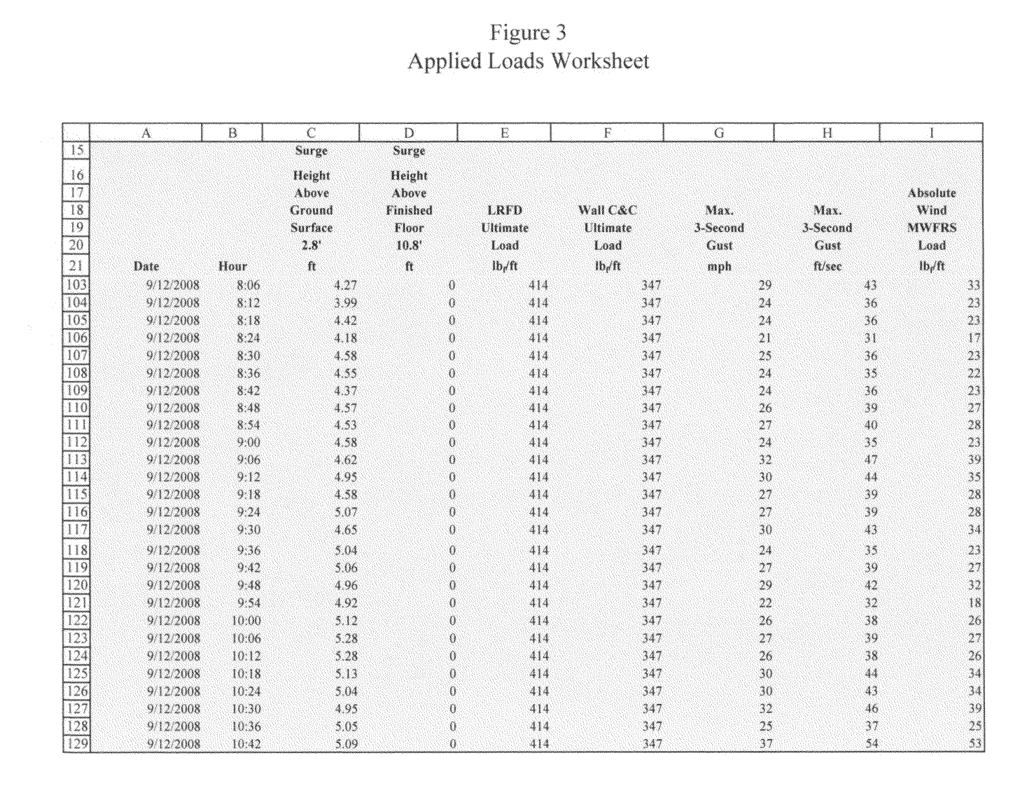

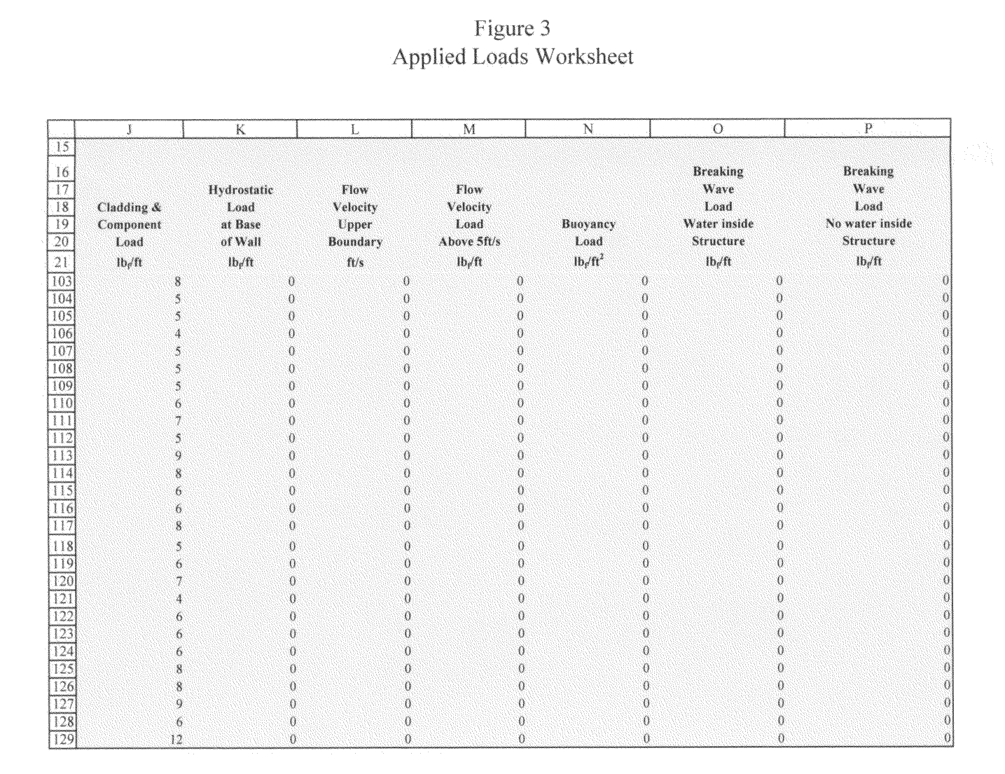

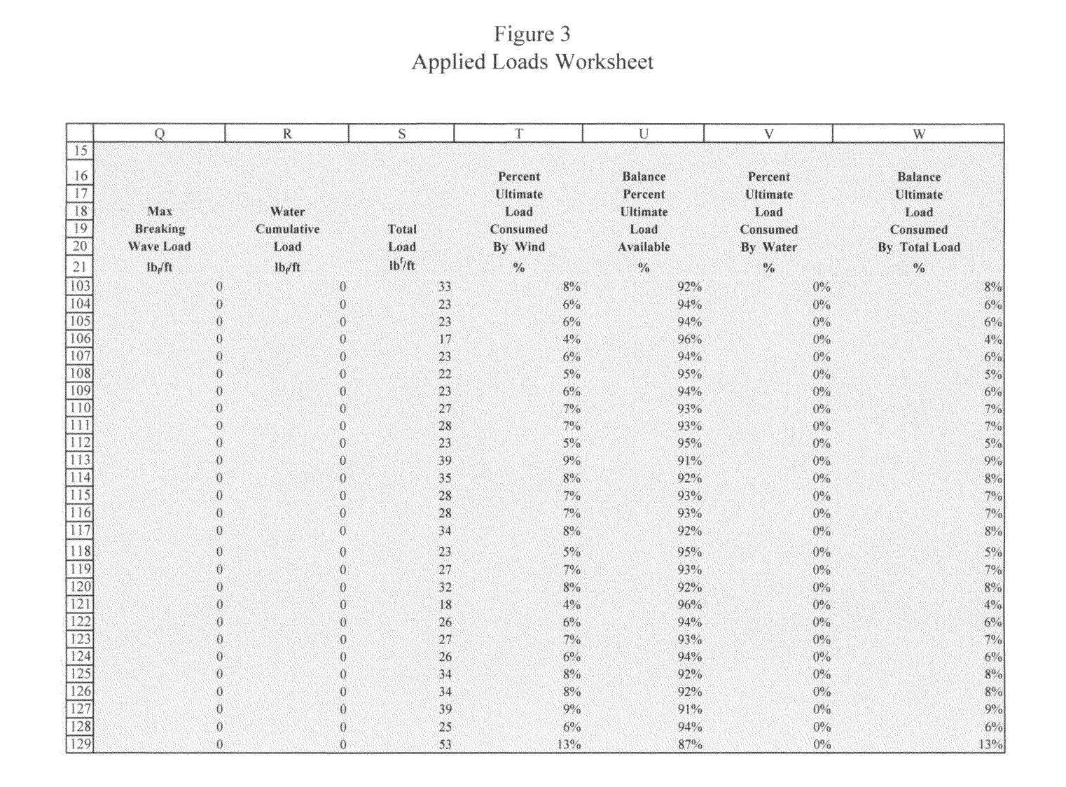

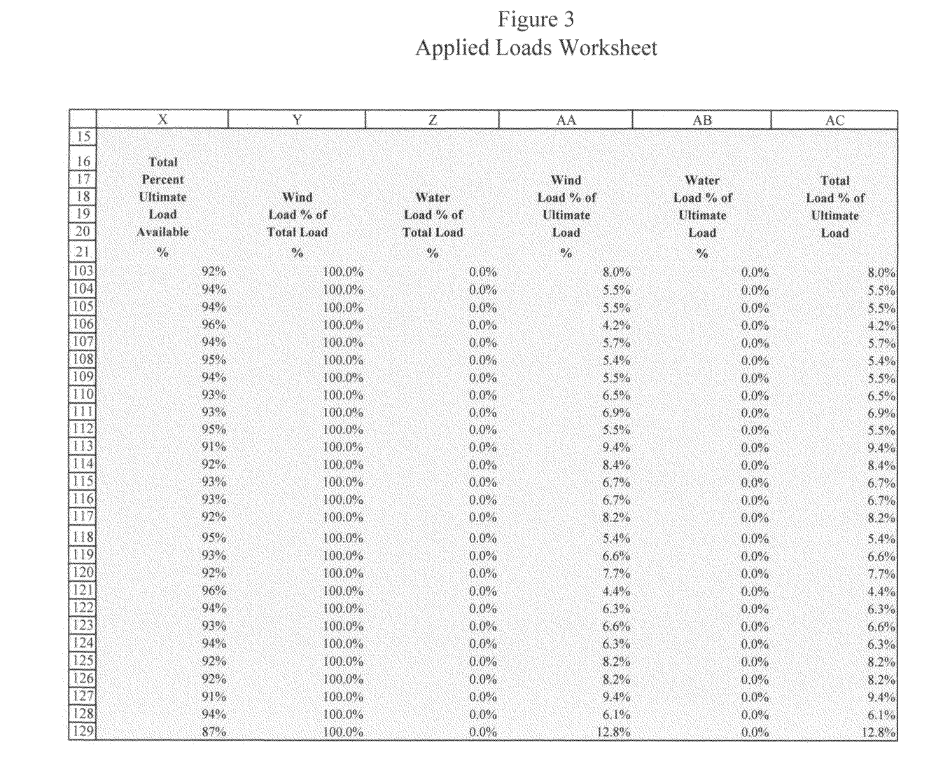

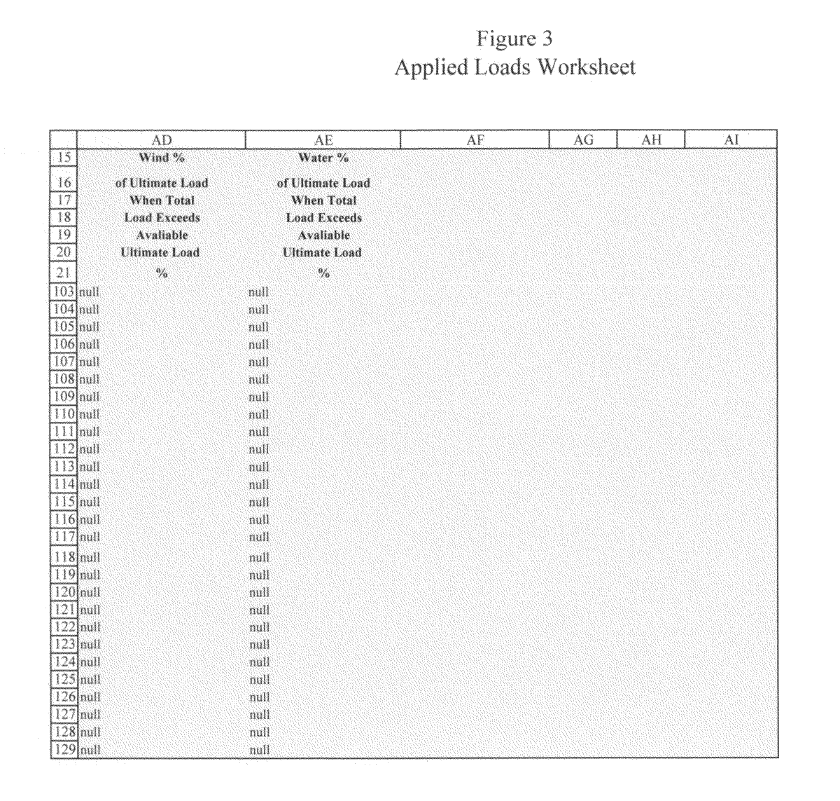

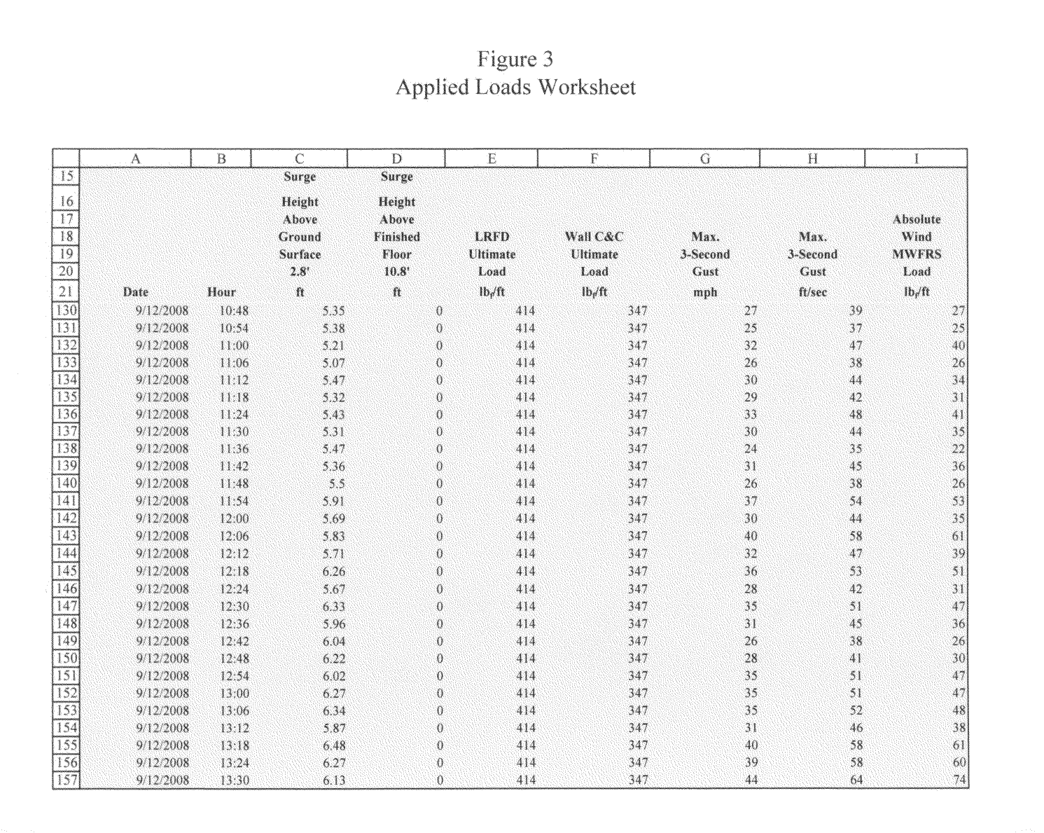

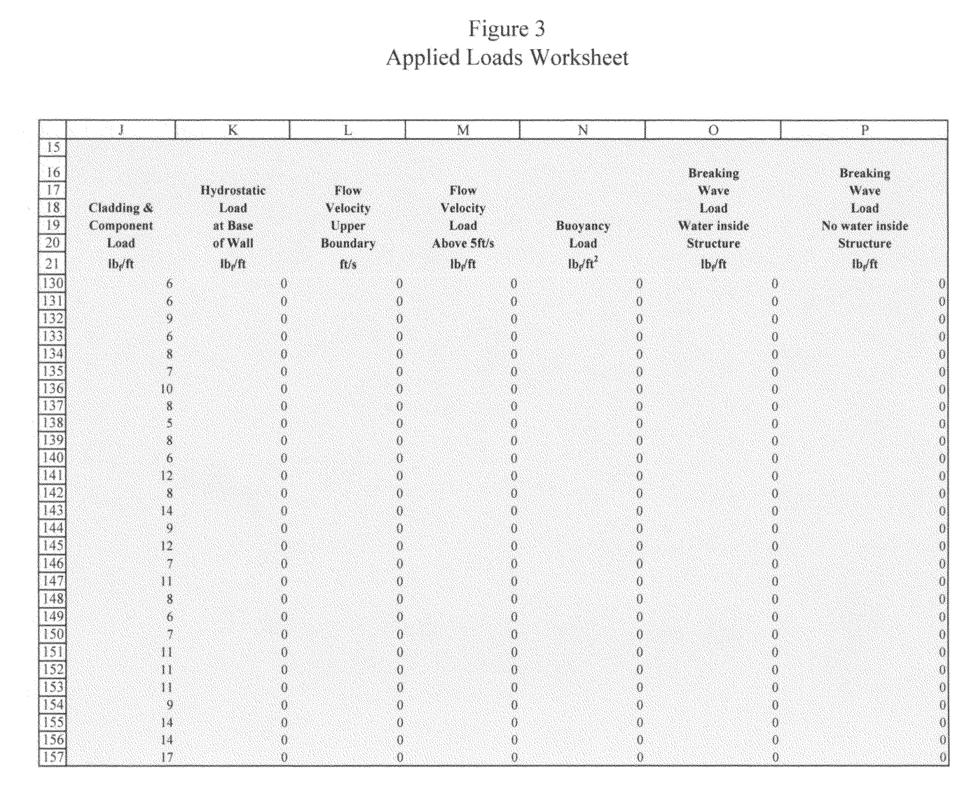

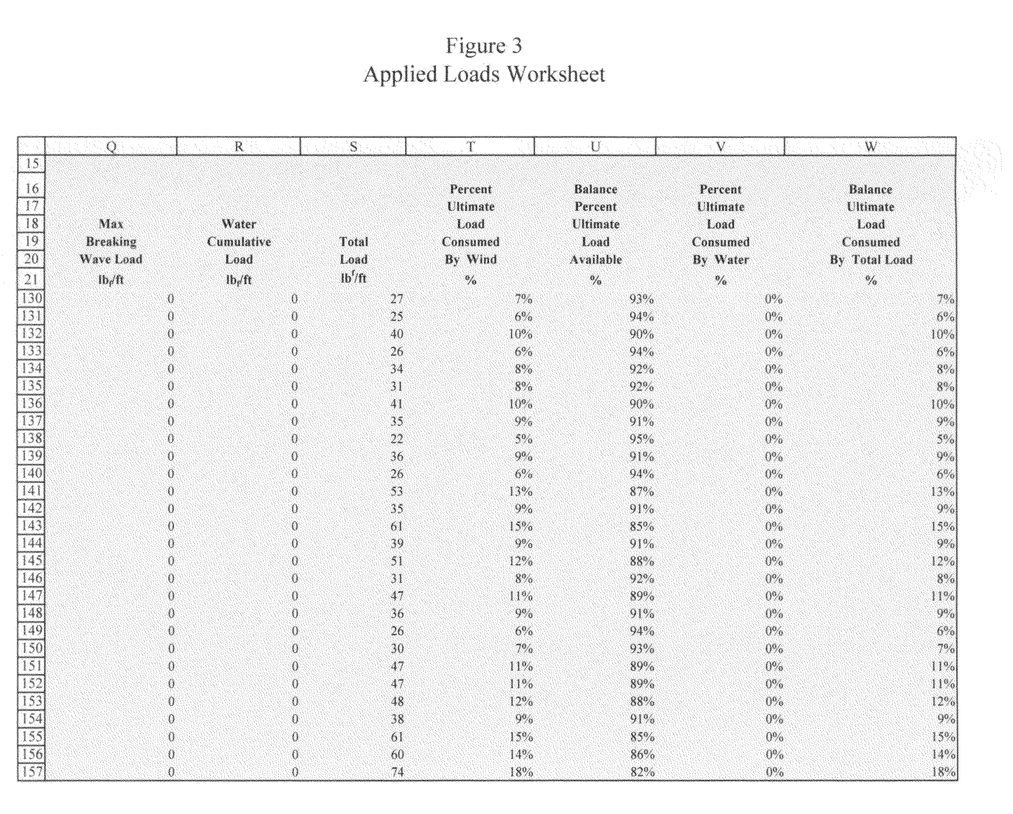

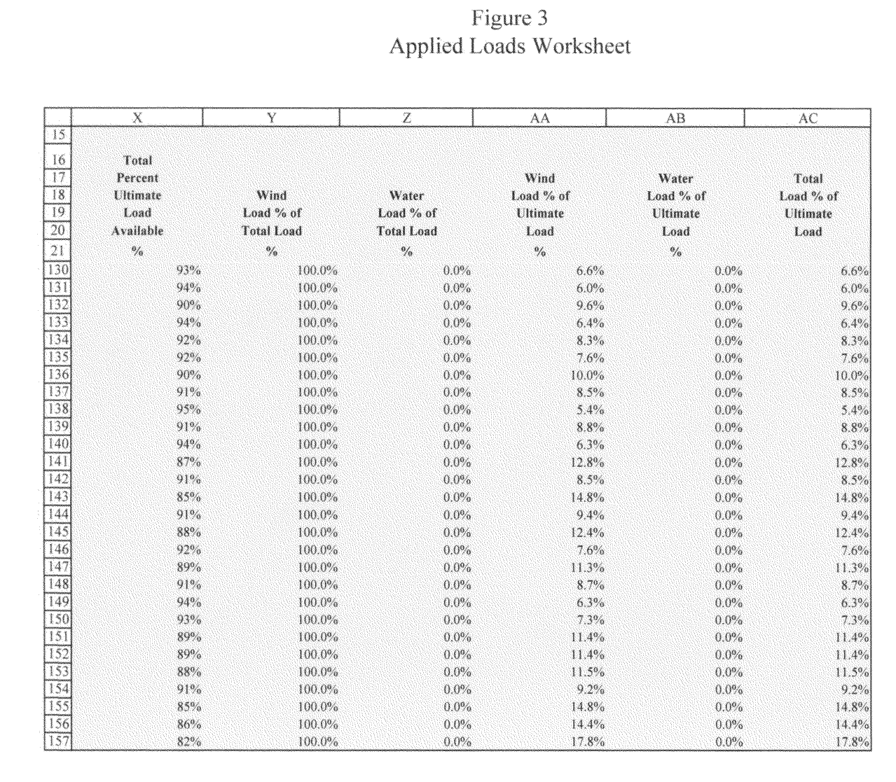

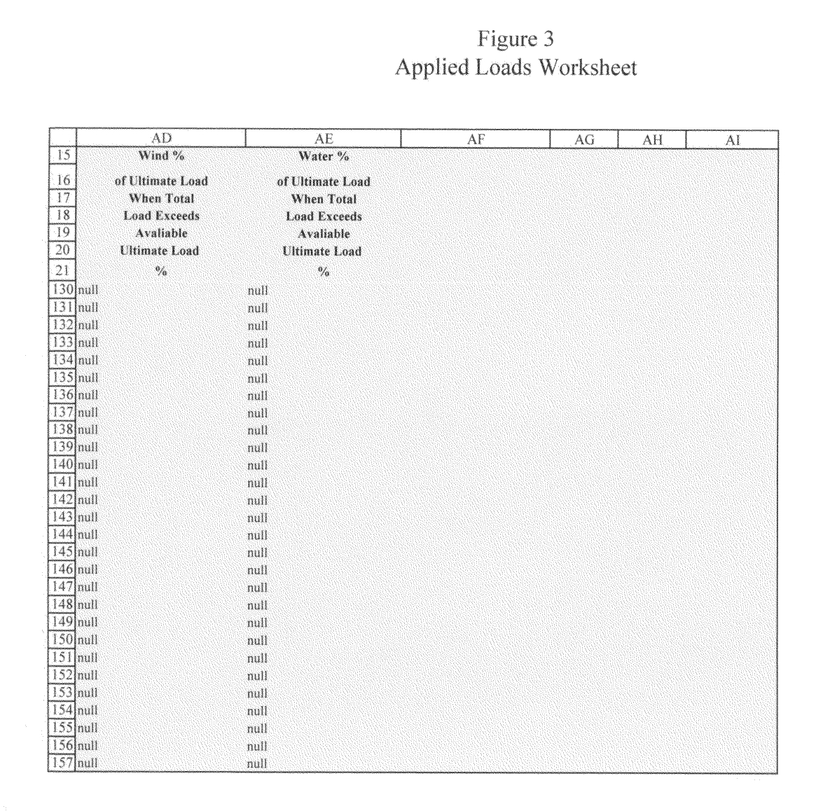

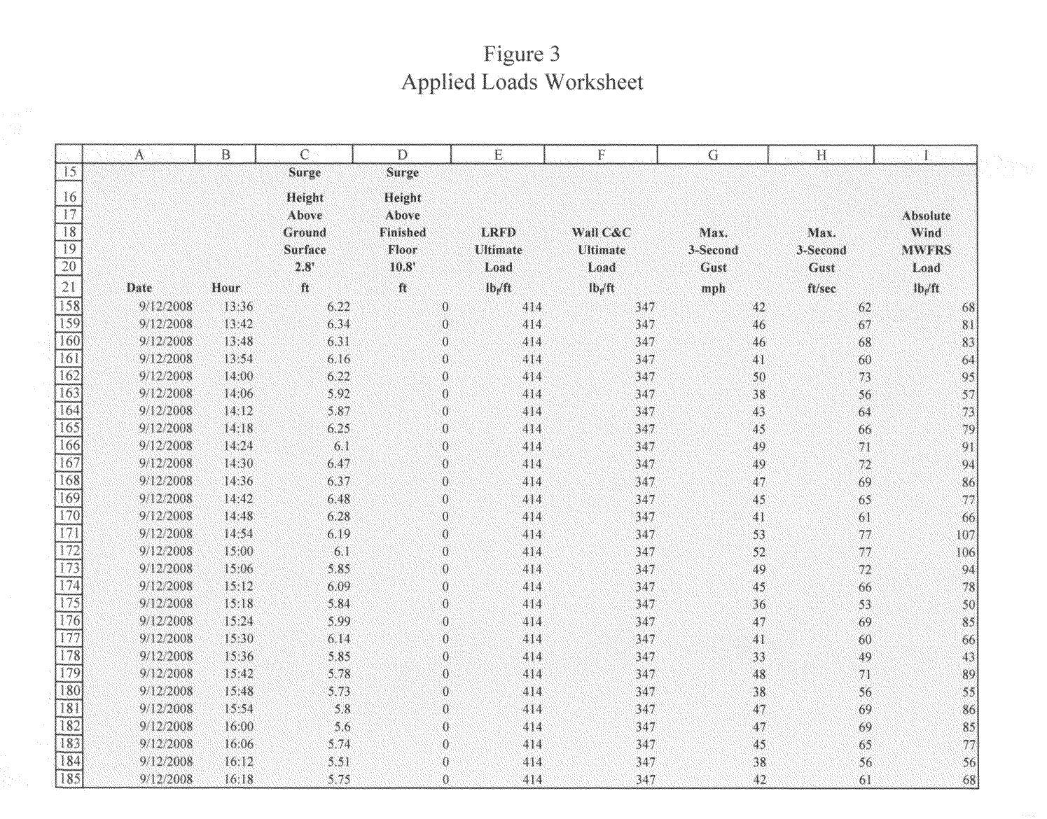

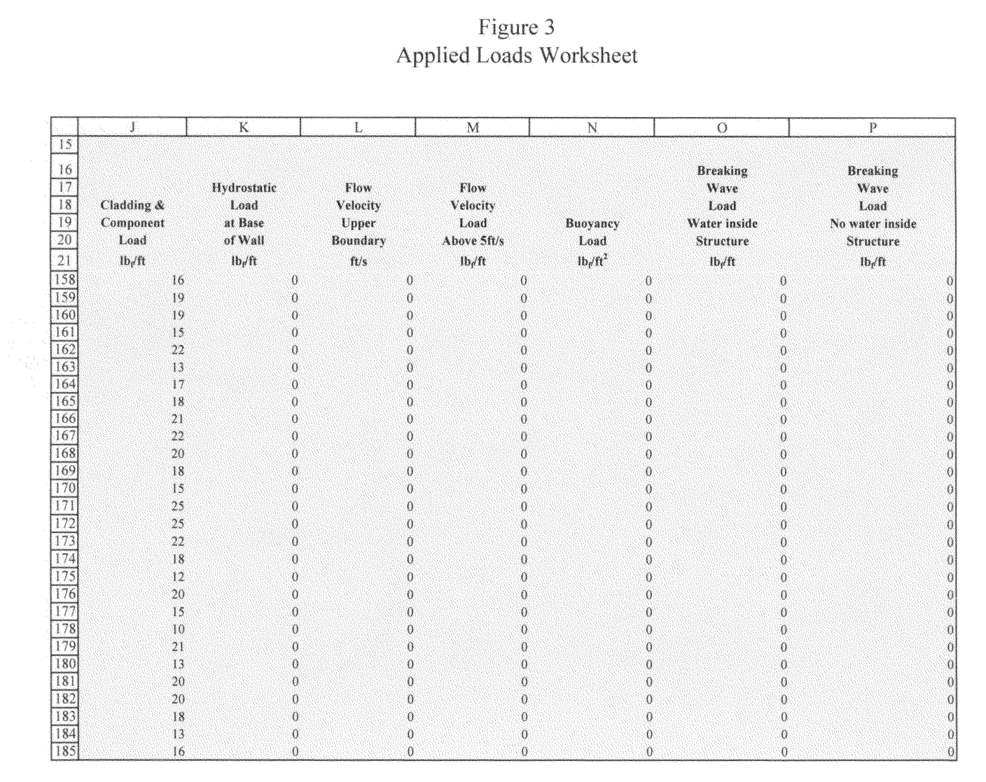

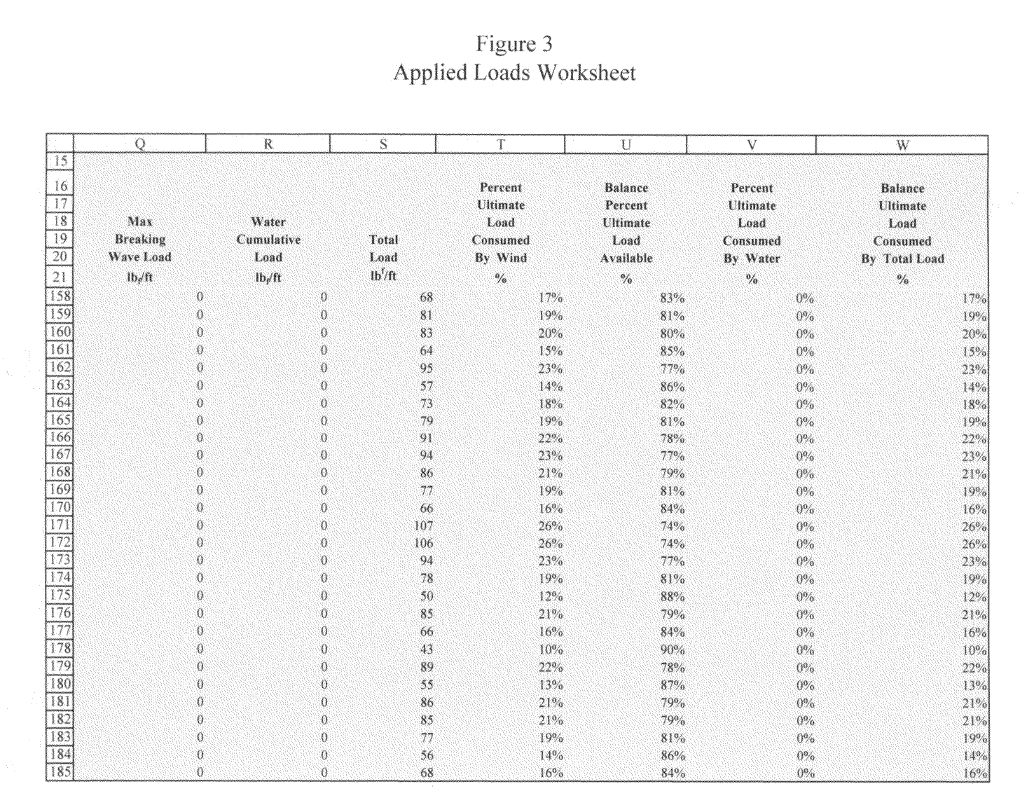

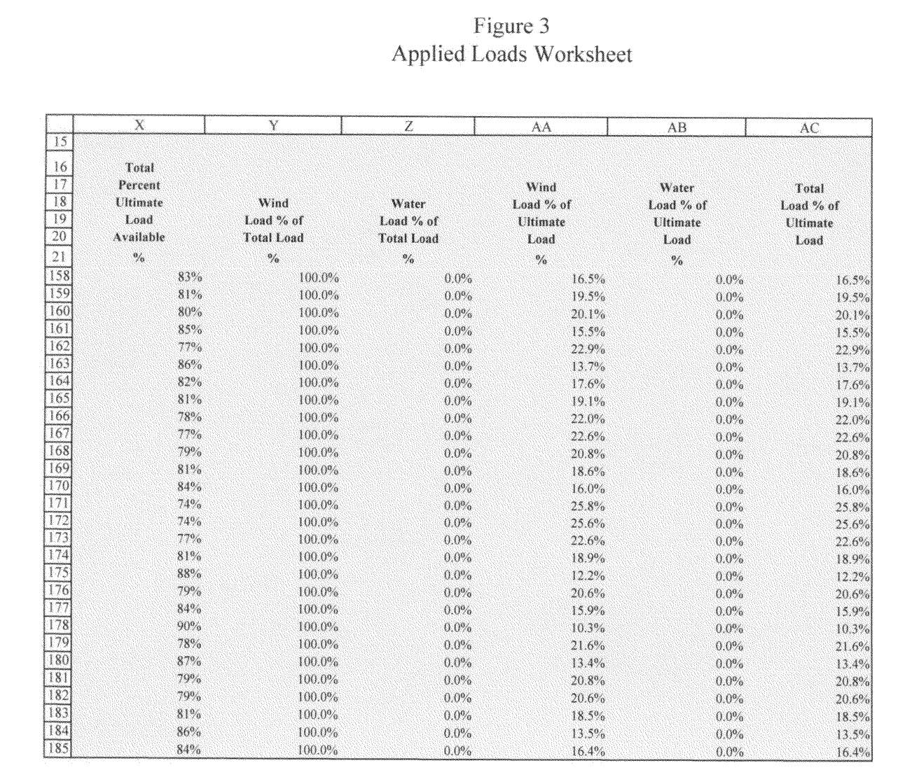

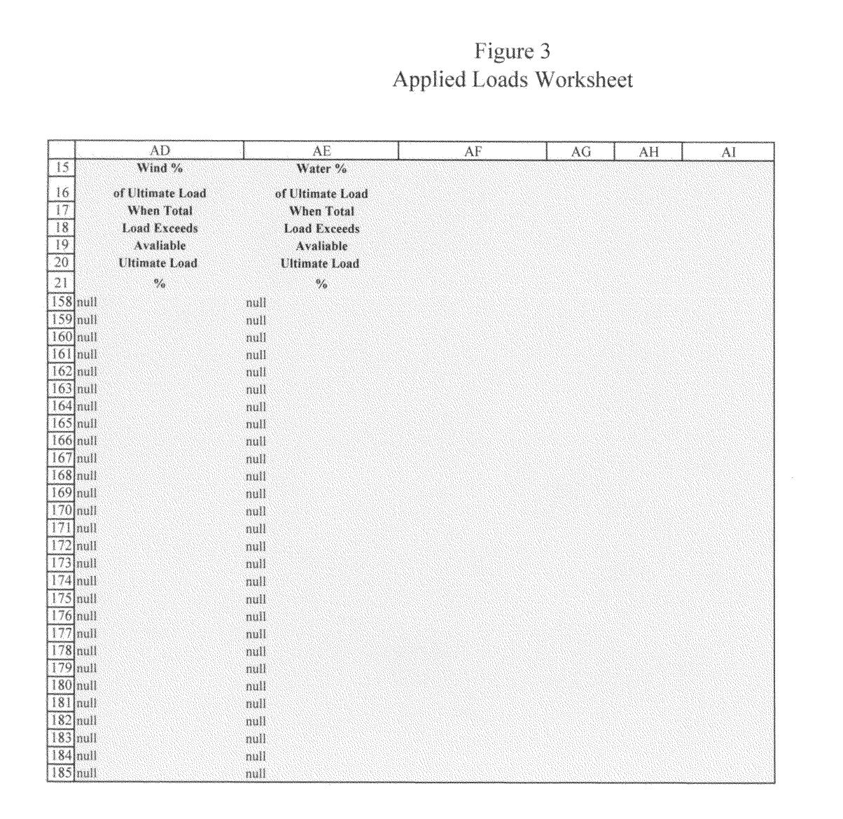

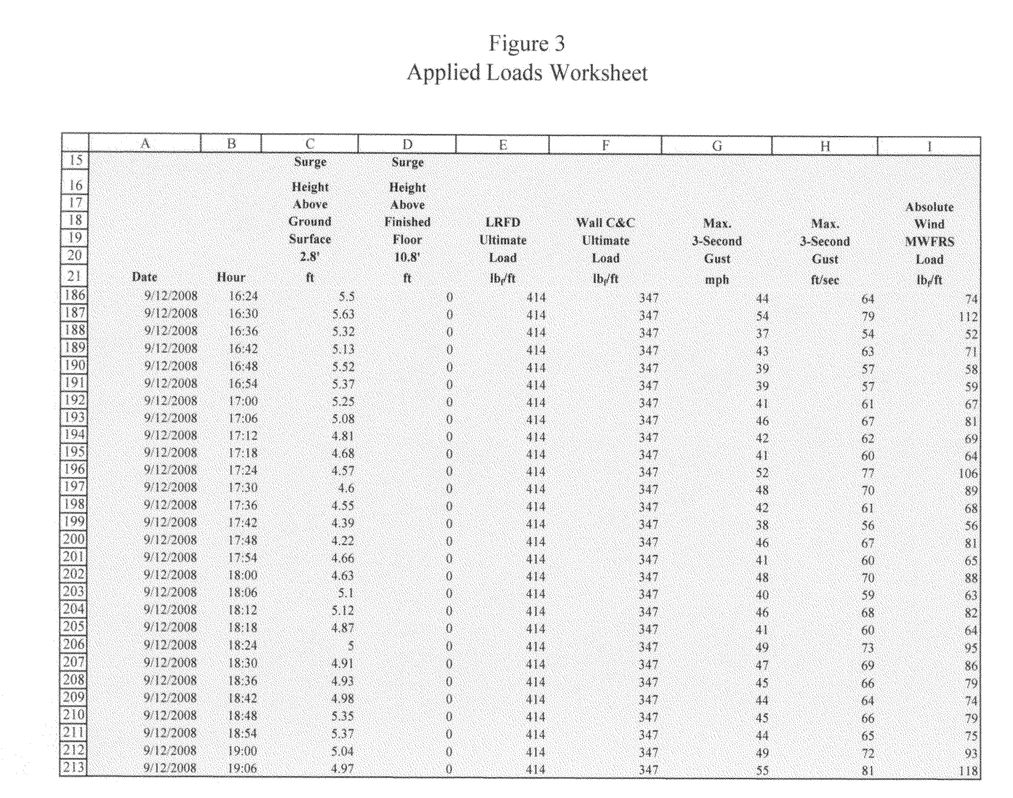

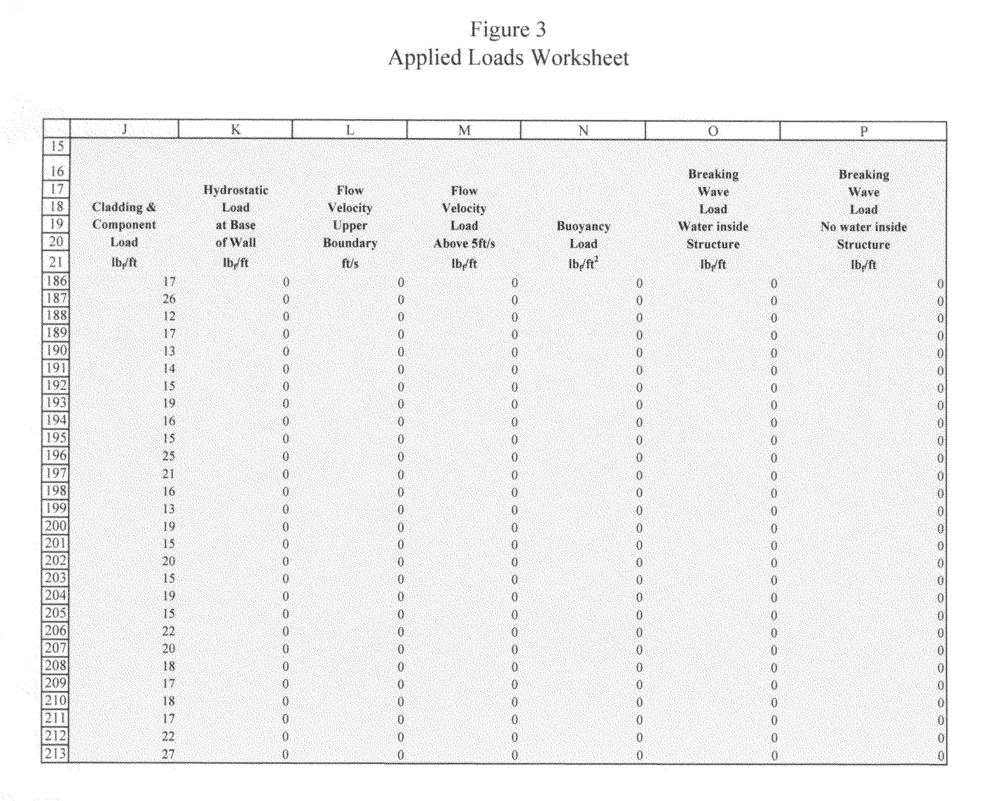

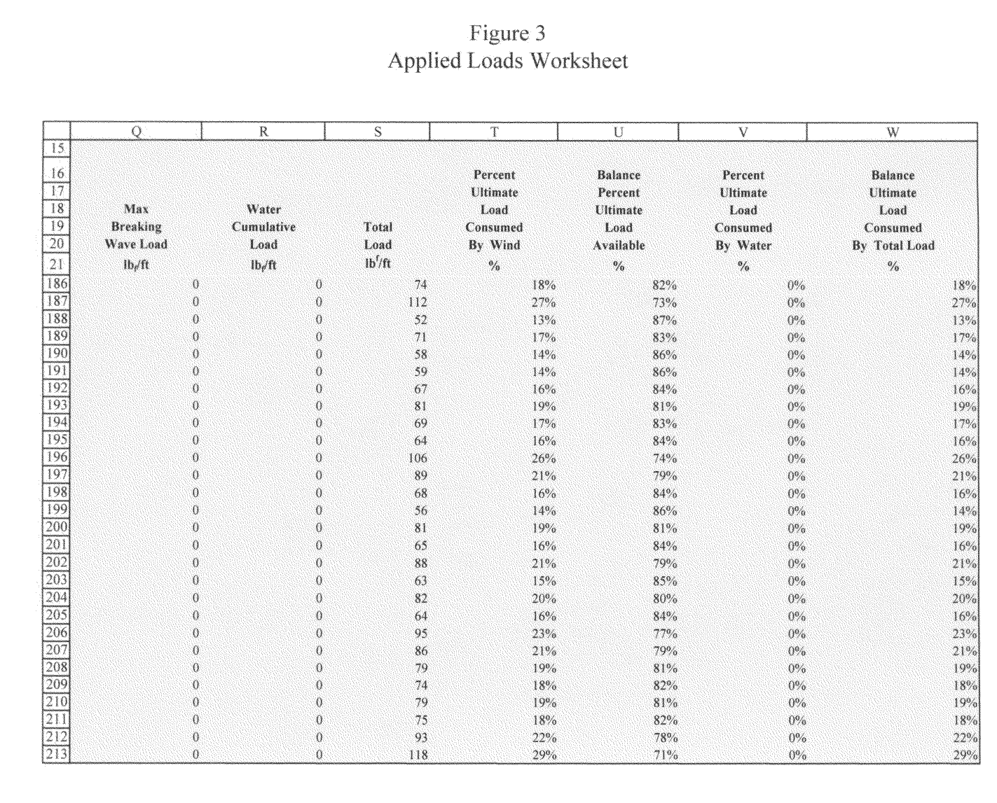

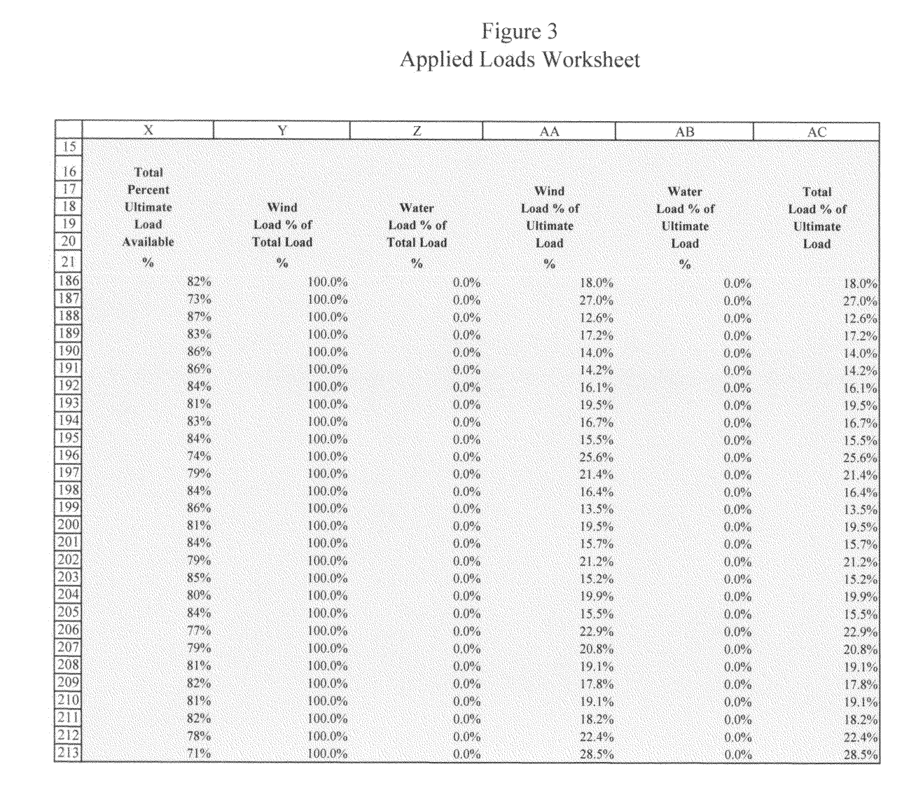

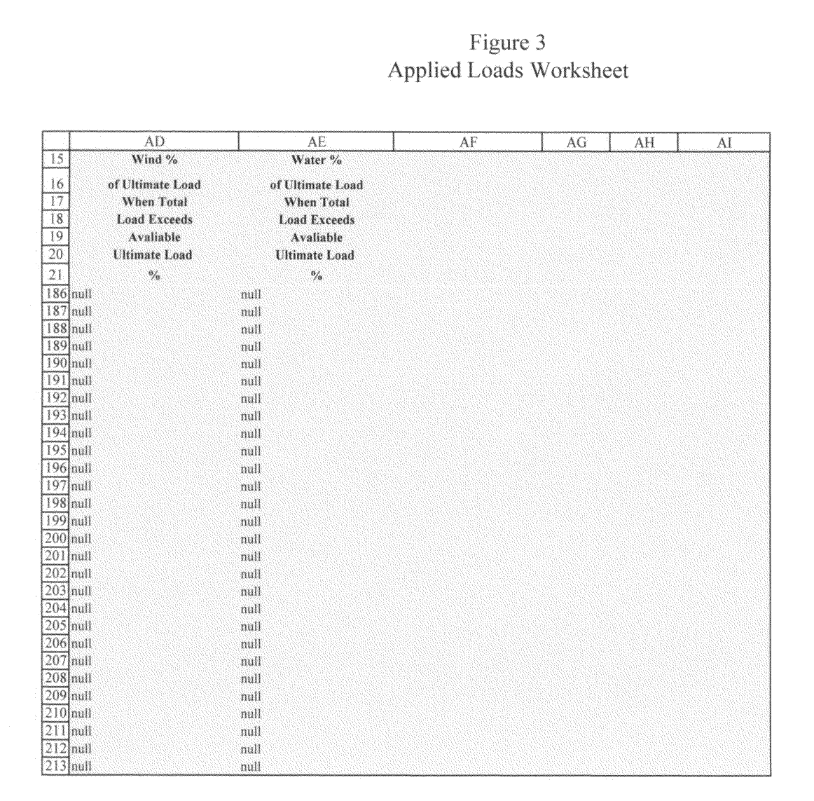

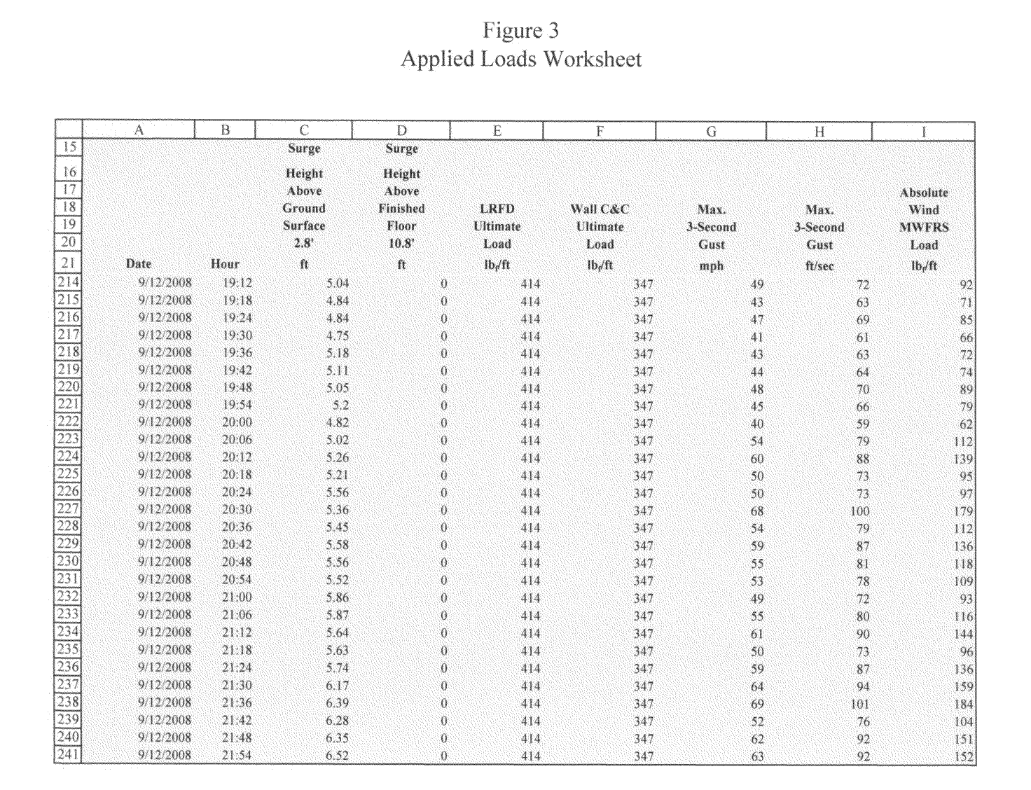

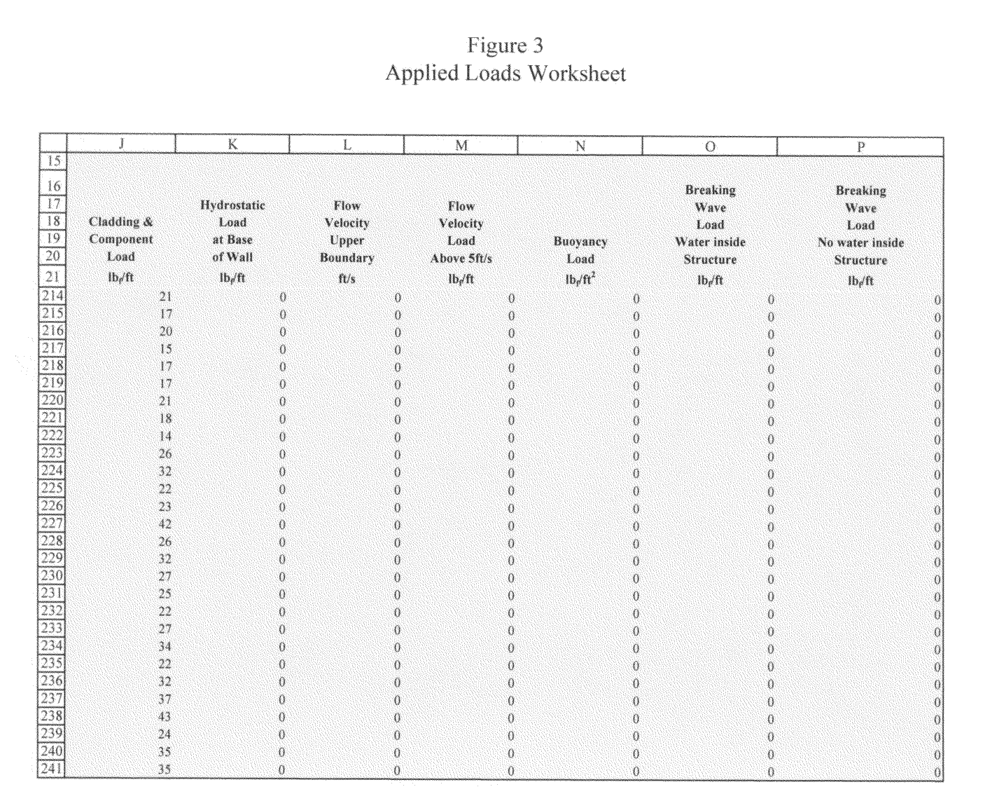

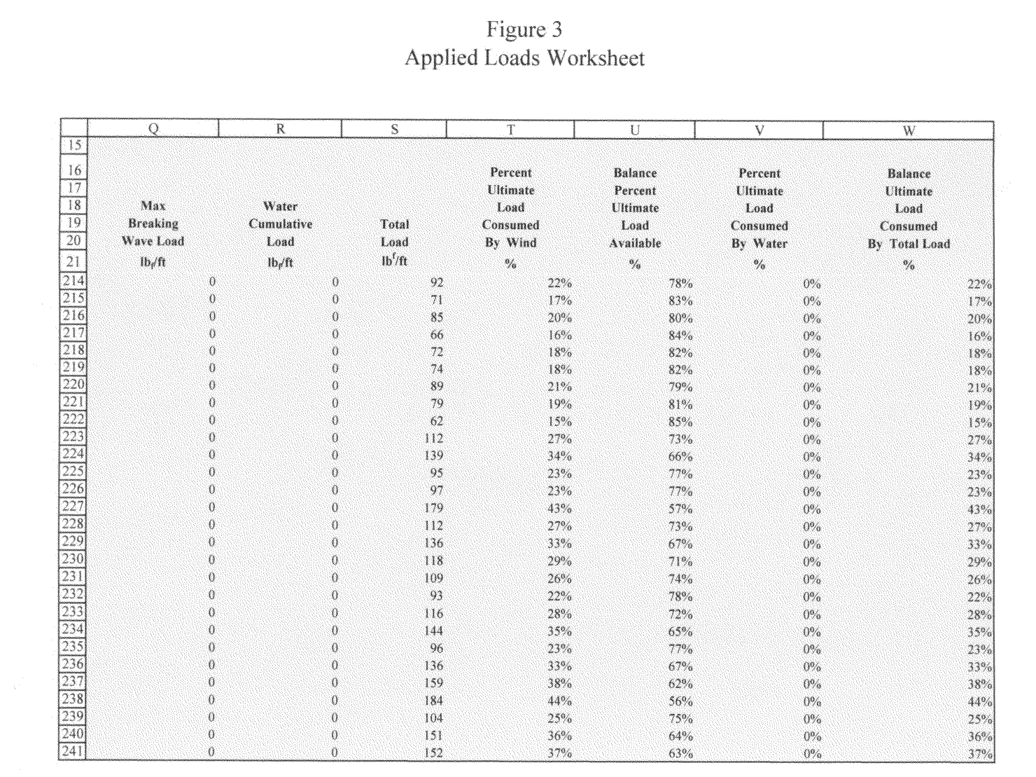

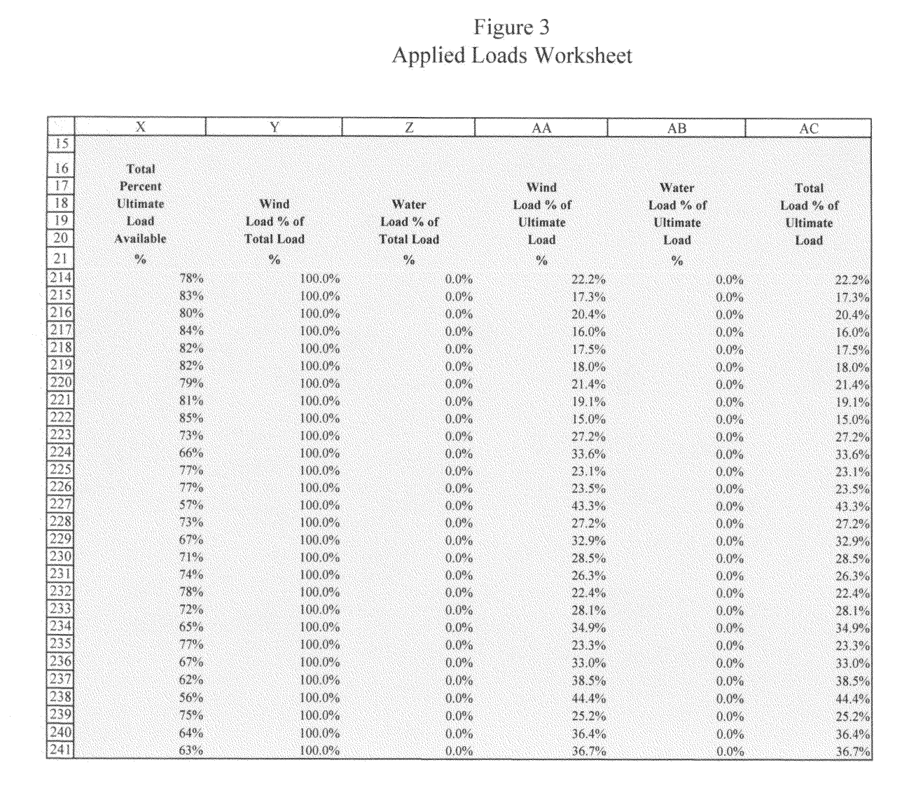

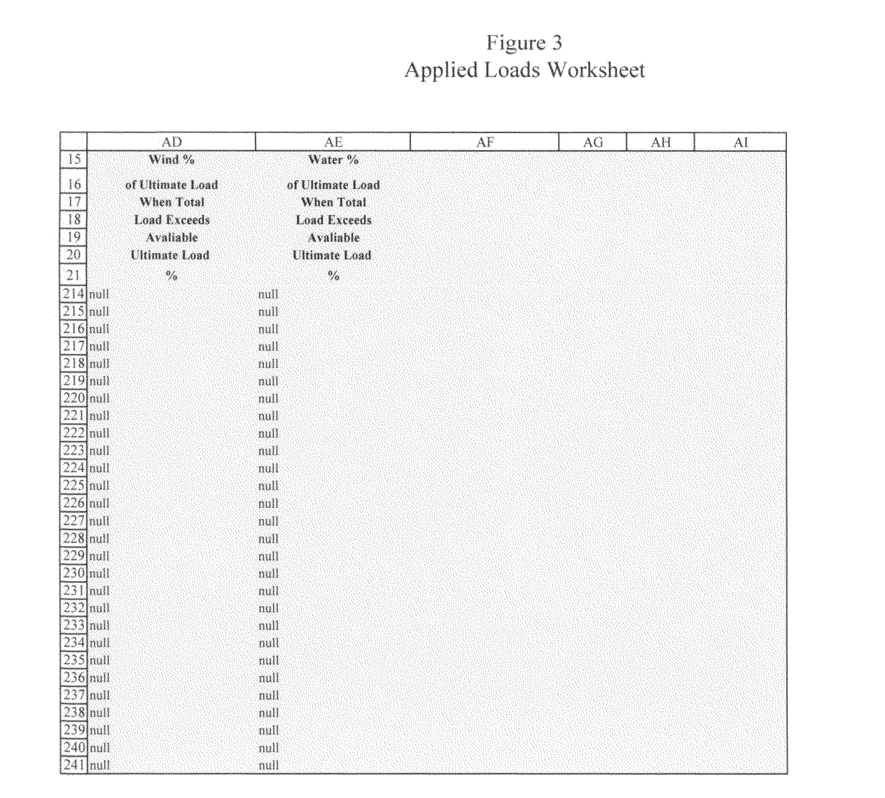

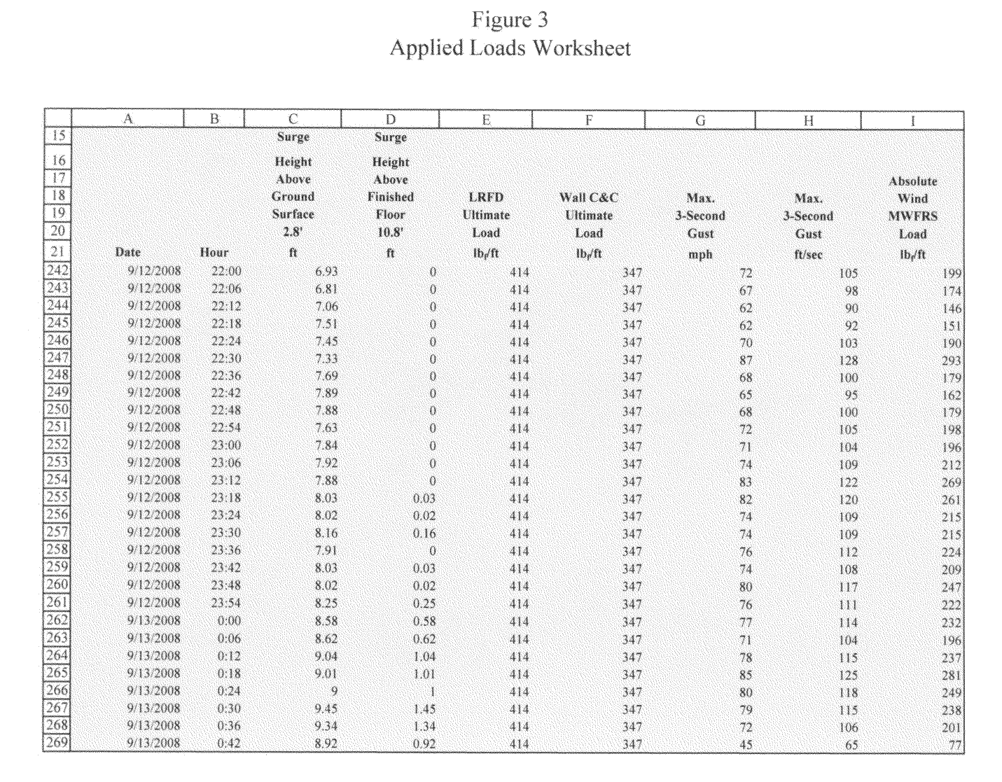

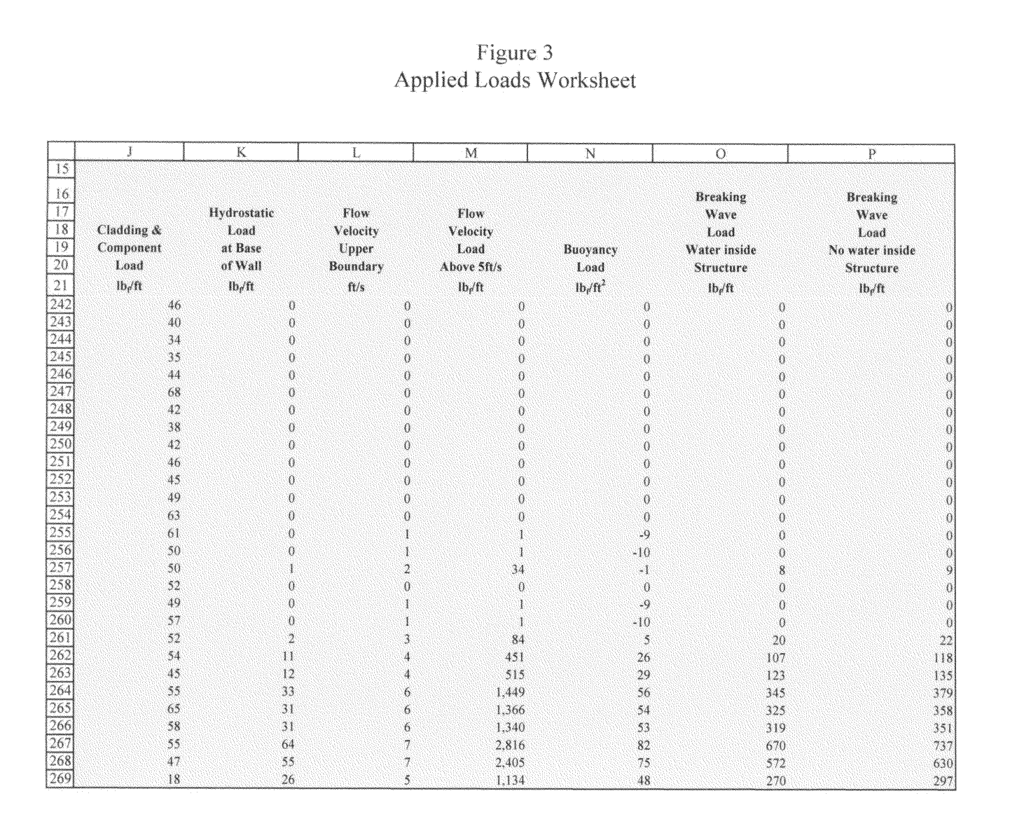

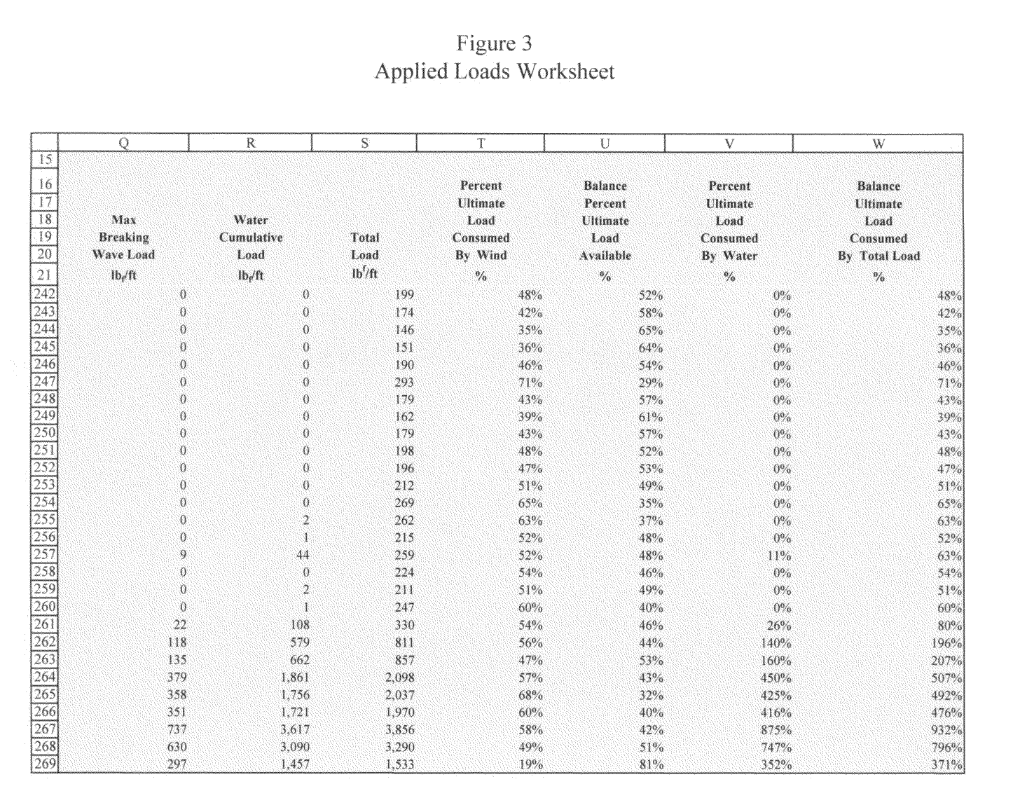

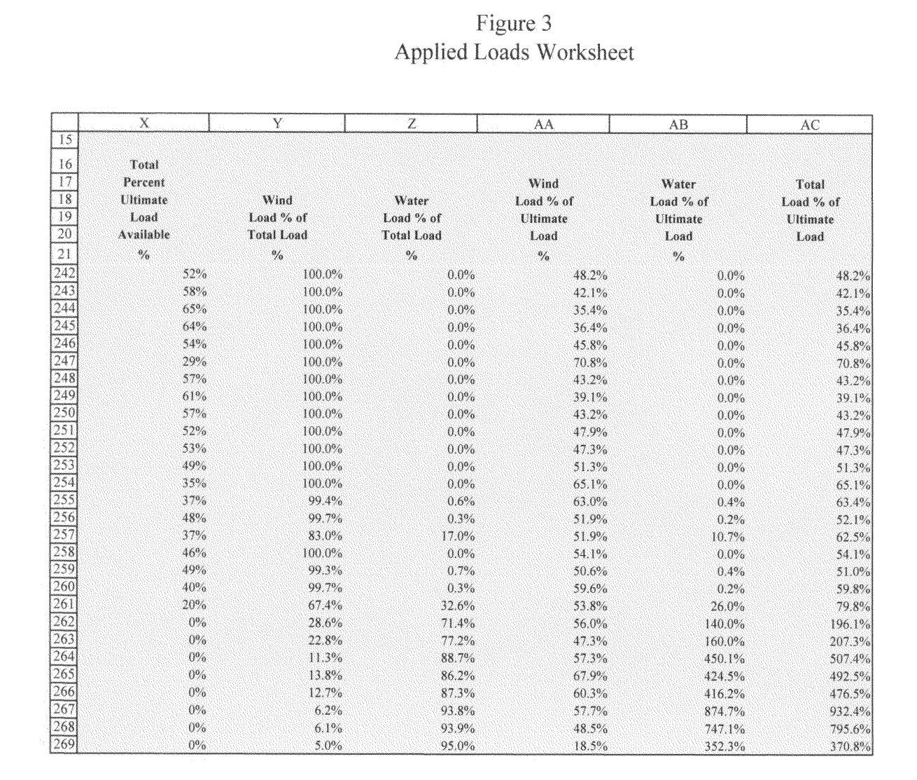

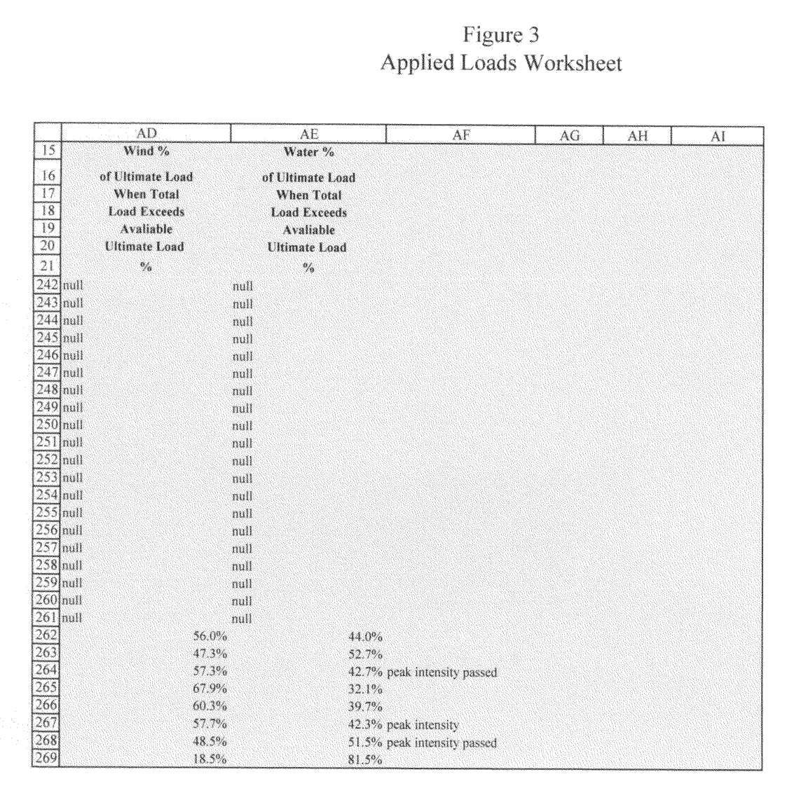

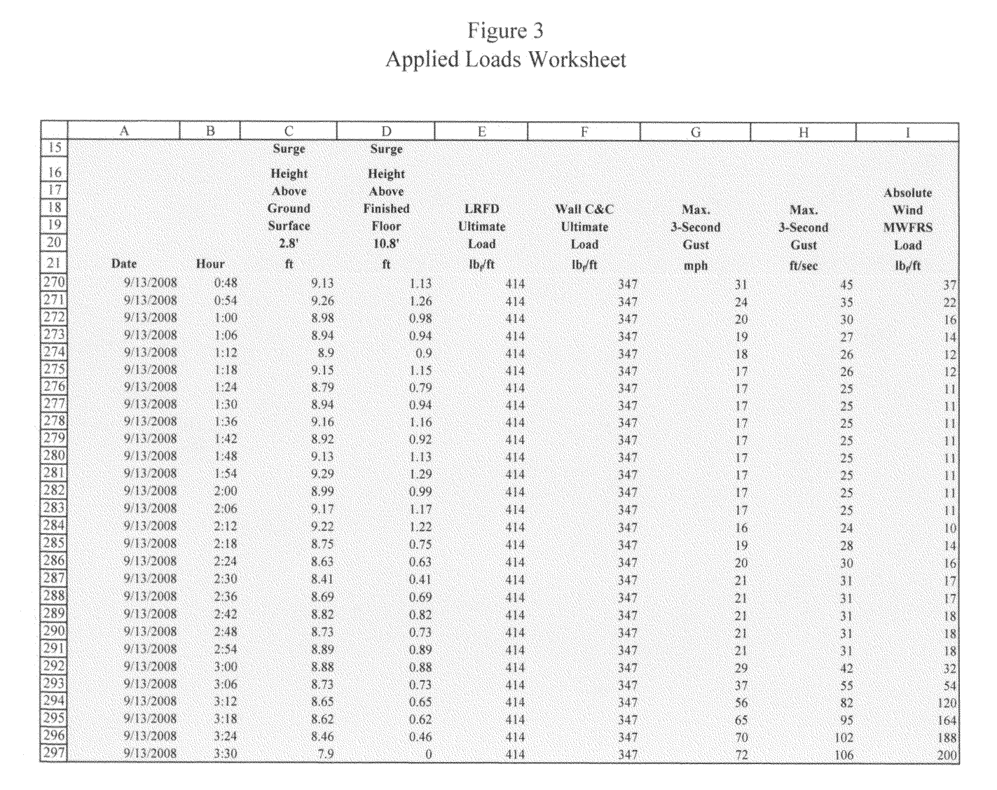

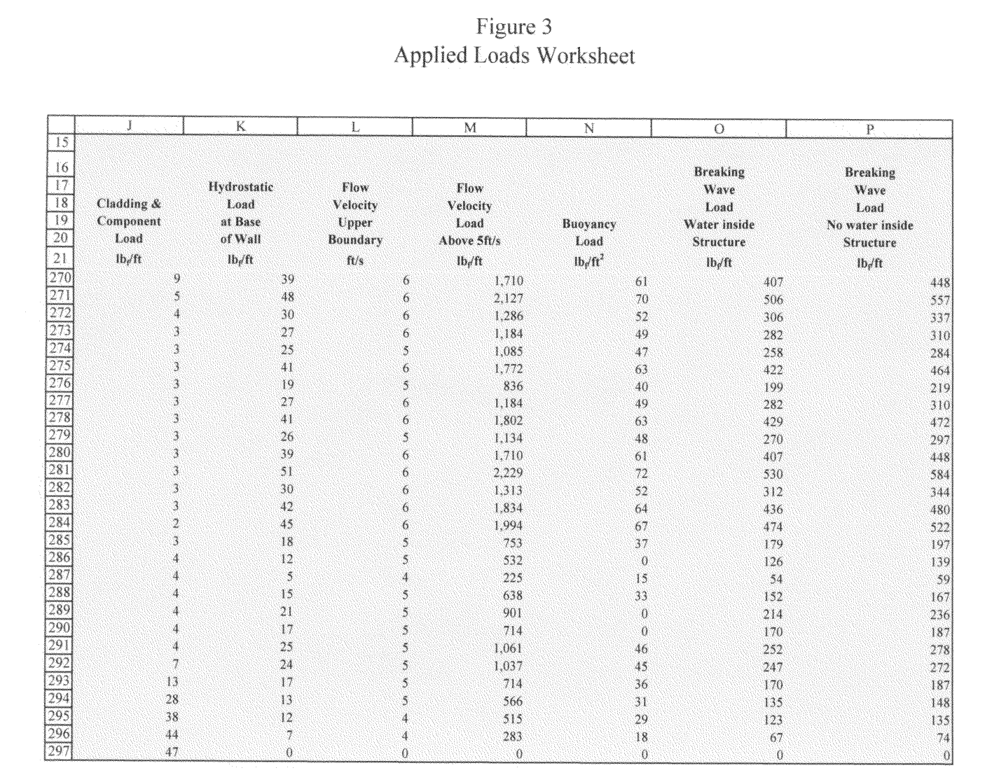

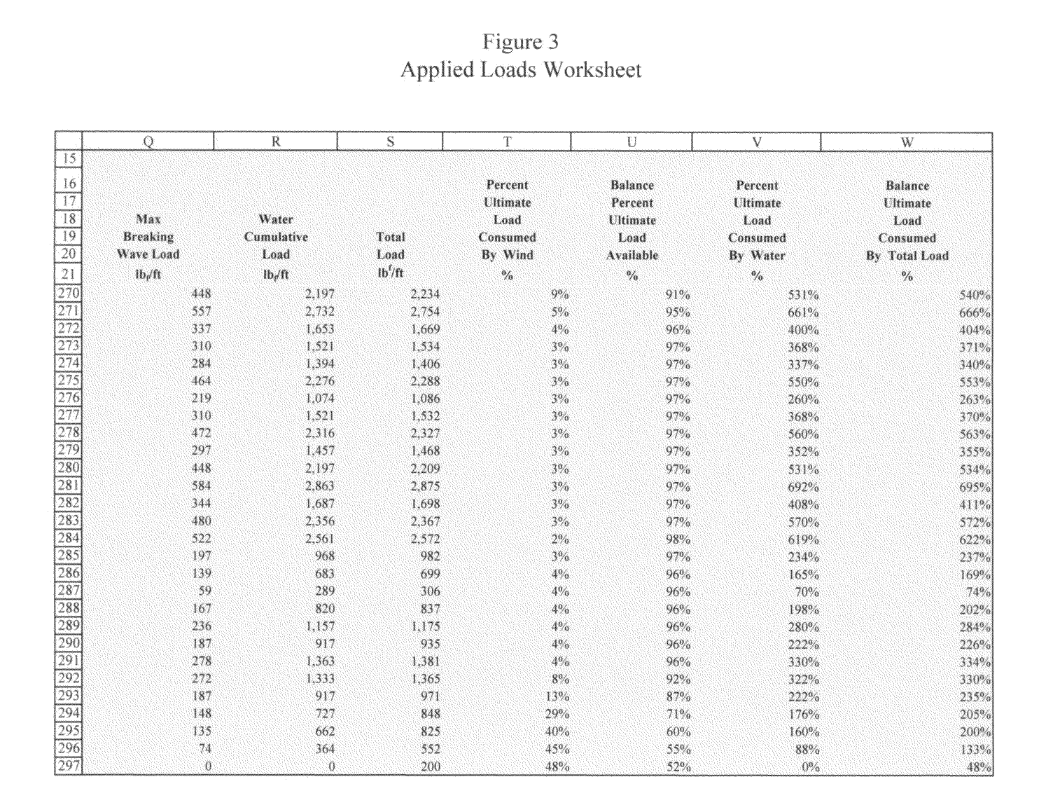

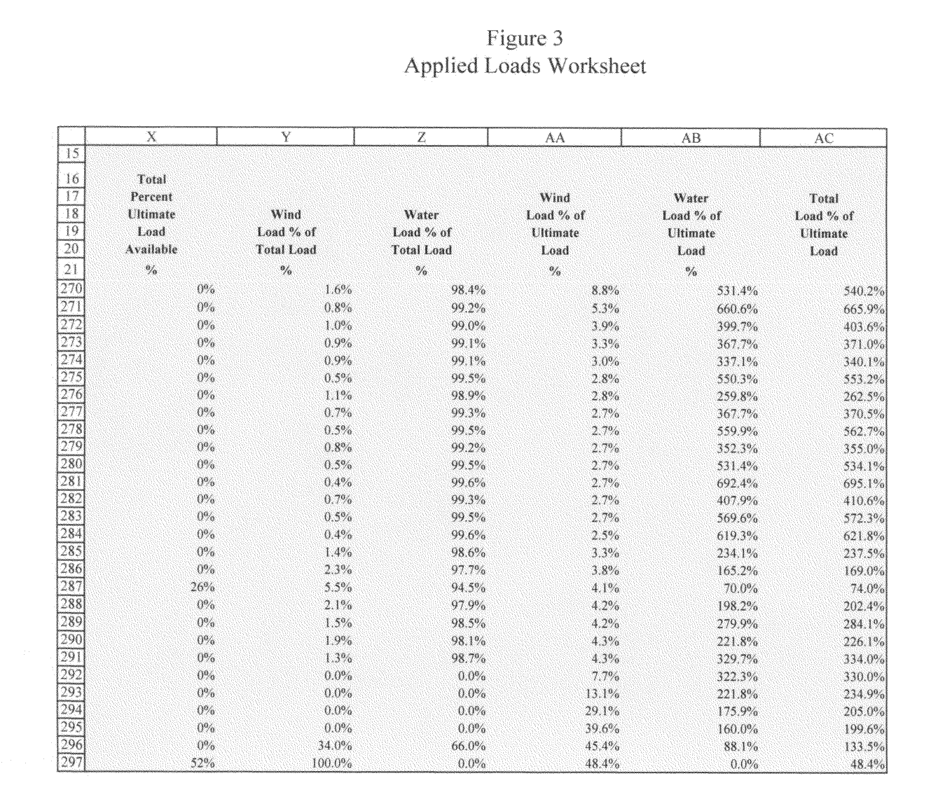

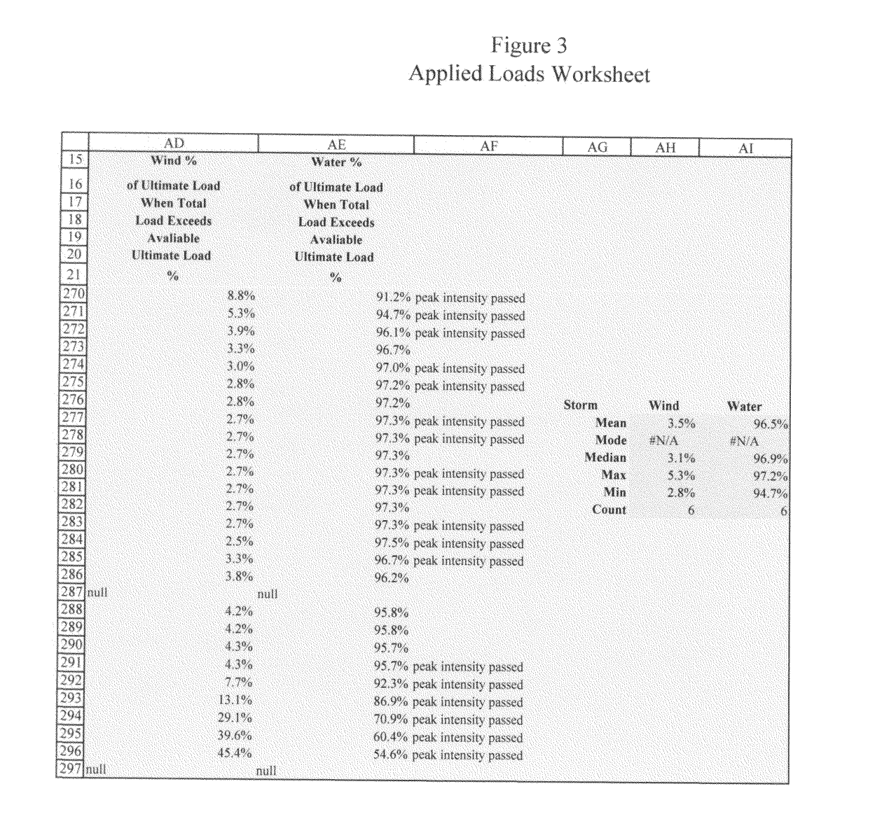

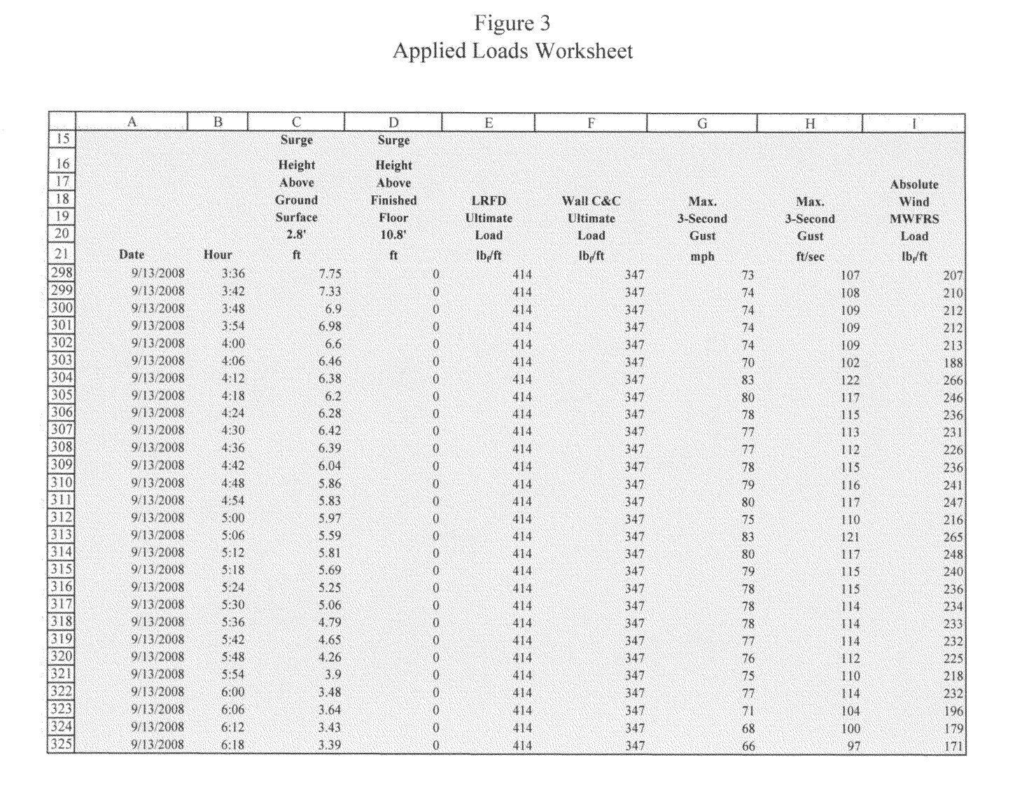

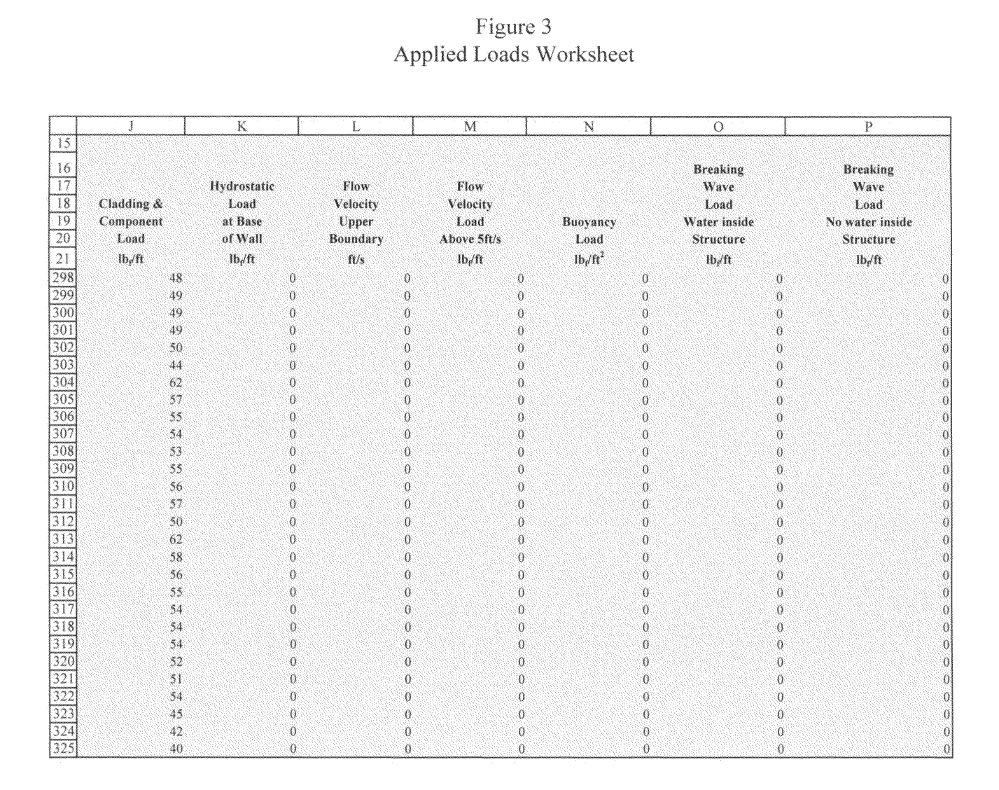

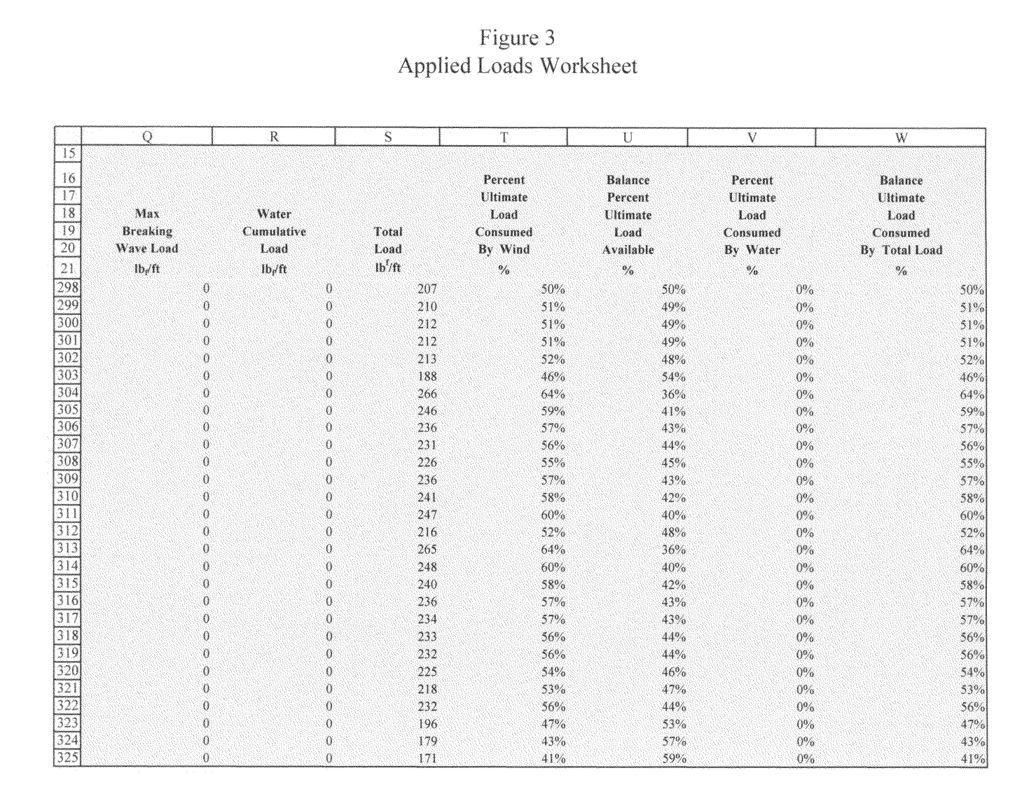

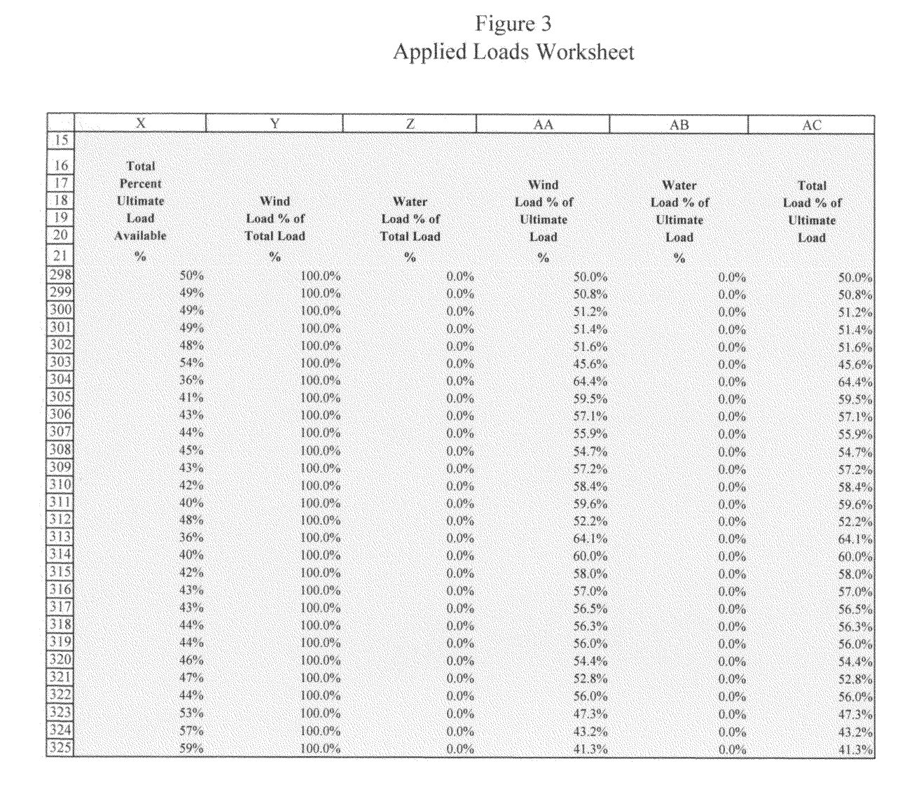

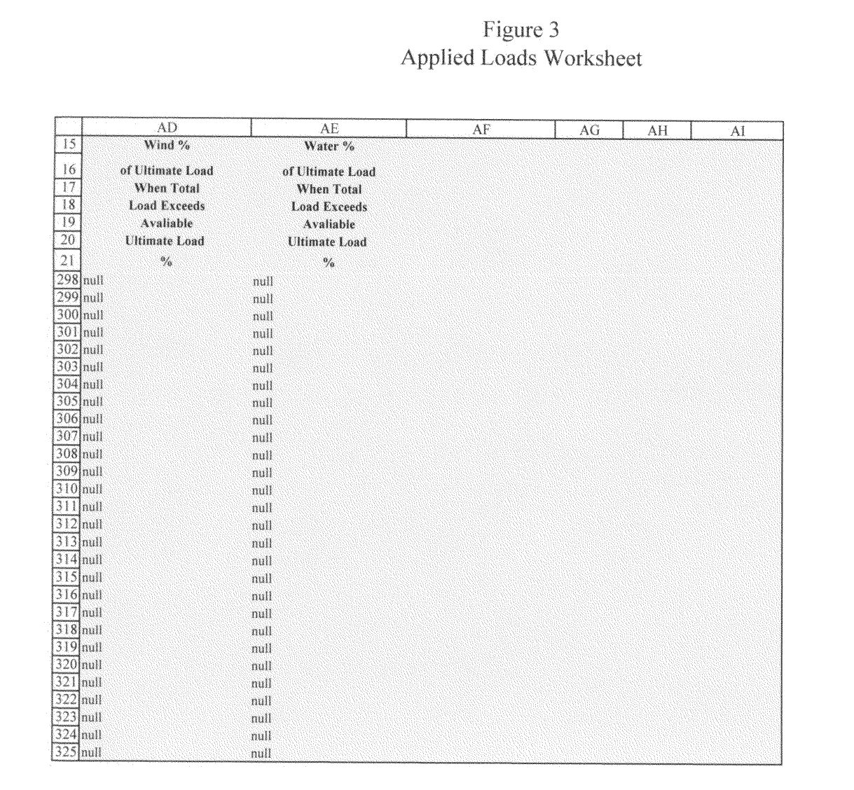

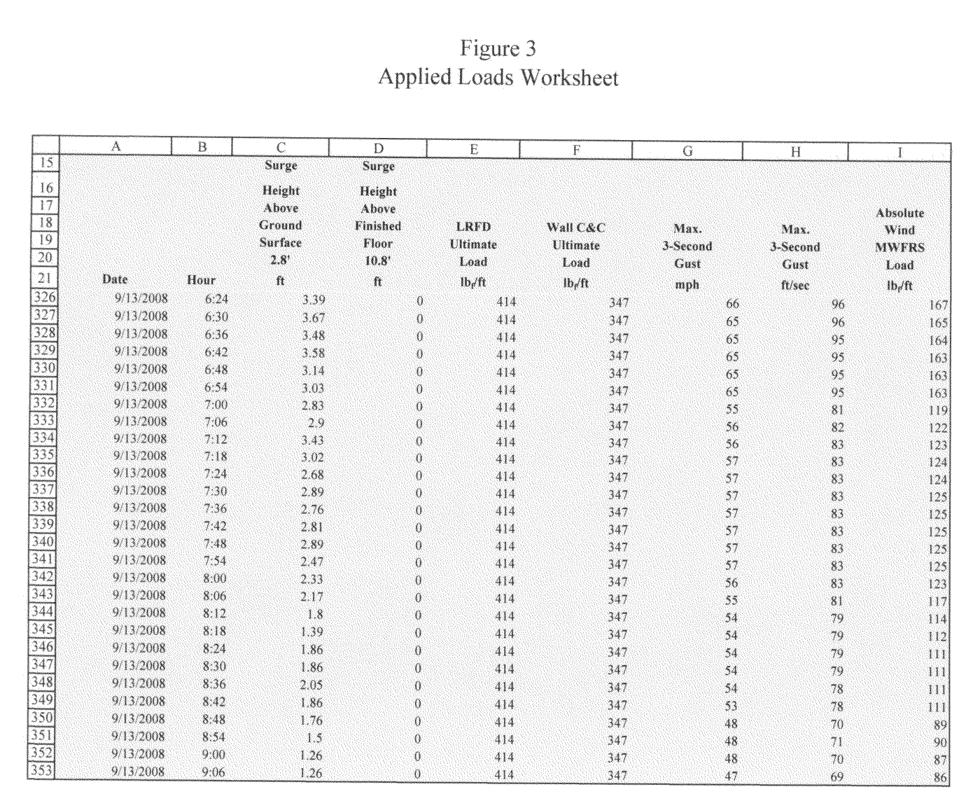

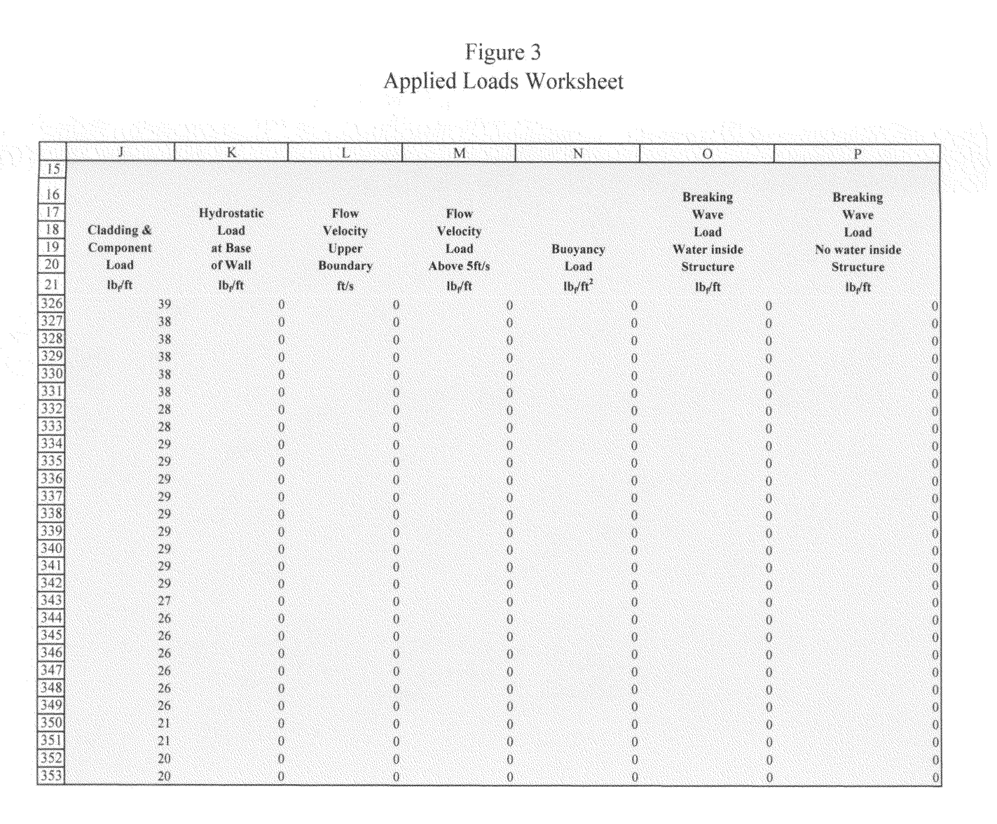

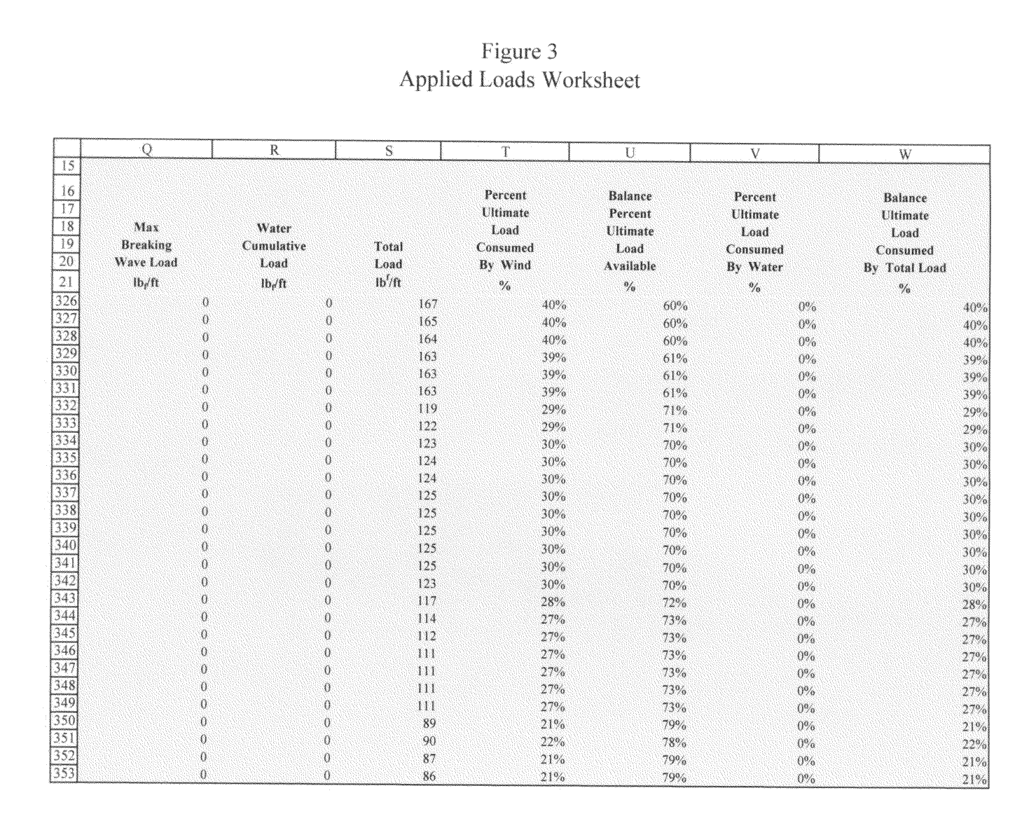

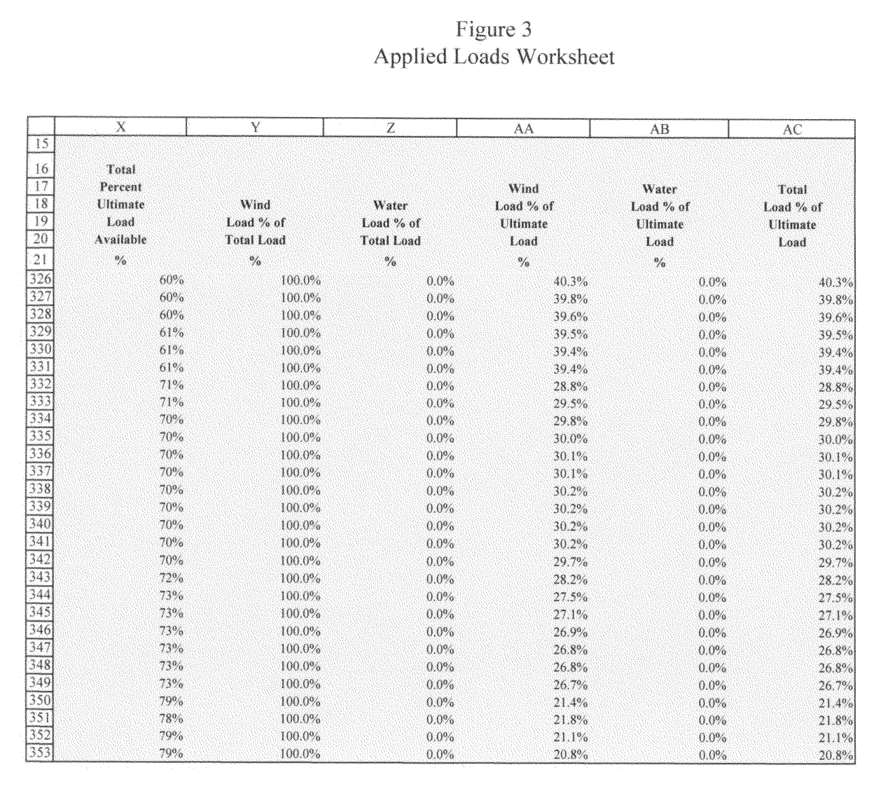

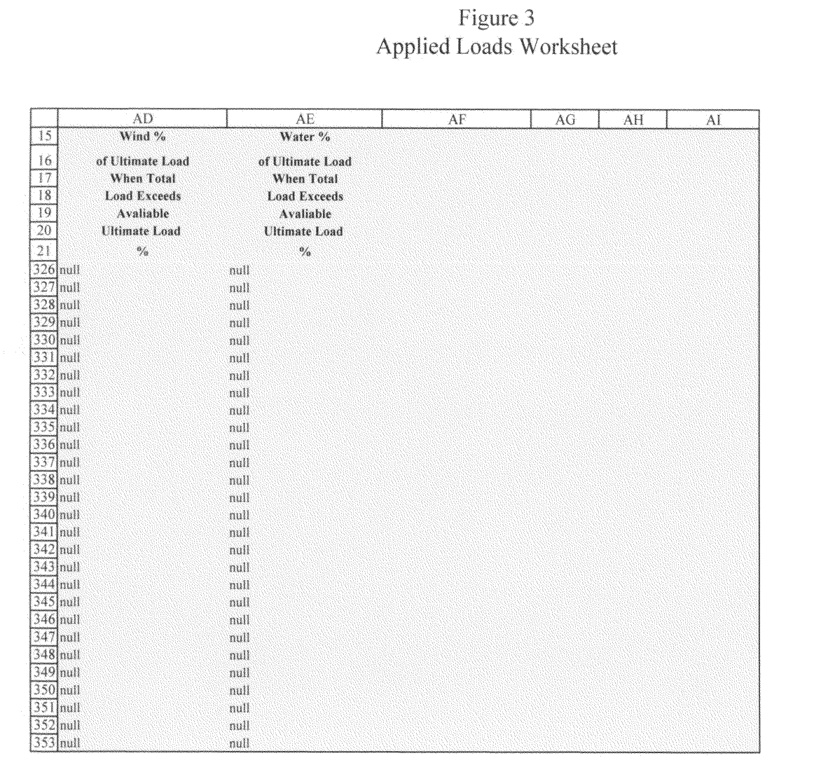

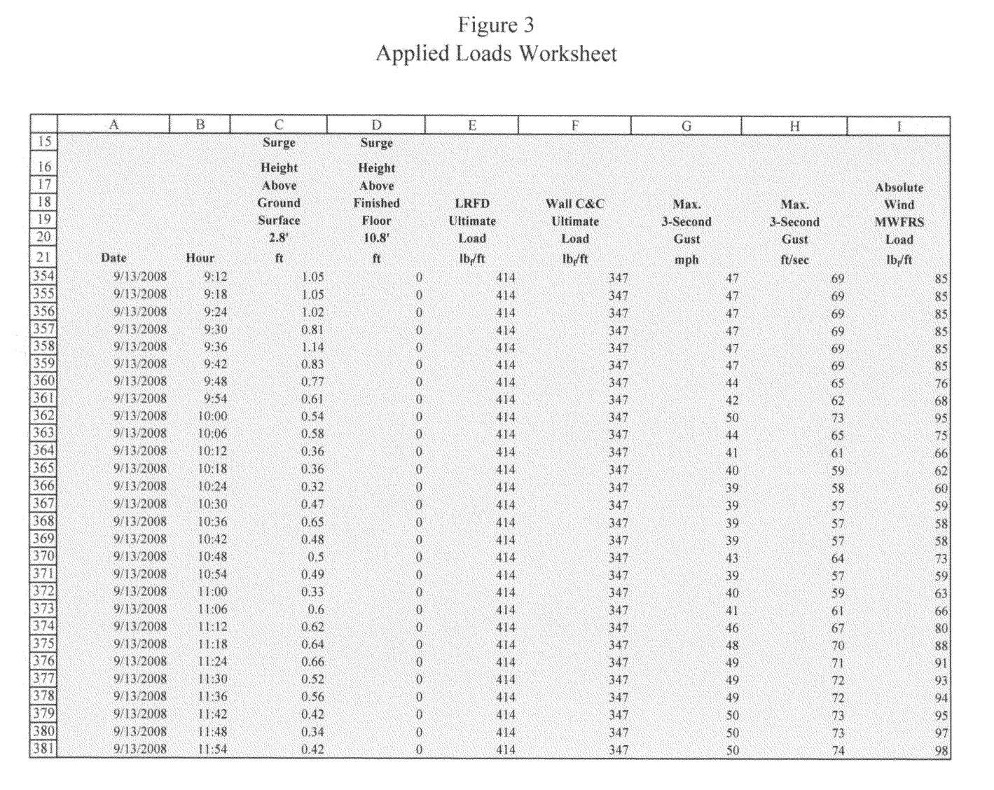

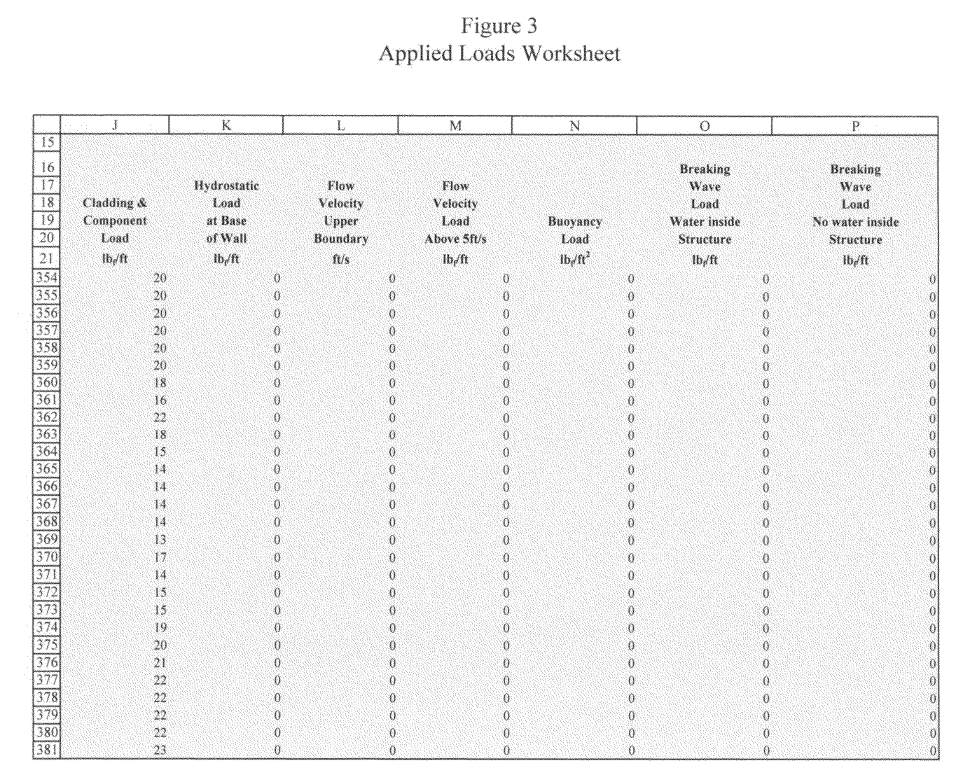

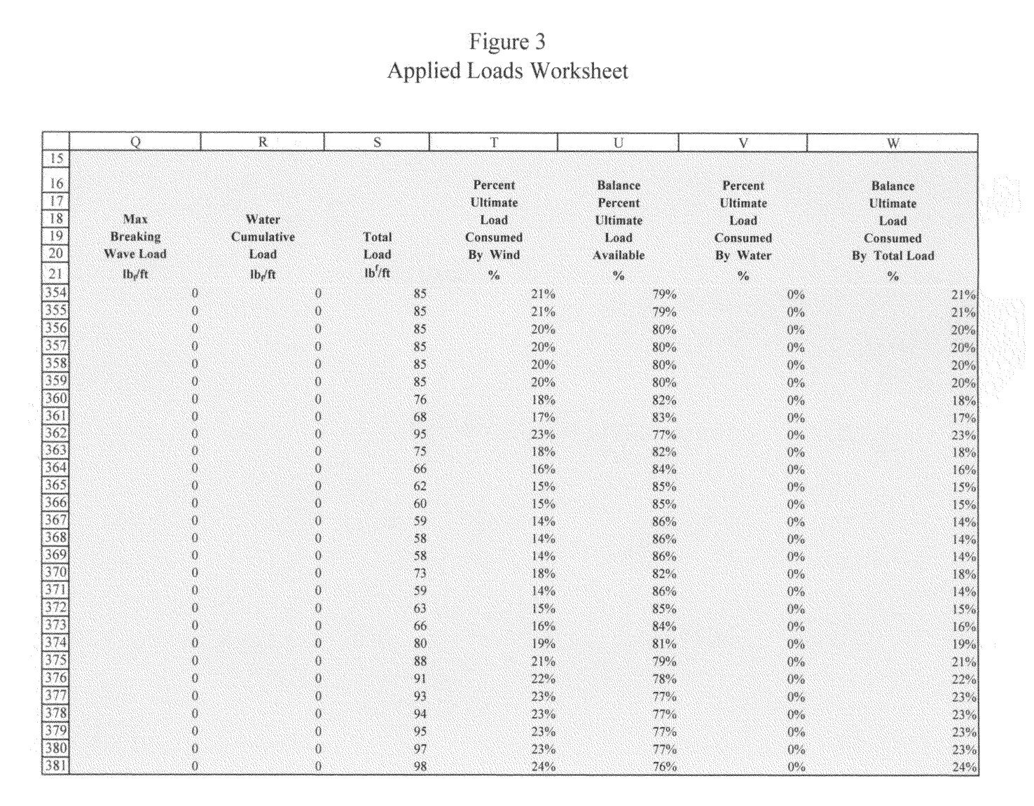

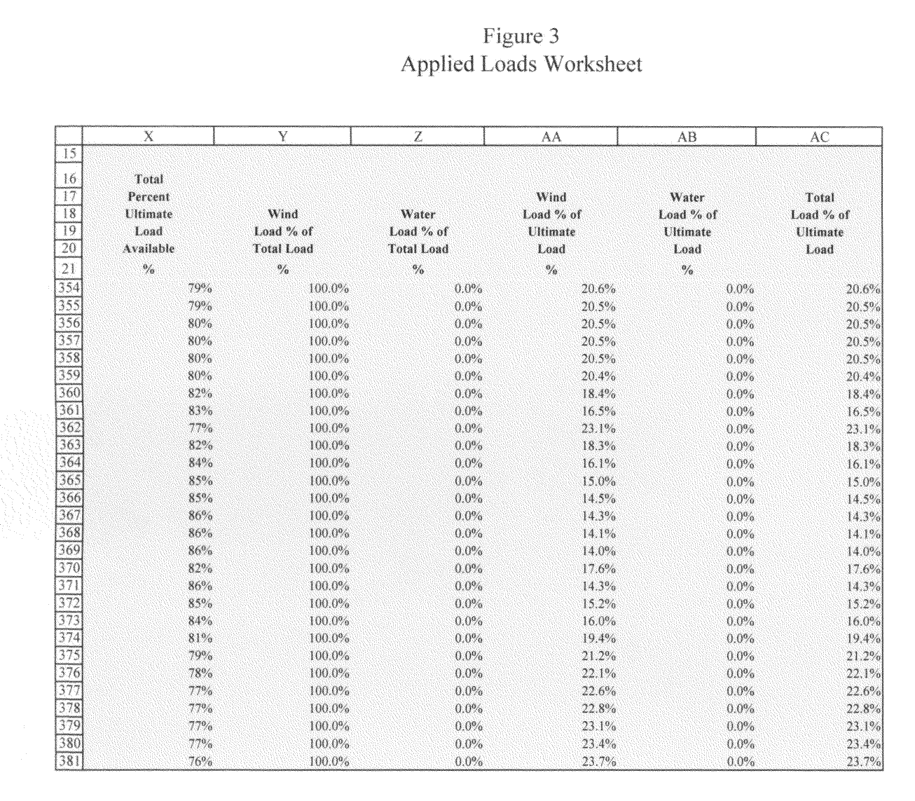

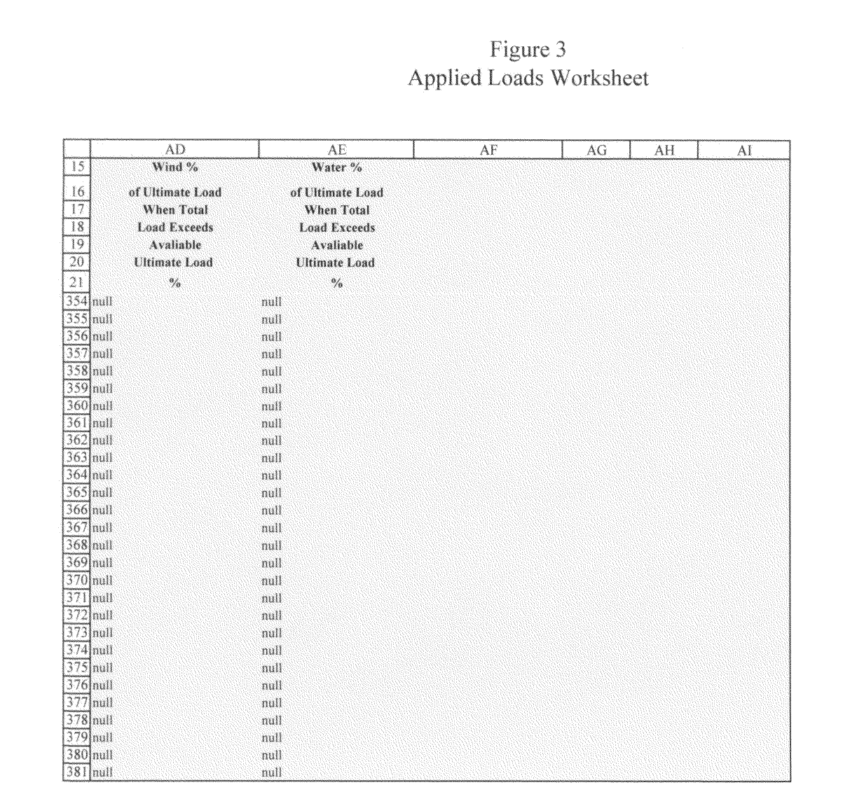

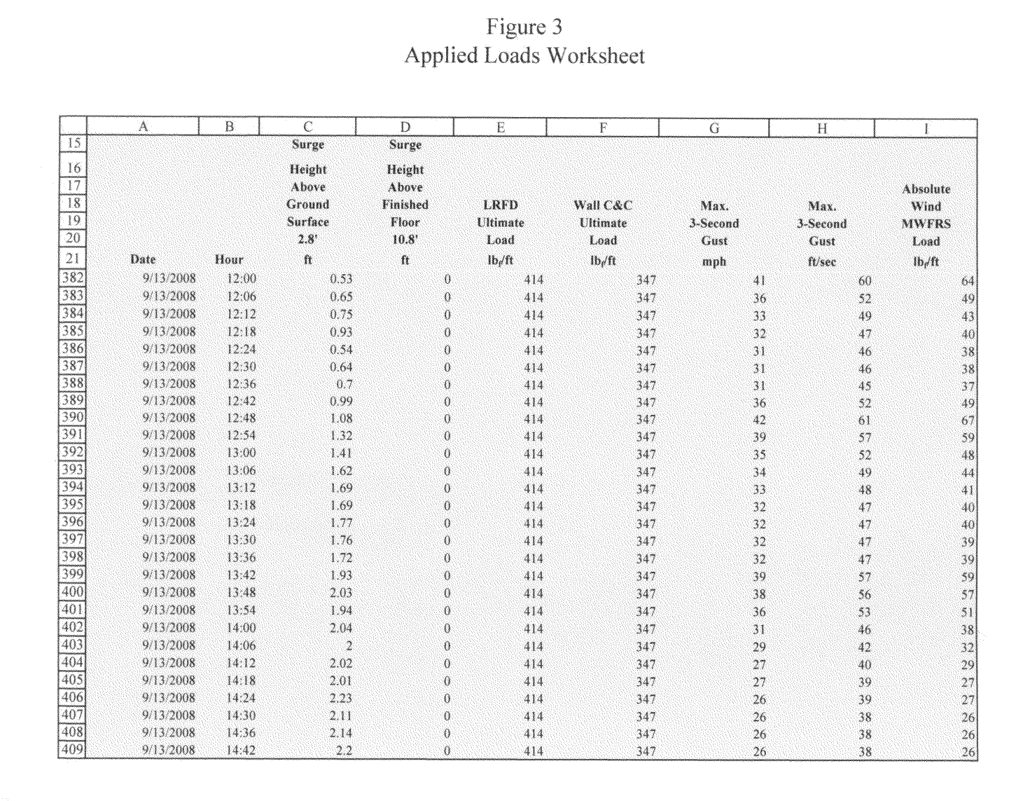

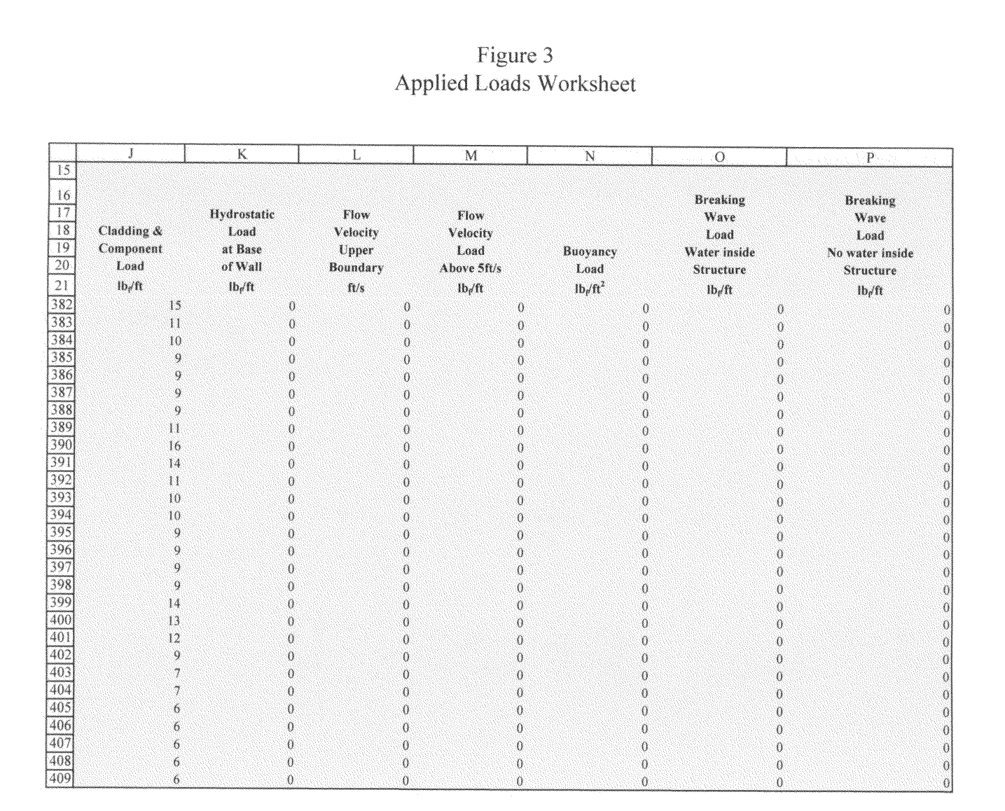

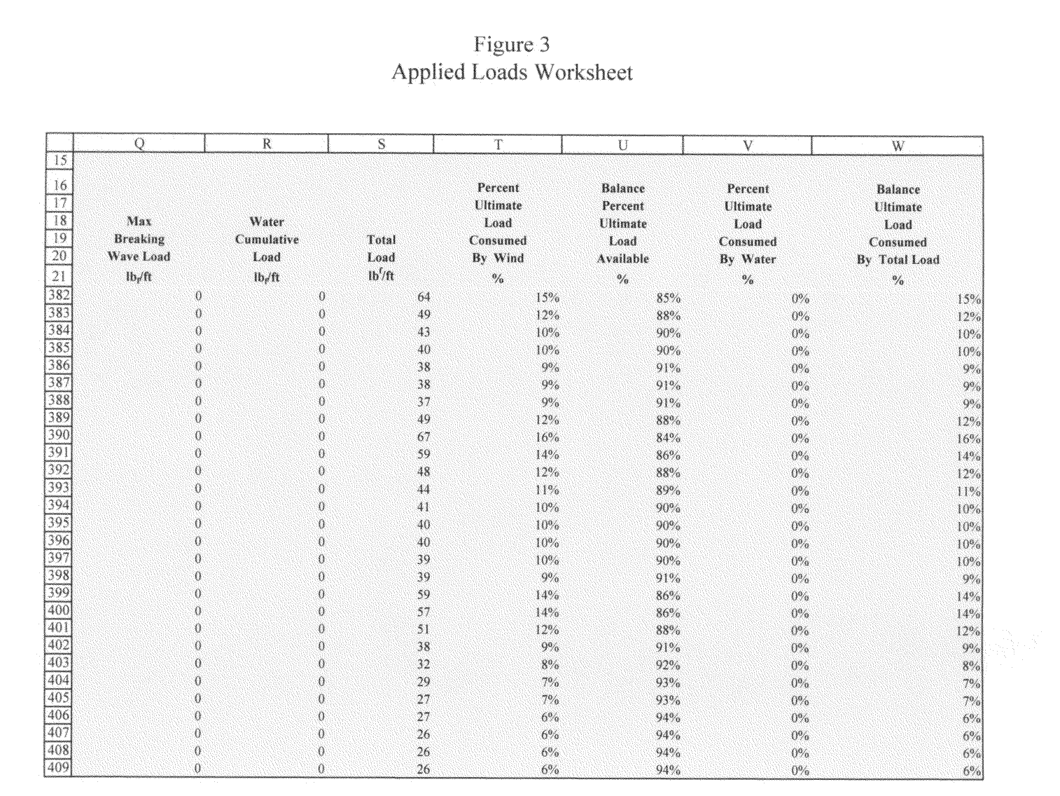

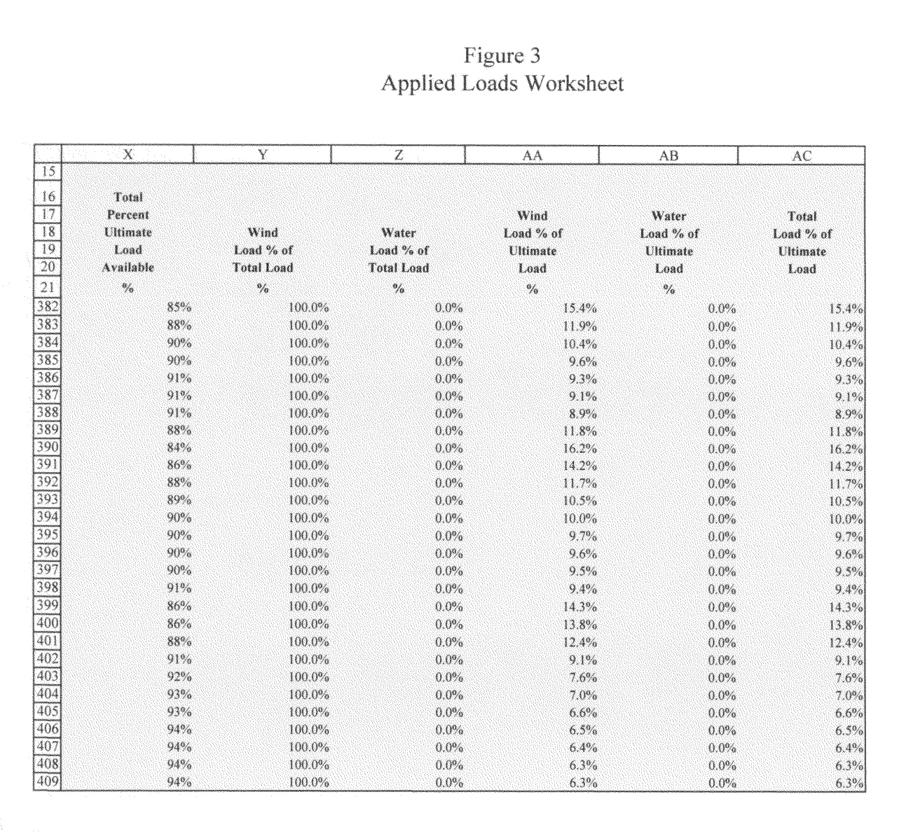

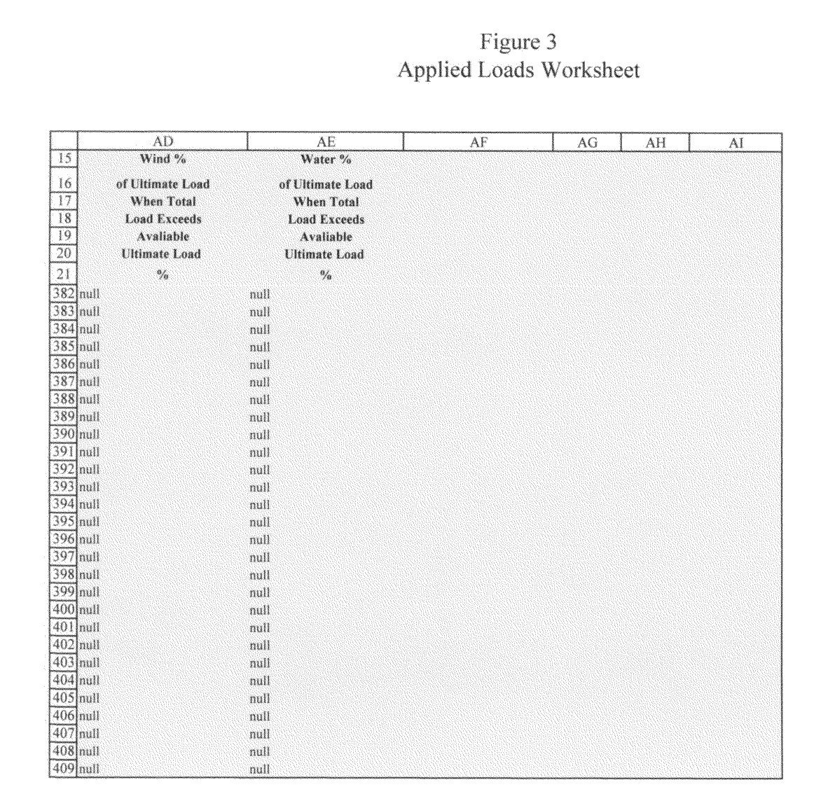

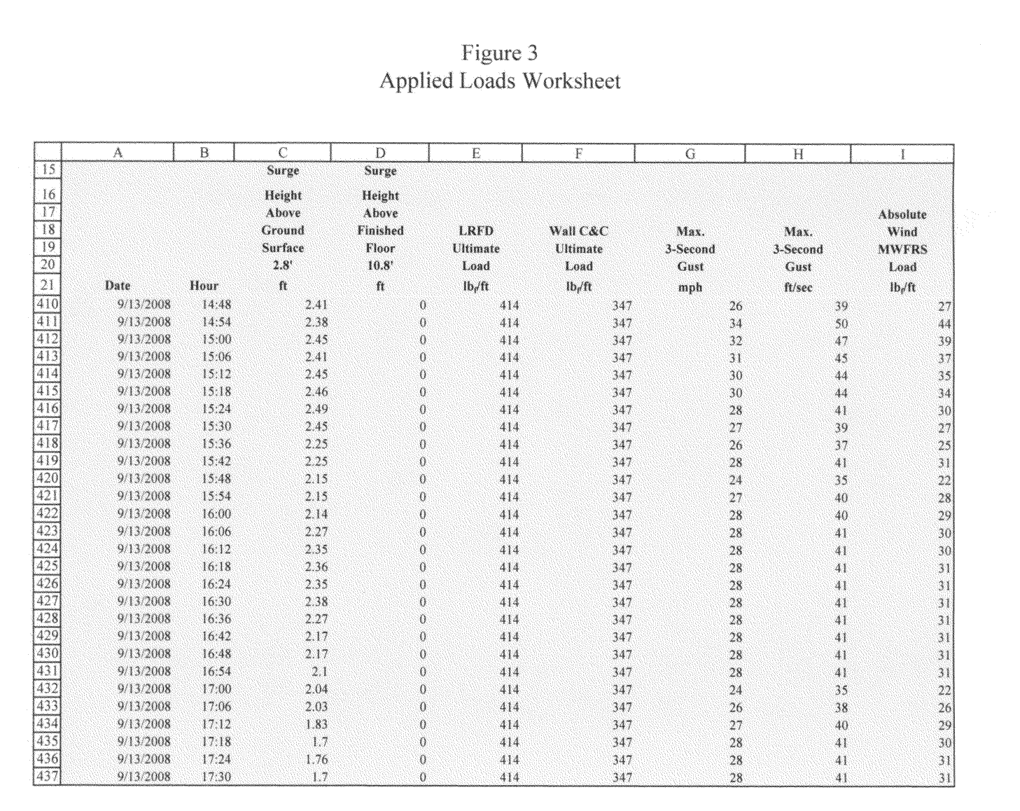

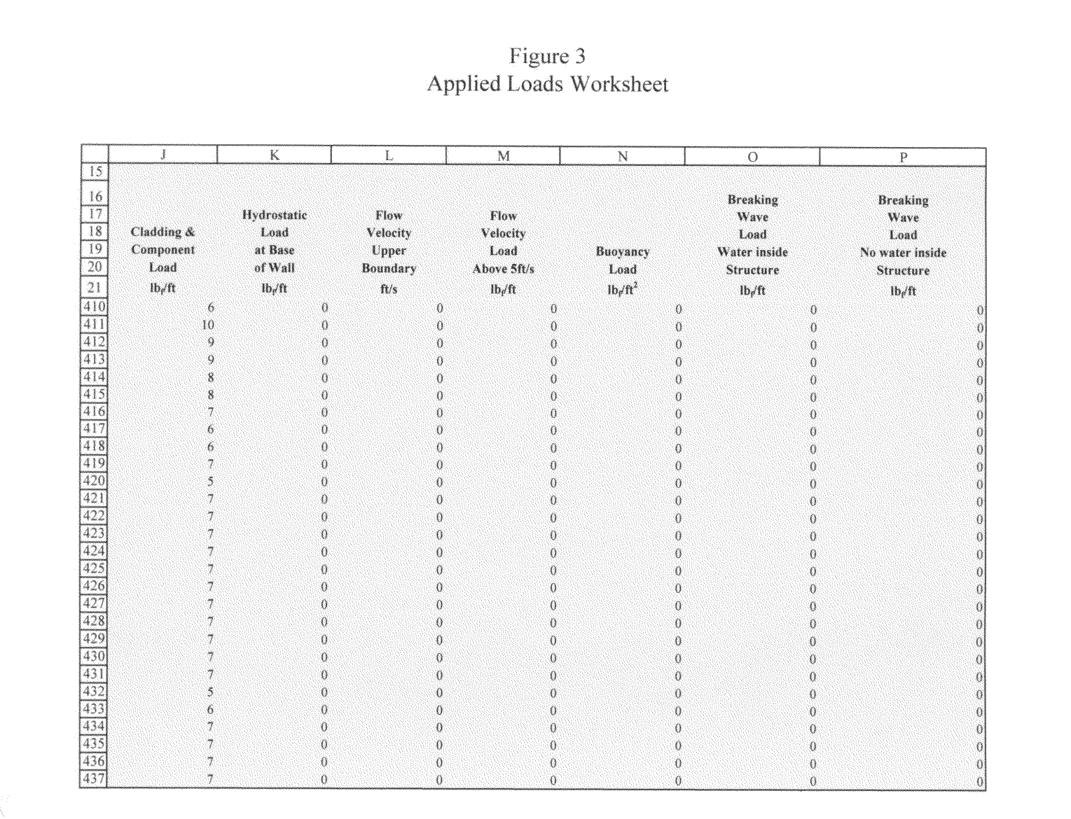

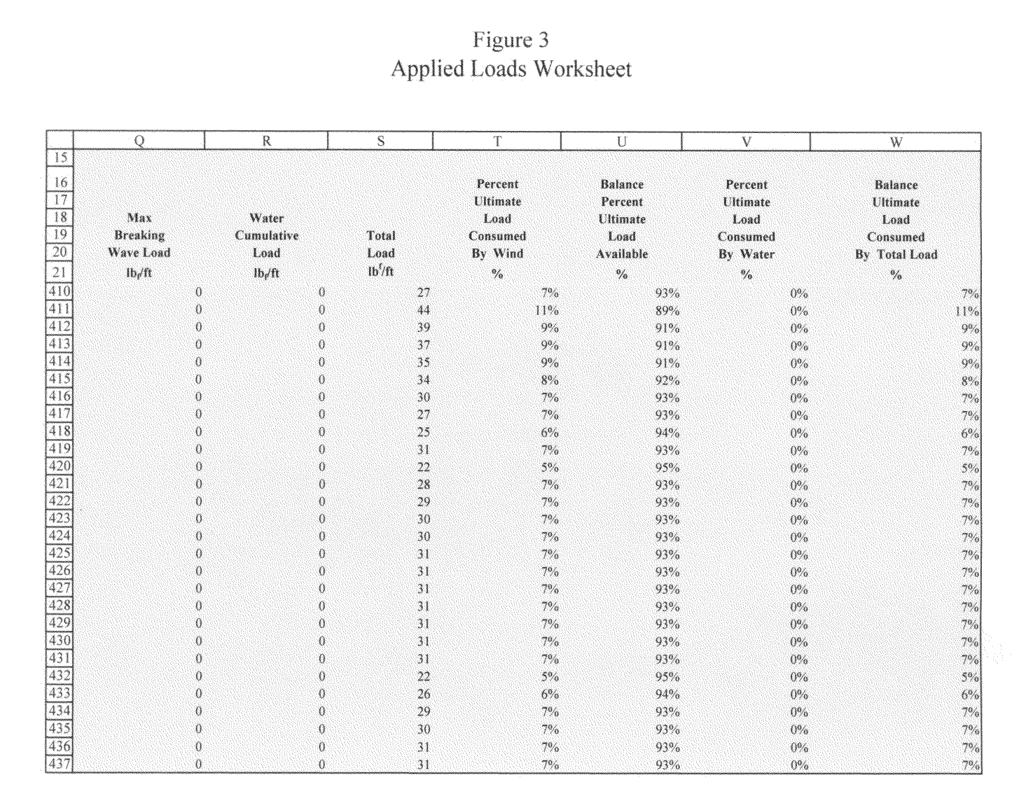

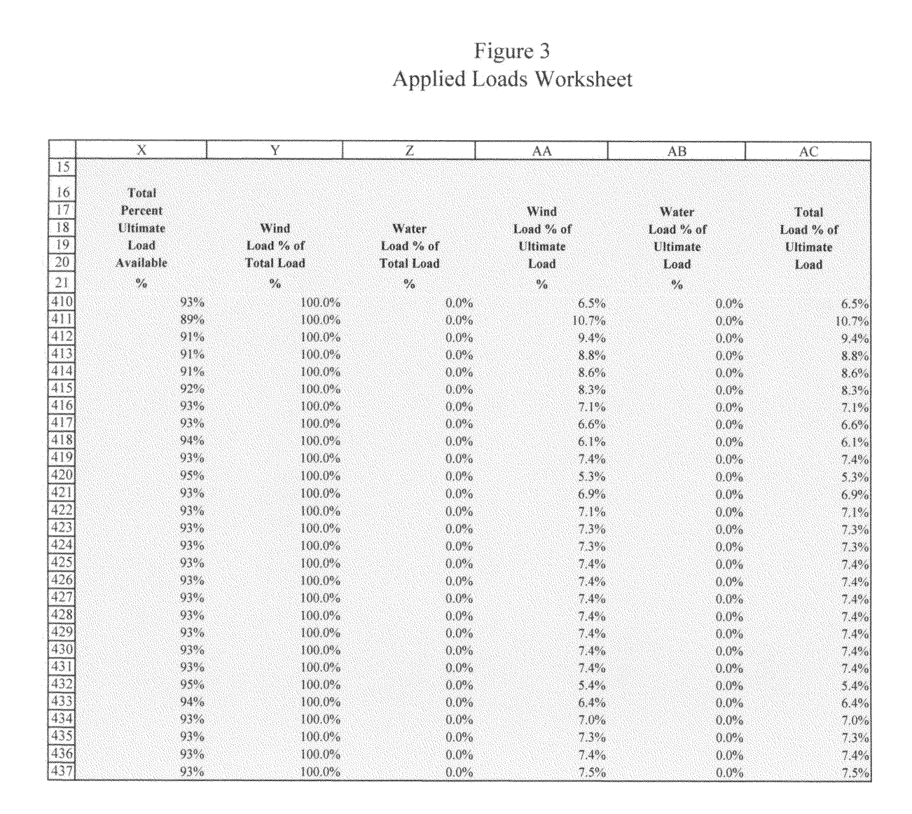

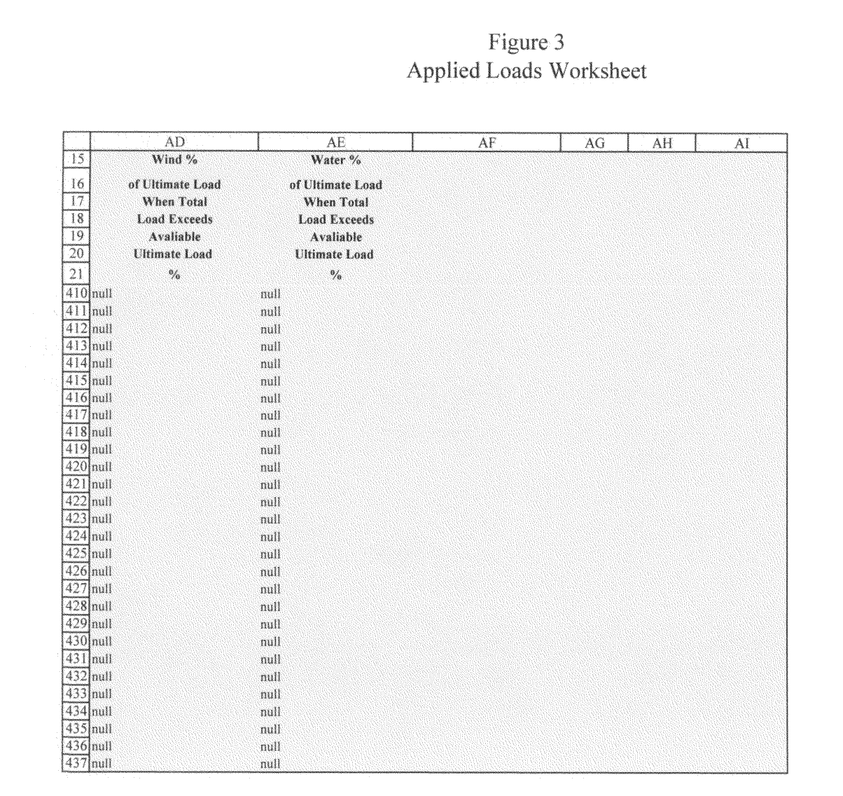

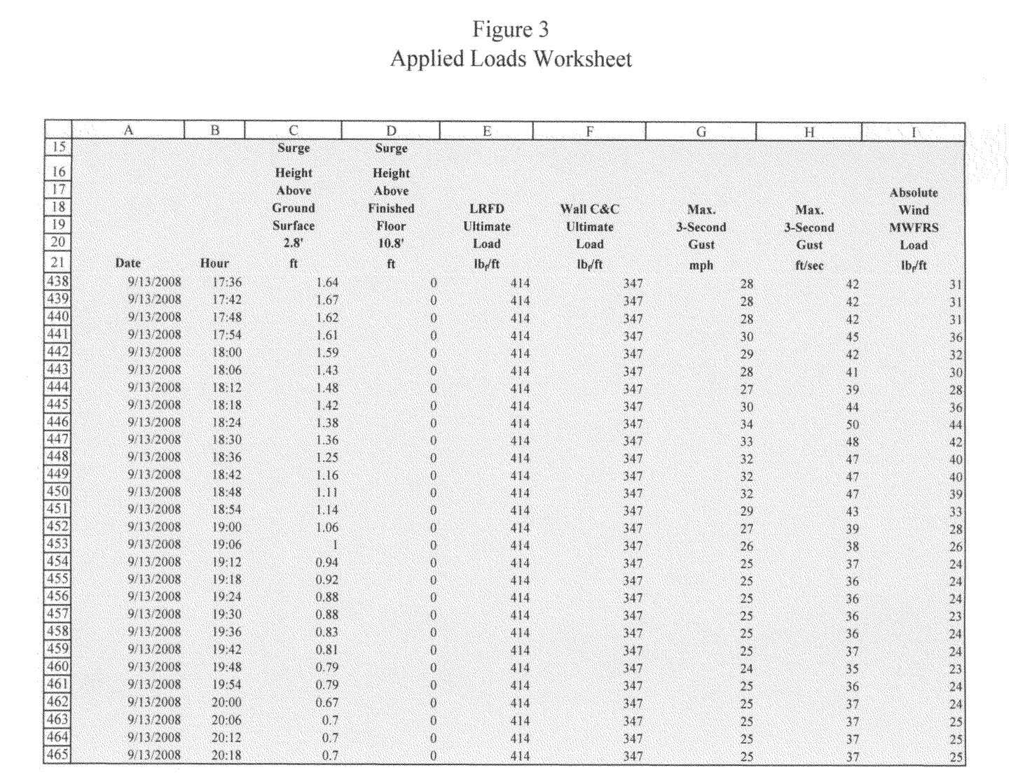

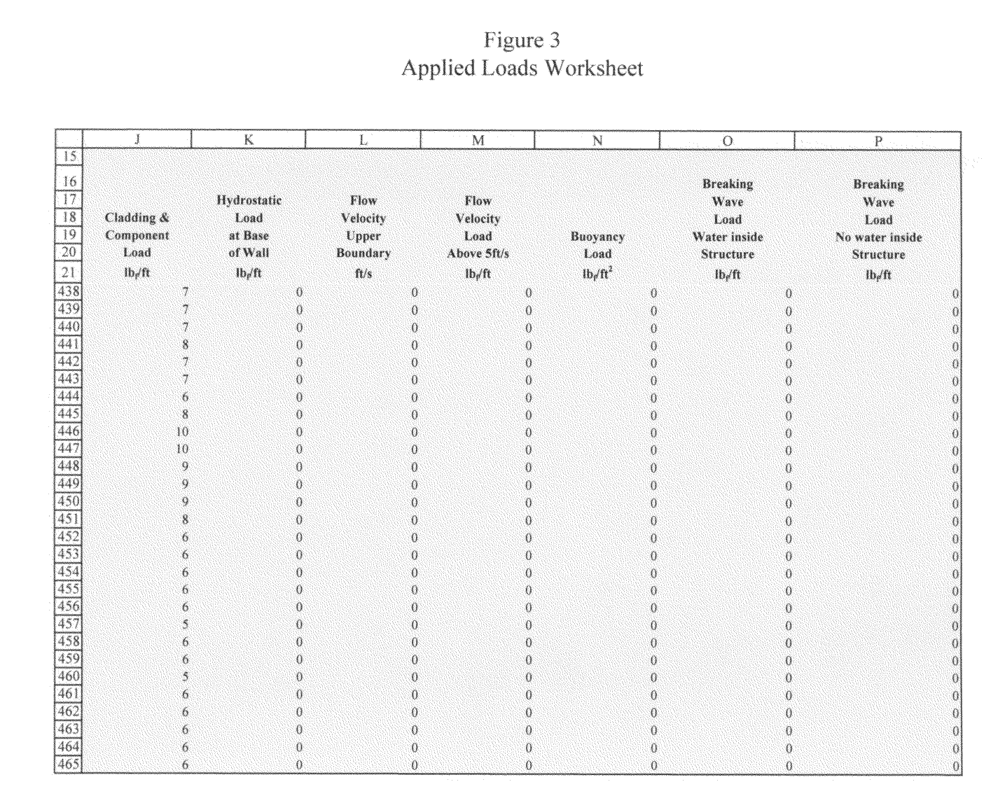

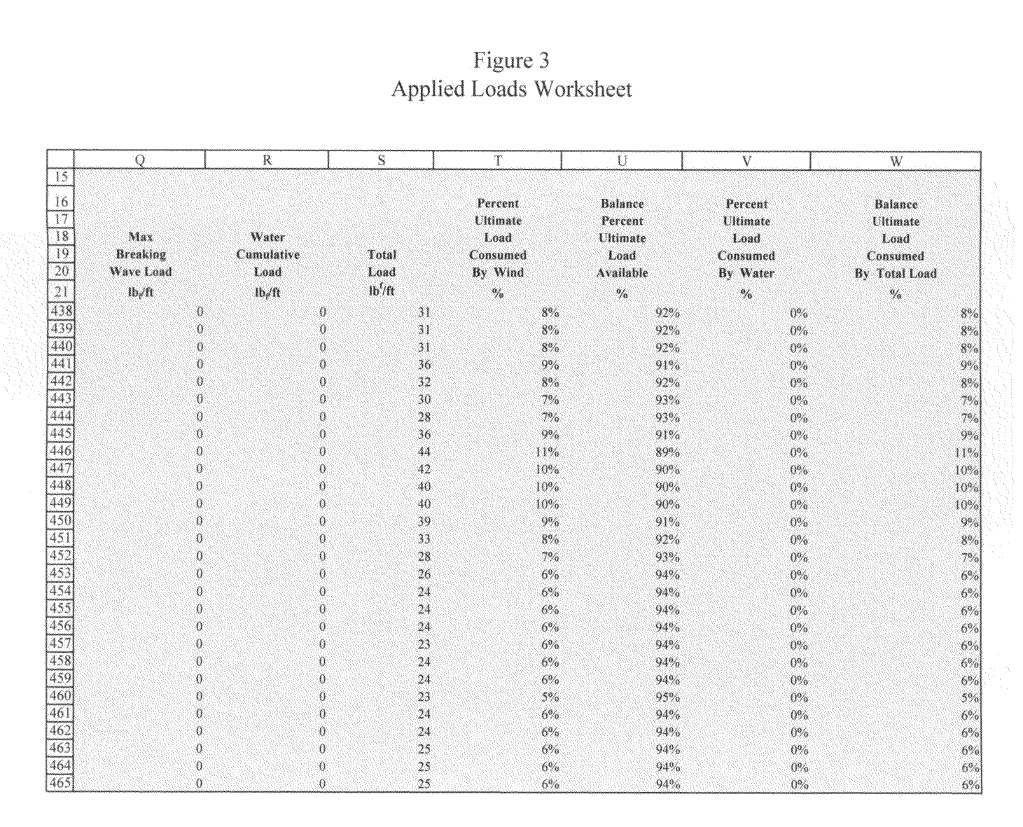

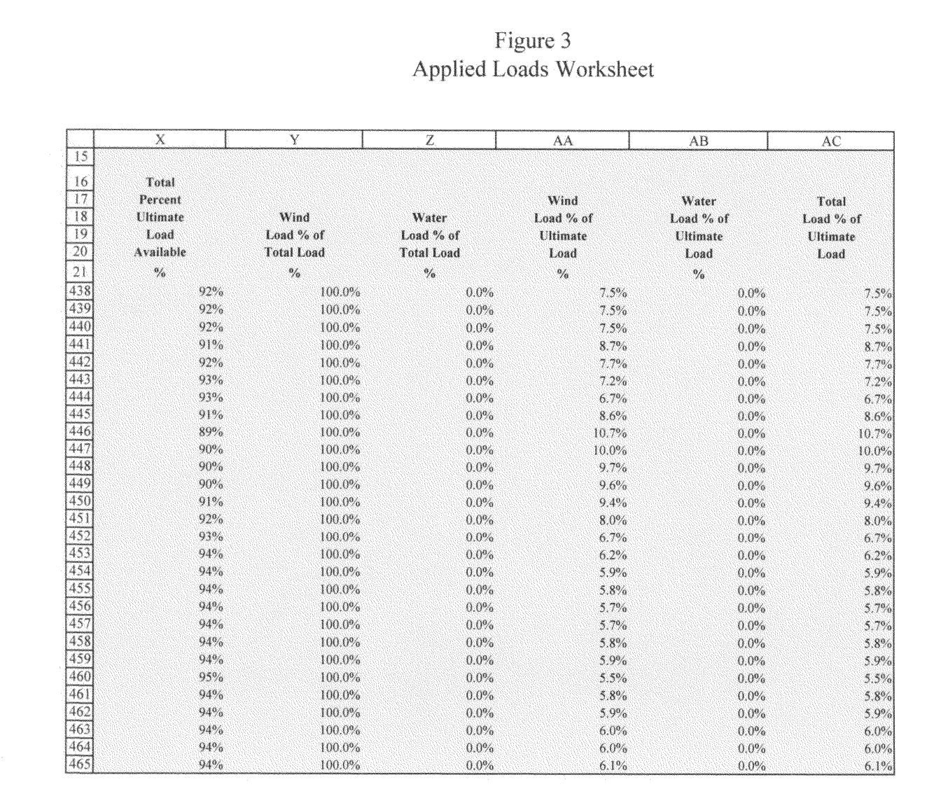

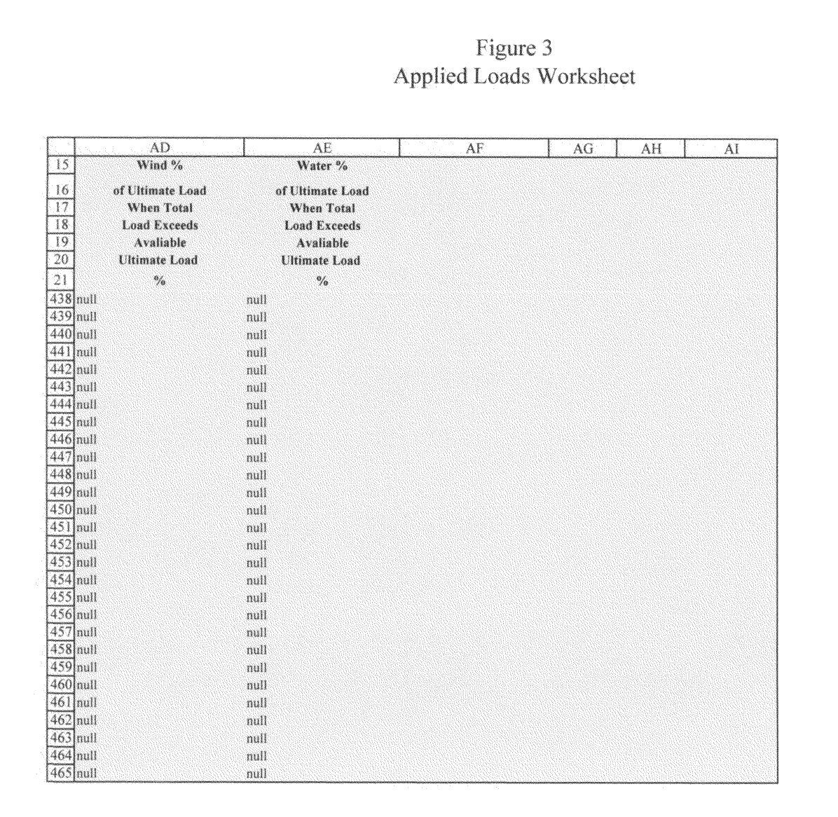

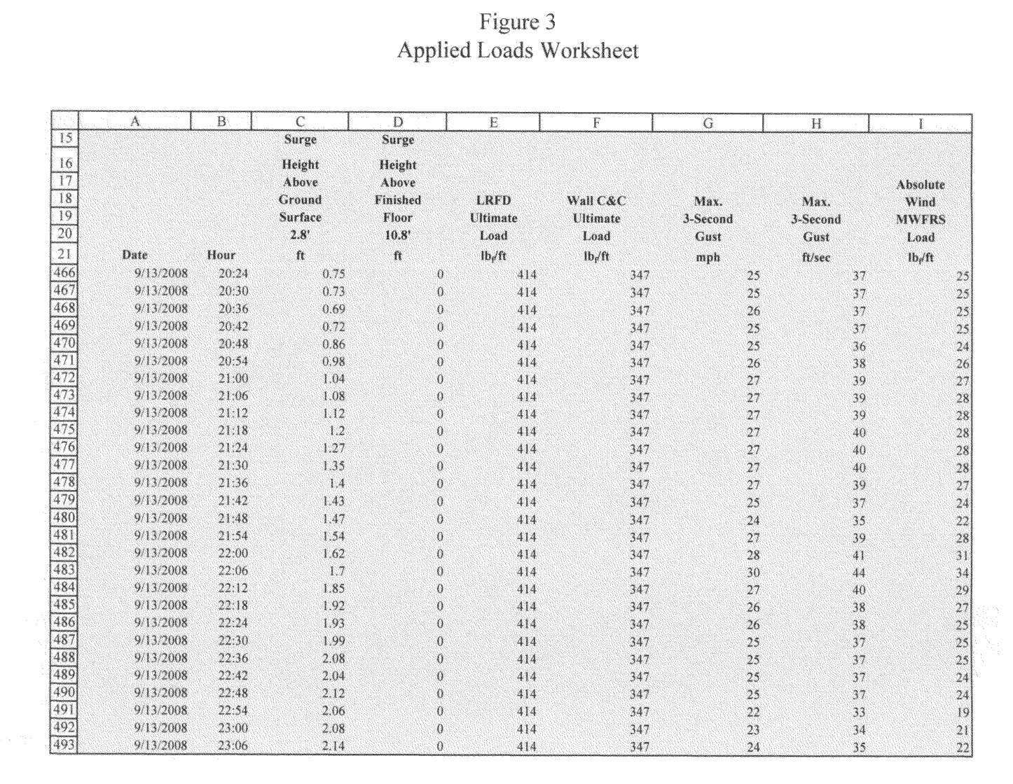

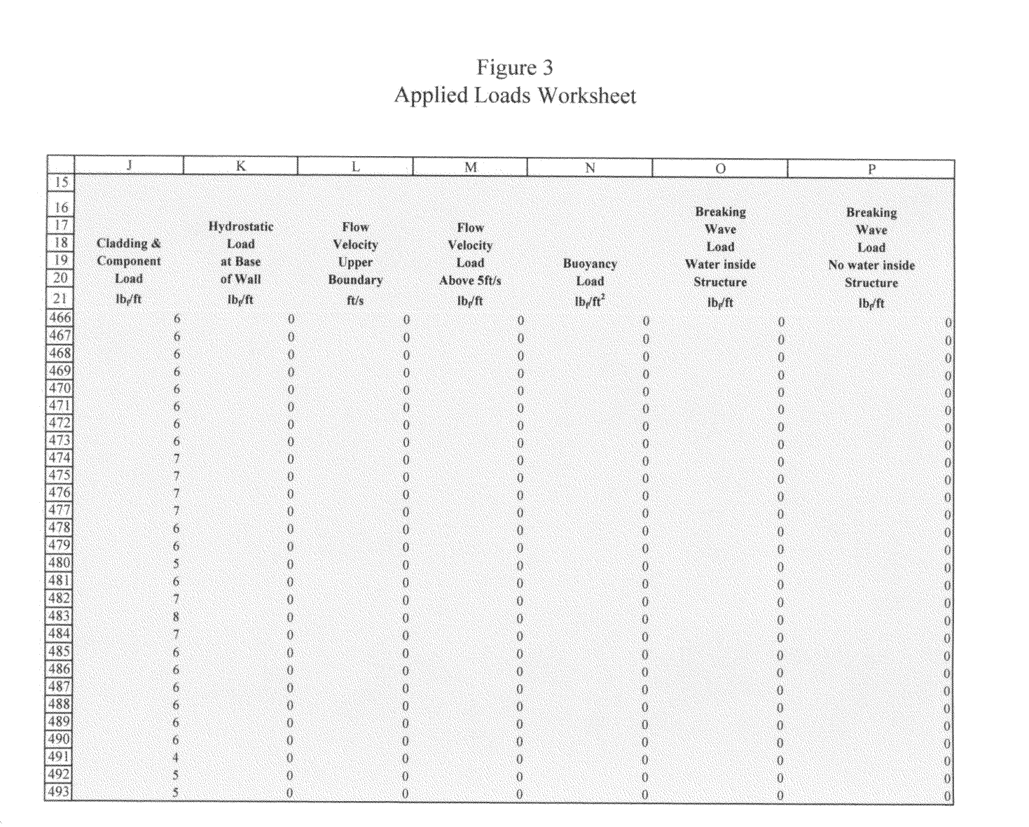

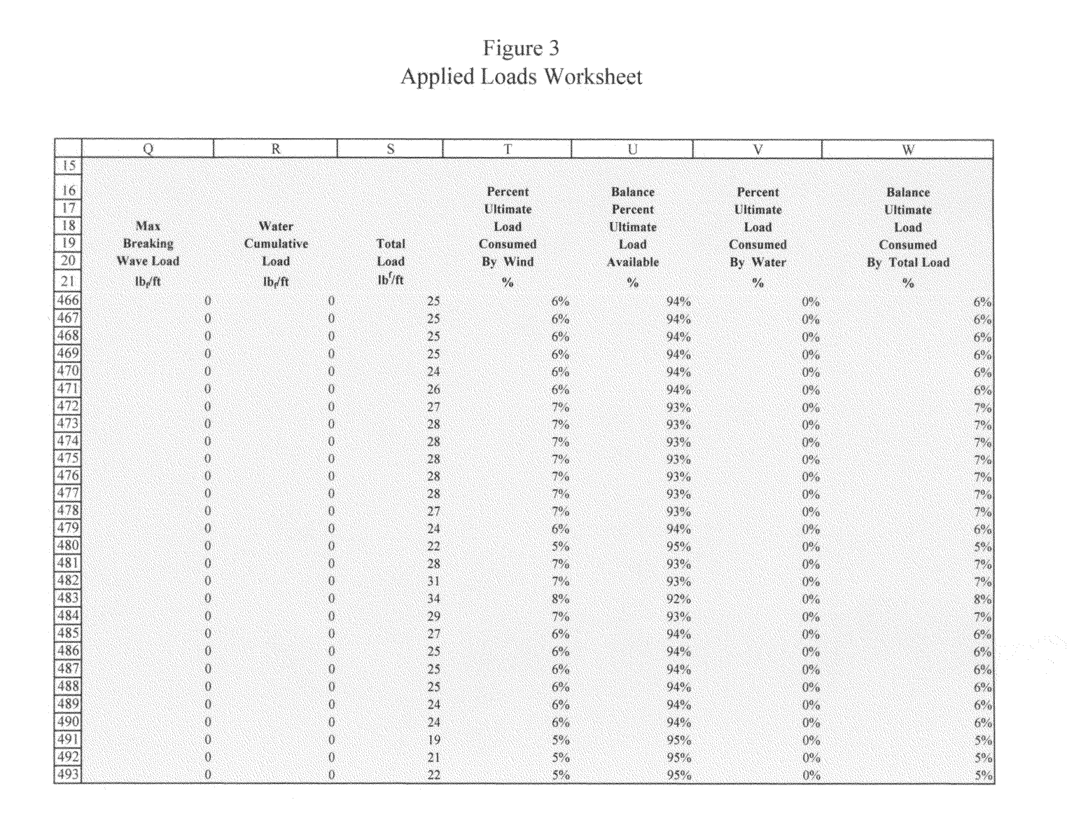

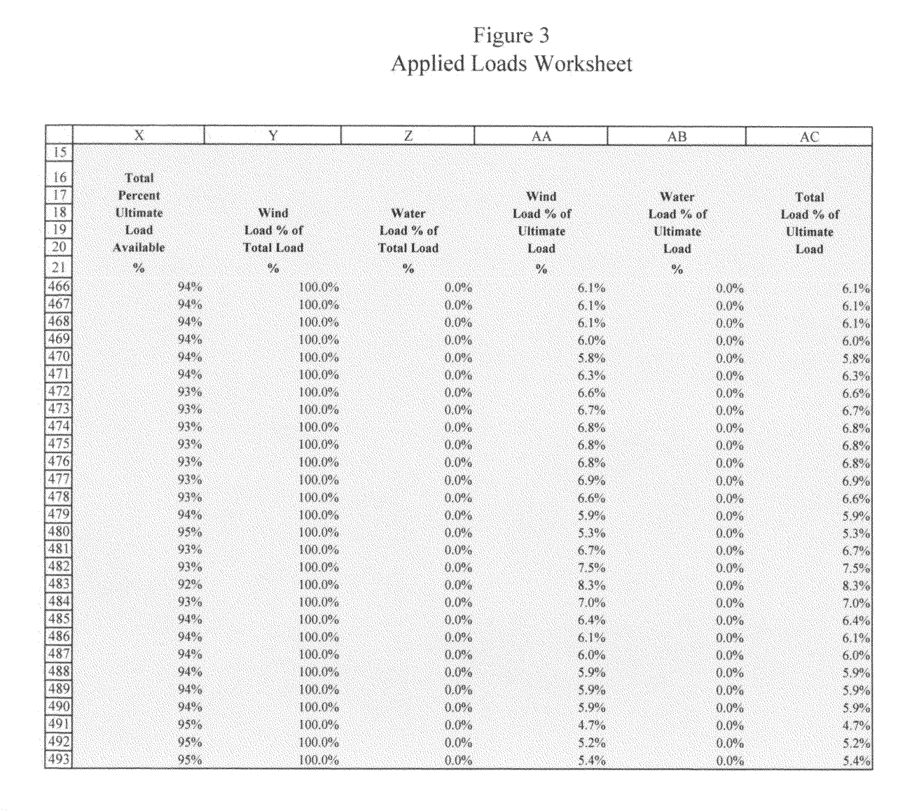

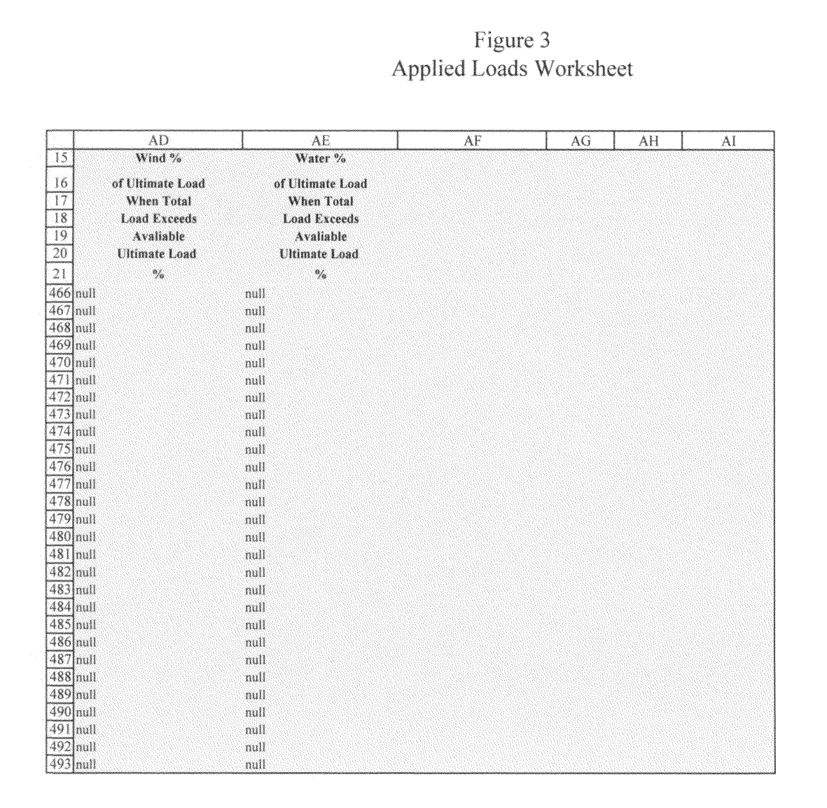

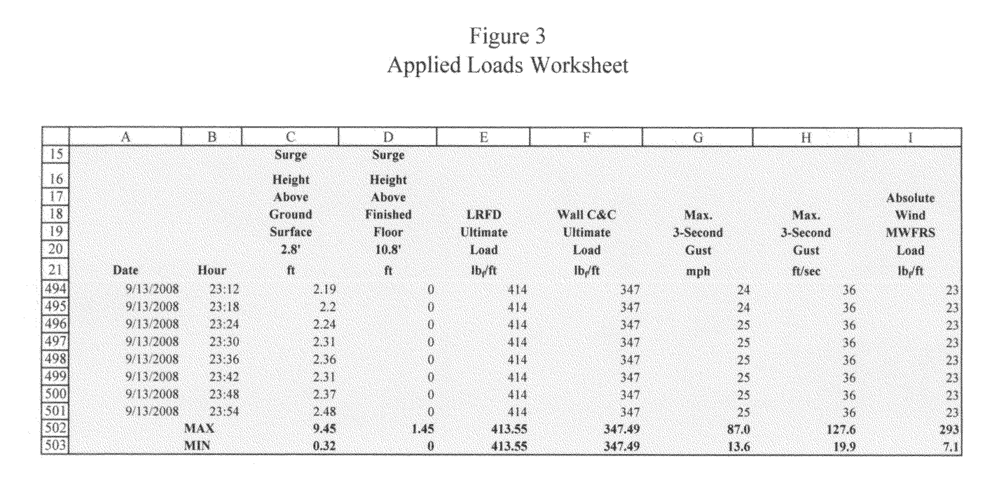

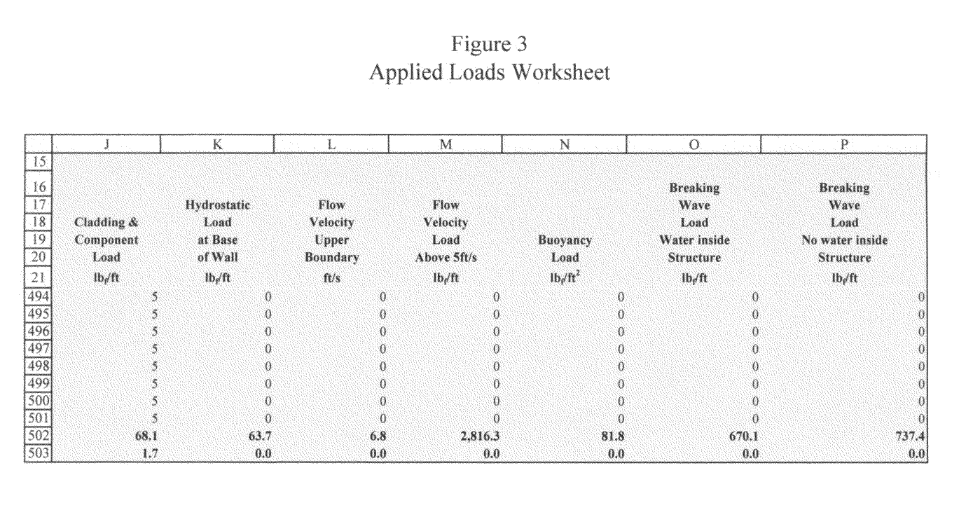

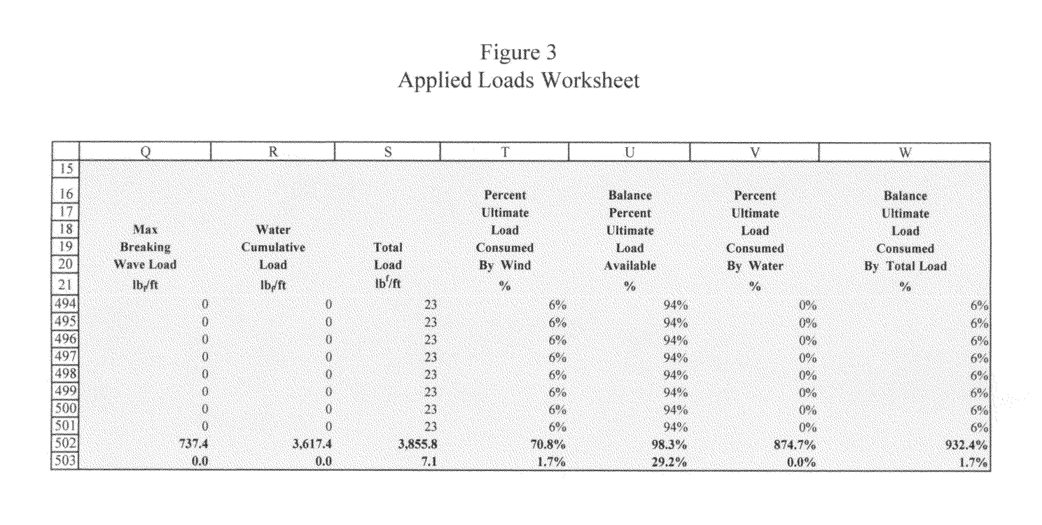

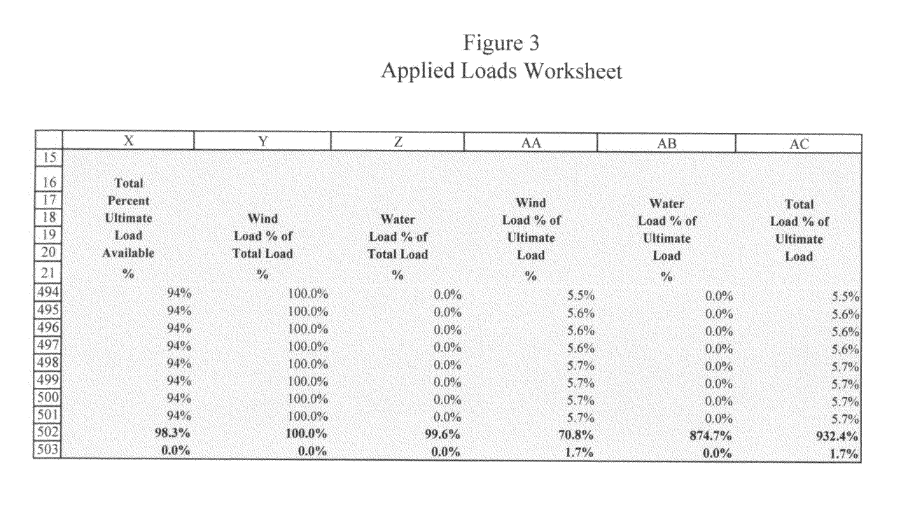

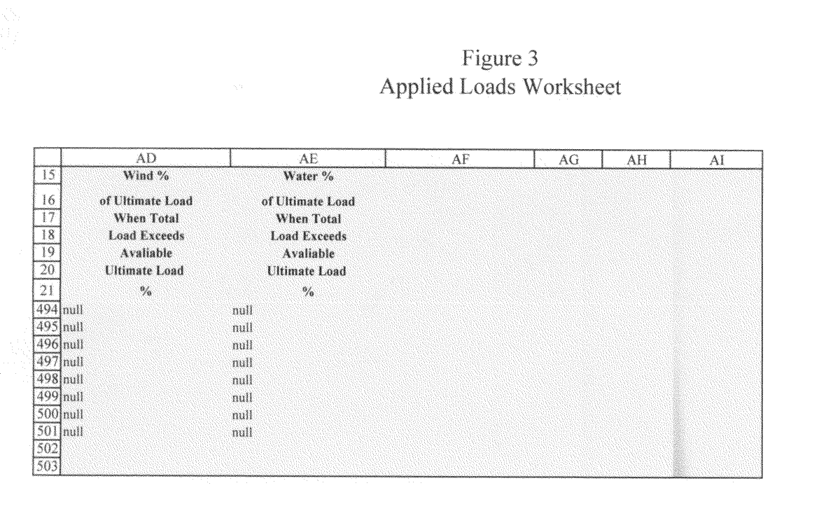

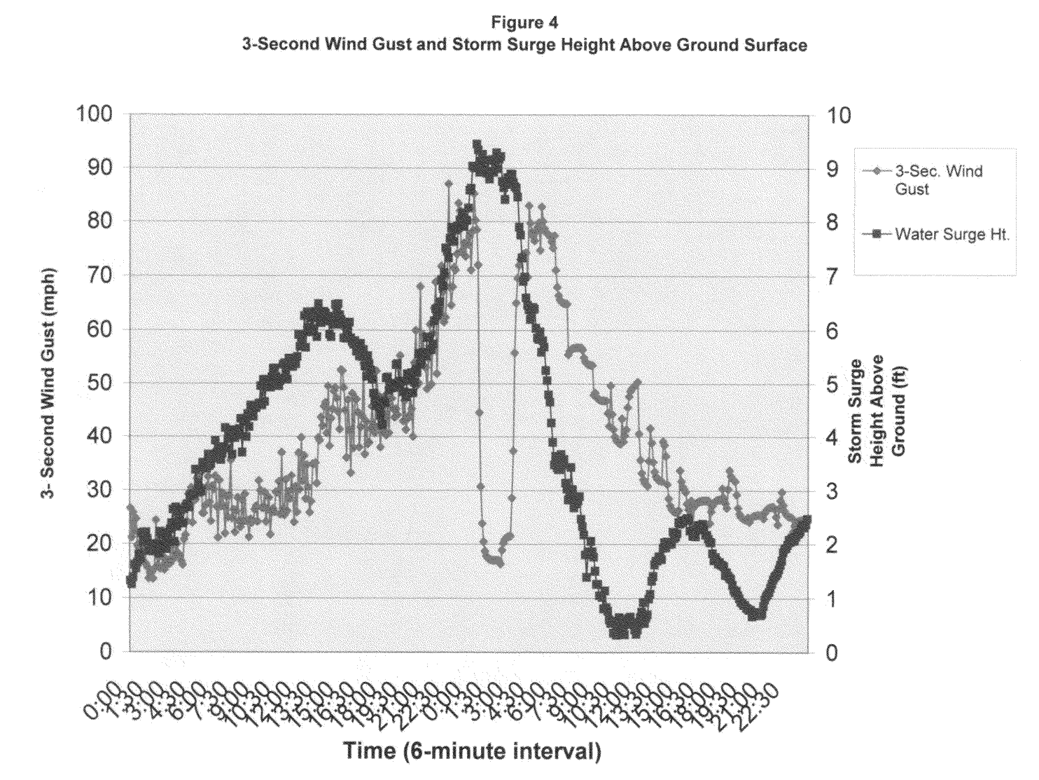

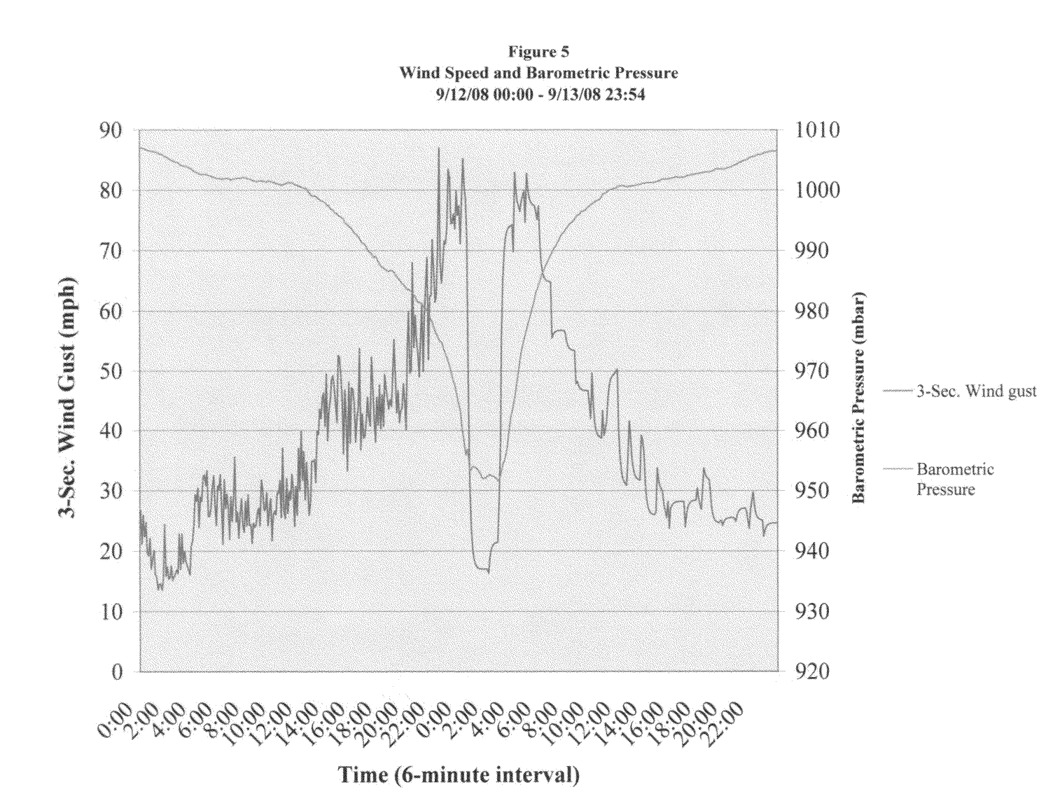

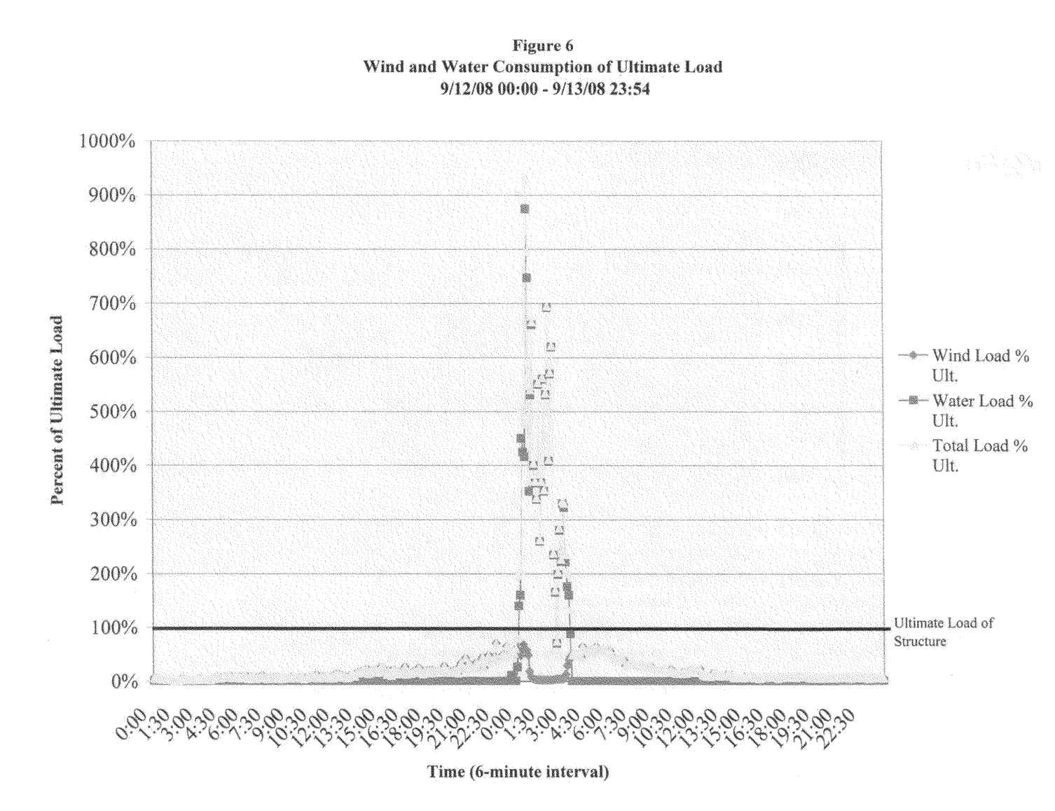

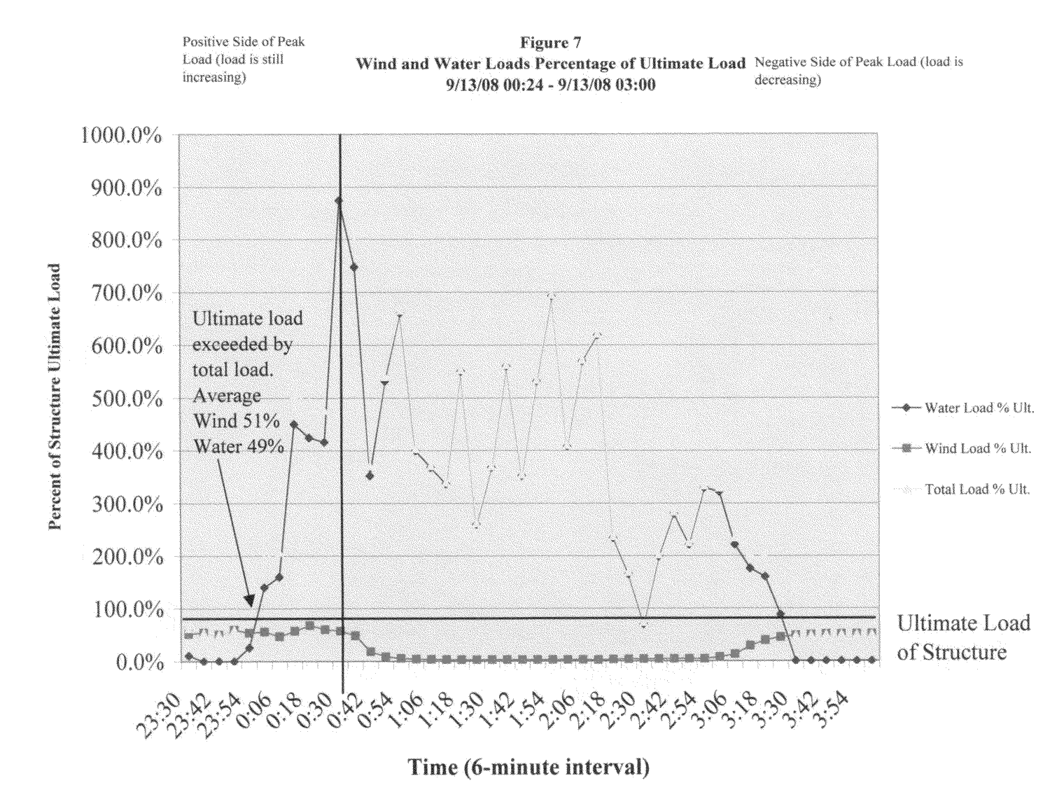

### DETAILED DESCRIPTION OF THE PREFERRED EMBODIMENTS

As required, detailed descriptions of the preferred embodiment are provided herein. It is to be understood, however, that the present invention may be embodied in various forms. The figures are not necessarily to scale; some features may be exaggerated to show details of particular components. Therefore, specific structural and functional details disclosed herein are not to be interpreted as limiting, but rather as a basis for the claims and as a representative basis for teaching one skilled in the art to employ the present invention in virtually any appropriately detailed system, structure or manner.

This patent application is for a physically based mathematically process to determine the percentage of damage, from one or multiply sources, (such as wind and flood) (but not limited to only wind and flood) that cause damage to structures.

This process comprising the following steps of:
1. Determining the location and physical dimensions of the structure;
2. Acquiring and plotting in a timeline the relevant damaging event data for the peril;
3. Conducting a damaging event data analysis by the process, determine the order of appearance of the forces;
4. Calculation of ultimate load for the subject structure;
5. Calculation of applied loads on the structure resulting from the event forces;
6. Comparison of individual and summation of applied loads on the subject structure to the structures ultimate load;
7. Plotting the applied loads on the event timeline compared to the ultimate load;
8. Identify times that the ultimate load was exceeded by the summation of applied loads;
9. Identify the time that the ultimate load is first exceed and the time the event is at its maximum intensity
10. Determine the percentage of the applied loads from when their sum exceeds the ultimate load through the event maximum intensity;
11. Average the individual applied loads from when their sum exceeds the ultimate load through the event maximum intensity;
12. Plotting the applied loads and their sum during the period the sum of the applied loads exceeds the ultimate load.

It is contemplated that these steps can be done manually, or by computer or a combination of both. As can be appreciated the above method provides a means by which forensic engineers can determine objectively what forces consumed in whole or in part the ultimate load of the structure.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

What is claimed is:

1. I claim the following:
The ultimate load and applied loads are calculated using physical dimensions of the structure;
The ultimate load wind speed is calculated from the design wind speed;
The applied loads are calculated from actual event data that is relevant to the project site;
The ultimate load identifies the point at which some type of structural failure will initiate;
The process will determine the precise amount (percentage) of damage (load) from single or multiple forces;
The process will determine the order in which the loads appeared and their time of appearance and relevance to each other;
The process will explain why the subject structure may be damaged more or less than an adjacent structure; and
The process will define the % of damage to the structure and associated and associated insurance claims.
